(19) United States
(12) Patent Application Publication
(10) Pub. No.: US 2024/0145873 A1
(43) Pub. Date: May 2, 2024

(54) VEHICLE BATTERY PACK WITH A BOLTLESS CONNECTOR SYSTEM

(71) Applicant: EATON INTELLIGENT POWER LIMITED, Dublin 4 (IE)

(72) Inventors: James Dawson, Carol Stream, IL (US); Jason Degen, Carol Stream, IL (US)

(21) Appl. No.: 18/310,183

(22) Filed: May 1, 2023

Related U.S. Application Data
(63) Continuation of application No. PCT/US2021/157959, filed on Nov. 3, 2021.
(60) Provisional application No. 63/109,135, filed on Nov. 3, 2020.

(51) Int. Cl. H01M 50/503; B60R 16/033; H01M 50/211; H01M 50/296; H01M 50/507; H01M 50/516; H01R 13/11; H01R 13/641

(52) U.S. Cl. CPC H01M 50/503; B60R 16/033; H01M 50/211; H01M 50/296; H01M 50/507; H01M 50/516; H01R 13/11; H01R 13/641; H01M 2220/20

(57) ABSTRACT

The invention relates to a battery pack for use in a power management system of an application, such as a motor vehicle, ship or train. The battery pack includes a boltless busbar having a first male terminal assembly and a second male terminal assembly. A first battery module has: (i) an internal battery cell positioned within a battery module housing (ii) a boltless female connector assembly having a female first terminal housing associated with said battery module housing and a first female terminal assembly positioned within the first female terminal housing. A second battery module has: (i) an internal battery cell positioned within a battery module housing (ii) a boltless female connector assembly having a second female terminal housing associated with said battery module housing and a second female terminal assembly positioned within the second female terminal housing. When the first male terminal assembly is positioned within an extent of the first female terminal assembly and the second male terminal assembly is positioned within an extent of the second female terminal assembly, the boltless busbar electrically couples the first battery module to the second battery module.

### RELATED APPLICATIONS

This application claims the benefit from PCT patent application US2021/057959, filed Nov. 3, 2021 and U.S. provisional patent application 63/109,135, filed Nov. 3, 2020, the disclosure of which are incorporated herein by this reference.

### FIELD OF DISCLOSURE

The present disclosure relates to a battery pack for use within a power distribution system of a vehicle. The battery pack includes a plurality of battery modules that are mechanically and electrically connected to one another using at least one boltless connector system with: (i) a female connector assembly, (ii) a conductor, and (iii) a male connector assembly.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for a variety of reasons, including but not limited to, monitoring, improving and/or controlling vehicle performance, emissions, safety and creates comforts to the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies due to a number of conditions, including but not limited to, space constraints that make initial installation difficult, harsh operating conditions, large ambient temperature ranges, prolonged vibration, heat loads, and longevity, all of which can lead to component and/or connector failure. For example, incorrectly installed connectors, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all of the automotive manufacturers and their direct suppliers is estimated to be between $50 billion and $150 billion, worldwide. In light of these challenging electrical environments, considerable time, money, and energy have been expended to find power distribution components that meet the needs of the markets. This disclosure addresses the shortcomings of conventional power distribution components. A full discussion of the features and advantages of the present disclosure is deferred to the following detailed description, which proceeds with reference to the accompanying drawings.

### SUMMARY

The present disclosure relates to a battery pack for use within a power distribution system that can be installed within in an airplane, motor vehicle, a military vehicle (e.g., tank, personnel carrier, heavy-duty truck, and troop transport), a bus, a locomotive, a bulldozer, an excavator, a tractor, marine applications (e.g., cargo ship, tanker, pleasure boat, submarine and sailing yacht), mining equipment, forestry equipment, agricultural equipment (e.g., tractor, cutters, planters, combines, threshers, harvesters), telecommunications hardware (e.g., server), a power storage system (e.g., backup power storage), renewable energy hardware (e.g., wind turbines and solar cell arrays), a 24-48 volt system, for a high-power application, for a high-current application, for a high-voltage application.

The inventive battery pack disclosed herein includes a plurality of battery modules, wherein the battery modules are mechanically and electrically connected to one another using at least one boltless connector system. This boltless connector system includes: (i) a female connector assembly, (ii) a conductor (e.g., busbar), and (iii) a boltless male connector assembly. In one embodiment, the female connector assembly is formed as a part of a unique electrical transfer assembly, which is contained within the battery modules to facilitate the charging/discharging of a plurality of battery cells. In other embodiments, the female connector assembly or female terminal assembly may be coupled to: (i) a current collector that is connected to a plurality of battery cells, and/or (ii) a current collector of a single battery cell. Additional structural and functional aspects and benefits of the power distribution components are disclosed in the Detailed Description section and the Figures.

### BRIEF DESCRIPTION OF THE DRAWINGS

The accompanying drawings or figures, which are included to provide further understanding and are incorporated in and constitute a part of this specification, illustrate disclosed embodiments and together with the description serve to explain the principles of the disclosed embodiments. In the Figures, like reference numerals refer to the same or similar elements throughout the Figures. In the drawings:

FIG. 1A is a perspective view of a first embodiment of a battery module and a plurality of boltless busbar assemblies of a boltless connector system, wherein the combination of the battery module and boltless busbars assemblies include a plurality of boltless connector systems;

FIG. 1B is a perspective view of the first embodiment of a battery module having a plurality of female connector assemblies;

FIG. 2 is a perspective view of a portion of the battery module and a plurality of boltless busbar assemblies of FIG. 1, where the battery module housing is shown as transparent and a plurality of battery cells have been removed to reveal the electrical transfer assembly;

FIG. 3 is a partial exploded view of the electrical transfer assembly shown in FIG. 2 that includes: (i) a negative connector module, (ii) an interior interface module, (iii) an exterior interface module, (iv) a jumper interface module, and (v) a positive connector module;

FIG. 4 is a perspective view of the negative connector module of FIG. 3;

FIG. 5 is a top view of the negative connector module of FIG. 4;

FIG. 6 is a front view of the negative connector module of FIG. 4;

FIG. 7 is a first end view of the negative connector module of FIG. 4;

FIG. 8 is a second end view of the negative connector module of FIG. 4;

FIG. 9 is an exploded view of the negative connector module that includes: (i) a negative support structure, (ii) a negative female connector assembly with a female housing assembly and a female terminal assembly, and (iii) a negative busbar;

FIG. 10 is a perspective view of an extent of the negative connector module of FIG. 9, where the female terminal assembly and the negative busbar have been omitted;

FIG. 11 is a zoomed in view of the female housing assembly of the negative connector module in FIG. 10;

FIG. 12 is a perspective view of the female terminal assembly and the negative busbar of the negative connector module of FIG. 9, shown in a coupled state;

FIG. 13 is a top view of the female terminal assembly and the negative busbar of FIG. 12;

FIG. 14 is a front view of the female terminal assembly and the negative busbar of FIG. 12;

FIG. 15 is a side view of the female terminal assembly and the negative busbar of FIG. 12;

FIG. 16 is a perspective view of the negative busbar of the negative connector module in FIG. 10;

FIG. 17 is a perspective view of the female terminal assembly of the negative connector module in FIG. 10;

FIG. 18 is a perspective view of the interior interface module of the electrical transfer assembly of FIG. 3;

FIG. 19 is a top view of the interior interface module of FIG. 18;

FIG. 20 is a front view of the interior interface module of FIG. 18;

FIG. 21 is a first end view of the interior interface module of FIG. 18;

FIG. 22 is a second end view of the interior interface module of FIG. 18;

FIG. 23 is an exploded view of the interior interface module of FIG. 3, showing an interior support structure and an interior interface busbar;

FIG. 24 is a perspective view of an extent of the interior interface module of FIG. 23, where the interior interface busbar has been removed from the interior support structure;

FIG. 25 is perspective view of the interior interface busbar of the interior interface module of FIG. 23;

FIG. 26 is a perspective view of the exterior interface module of FIG. 3;

FIG. 27 is a top view of the exterior interface module of FIG. 26;

FIG. 28 is a front view of the exterior interface module of FIG. 26;

FIG. 29 is an exploded view of the exterior interface module showing an outer support structure and an outer interface busbar;

FIG. 30 is a perspective view of an extent of the exterior interface module of FIG. 29, where the outer interface busbar has been removed from the outer support structure;

FIG. 31 is perspective view of the outer interface busbar of FIG. 29;

FIG. 32 is a perspective view of a jumper interface module of FIG. 3;

FIG. 33 is a top view of the jumper interface module of FIG. 32;

FIG. 34 is a front view of the jumper interface module of FIG. 32;

FIG. 35 is a first end view of the jumper interface module of FIG. 32;

FIG. 36 is a second end view of the jumper interface module of FIG. 32;

FIG. 37 is an exploded view of the jumper interface module of FIG. 3 showing a jumper support structure and a jumper interface busbar;

FIG. 38 is a perspective view of an extent of the jumper interface module of FIG. 37, where the jumper interface busbar has been removed from the jumper support structure;

FIG. 39 is perspective view of the jumper interface busbar;

FIG. 40 is a perspective view of the positive connector module of FIG. 3;

FIG. 41 is a top view of the positive connector module of FIG. 40;

FIG. 42 is a front view of the positive connector module of FIG. 40;

FIG. 43 is a cross-sectional view of the positive connector module of FIG. 3 take along line 43-43 in FIG. 41;

FIG. 44 is a first end view of the positive connector module of FIG. 40;

FIG. 45 is a second end view of the positive connector module of FIG. 40;

FIG. 46 is an exploded view of the positive connector module of FIG. 3 showing: (i) a positive support structure, (ii) a positive female connector assembly having a female housing assembly and a female terminal assembly, and (iii) a positive terminal busbar;

FIG. 47 is a perspective view of an extent of the positive connector module of FIG. 46, where the female terminal assembly and the positive terminal busbar have been removed;

FIG. 48 is a zoomed in view of the positive female housing assembly of FIG. 47;

FIG. 49 is a cross-sectional view of the positive connector module take along line 49-49 in FIG. 47;

FIG. 50 is a perspective view of the female terminal assembly and the positive busbar of the positive connector module of FIG. 46, shown in a coupled state;

FIG. 51 is a top view of the female terminal and the positive terminal busbar of FIG. 50;

FIG. 52 is a side view of the female terminal and the positive terminal busbar of FIG. 50;

FIG. 53 is a perspective view of the positive terminal busbar;

FIG. 54 is a perspective view of the female terminal assembly;

FIG. 55 is a perspective view of the electrical transfer assembly of FIG. 1, wherein the electrical transfer assembly includes the plurality of female connector assemblies;

FIG. 56 is a front view of the electrical transfer assembly of FIG. 55;

FIG. 57 is a rear view of the electrical transfer assembly of FIG. 55;

FIG. 58 is a top view of the electrical transfer assembly of FIG. 55;

FIG. 59 is a bottom view of the electrical transfer assembly of FIG. 55;

FIG. 60 is a top view of a busbar assembly of FIG. 1 that includes a busbar and opposed male connector assemblies;

FIG. 61 is a cross-sectional view of the busbar assembly taken along line 61-61 of FIG. 60;

FIG. 62 is an exploded view of a portion of the busbar assembly of FIG. 60 showing a male terminal housing and a male terminal assembly;

FIG. 63 is a perspective view of the male terminal assembly of FIG. 62 showing a male terminal body and internal spring member in a disassembled state;

FIG. 64 is a perspective view of the male terminal assembly of FIG. 62 in a partially assembled state;

FIG. 65 is a side view of the male terminal assembly of FIG. 62 in an assembled state;

FIG. 66 is a cross-sectional view of the male terminal assembly taken along line 66-66 of FIG. 65;

FIG. 67 is a side view of a portion of the busbar assembly of FIG. 60;

FIG. 68 is a cross-sectional view of the portion of the busbar assembly taken along line 68-68 of FIG. 67;

FIG. 69 is a side view of a portion of the busbar assembly of FIG. 60;

FIG. 70 is a cross-sectional view of the portion of the busbar assembly taken along line 70-70 of FIG. 69;

FIG. 71 is a perspective view of the battery module and the boltless busbar assembly of FIG. 1, wherein the battery module housing has been omitted and a portion of the battery cells have been removed to show the internal electrical transfer assembly;

FIG. 72 is a side view of the battery module and the boltless busbar assembly of FIG. 71;

FIG. 73 is a side view of the boltless connector system of FIG. 1 in a fully connected state, where an extent of the boltless male connector assembly and female connector assembly have been omitted;

FIG. 74 is a cross-sectional view of the boltless connector system taken along line 74-74 of FIG. 73;

FIG. 75 is a perspective view of a battery pack having a plurality of boltless connector systems that couple the battery cells contained in the battery modules of FIG. 1 to each other using a plurality of boltless busbar assemblies;

FIG. 76 is a perspective view of a second embodiment of a battery pack having a plurality of boltless connector systems that couple the battery cells contained in a battery modules of FIG. 78 to each other using a plurality of boltless busbar assemblies;

FIG. 77 is an exploded view of the battery pack of FIG. 76, wherein the housing has been omitted and the individual battery modules are visible;

FIG. 78 is perspective view of the battery module contained in the battery pack of FIG. 77, wherein an extent of the housing has been removed to show the battery cells contained therein;

FIG. 79 is a perspective view of an alternative embodiment of a battery module that may be used in the second embodiment of a battery pack of FIG. 76;

FIG. 80 is a perspective view of a third embodiment of a battery pack having upper and lower housings, internal support trays, and a plurality of boltless connector systems that couple the battery cells contained in a battery modules of FIG. 81 to each other using a plurality of boltless busbar assemblies;

FIG. 81 is an exploded view of the battery module of FIG. 80;

FIG. 82 is alternative embodiment of a battery cell having a plurality of female connector assemblies;

FIG. 83 is a perspective view of a battery pack of FIG. 75 installed within a skateboard mounting platform of a vehicle;

FIG. 84 is a perspective view of a vehicle that includes the skateboard mounting platform of FIG. 83;

FIG. 85 is a perspective view of a passenger bus including a battery pack having a plurality of boltless connector systems that couple the battery cells contained in the battery modules to each other using a plurality of boltless busbar assemblies;

FIG. 86 is a perspective view of a large ship including a battery pack having a plurality of boltless connector systems that couple the battery cells contained in the battery modules to each other using a plurality of boltless busbar assemblies;

FIG. 87 is a perspective view of a ship including a battery pack having a plurality of boltless connector systems that couple the battery cells contained in the battery modules to each other using a plurality of boltless busbar assemblies;

FIG. 88 is a second embodiment of a boltless connector system having a male connector assembly, a busbar, and a female connector assembly, wherein the boltless connector system is in a fully connected state;

FIG. 89 is a rear view of the boltless connector system of FIG. 88;

FIG. 90 is an exploded view of the boltless connector system of FIG. 88 showing a female terminal assembly and a male terminal assembly;

FIG. 91 is a perspective view of the female connector assembly of FIG. 88 showing a female terminal assembly and a female terminal housing;

FIG. 92 is a front view of the female connector assembly of FIG. 91;

FIG. 93 is a rear view of the female connector assembly of FIG. 91;

FIG. 94 is a perspective view of the female terminal assembly of FIG. 91;

FIG. 95 is a front view of the female terminal assembly of FIG. 91;

FIG. 96 is a rear view of the female terminal assembly of FIG. 91;

FIG. 97 is a perspective view of a battery cell with a second embodiment of a boltless connector system;

FIG. 98 is an exploded view of the battery module that includes a plurality of battery cells of FIG. 97;

FIG. 99 is a block diagram shown one configuration of a battery pack having a boltless connector system;

FIG. 100 is a block diagram showing components of the battery module;

FIG. 101 is a block diagram showing components of the battery module housing;

FIG. 102 is a block diagram showing components of the battery cells;

FIG. 103 is a block diagram showing components of the interior interface module;

FIG. 104 is a block diagram showing components of the exterior interface module;

FIG. 105 is a block diagram showing components of jumper interface module;

FIG. 106 is a block diagram showing components of negative connector module;

FIG. 107 is a block diagram showing components of busbar mount of the negative connector module;

FIG. 108 is a block diagram showing components of battery cell interface of the negative connector module;

FIG. 109 is a block diagram showing components of negative female housing of the negative connector module;

FIG. 110 is a block diagram showing components of negative female terminal assembly of the negative connector module;

FIG. 111 is a block diagram showing components of positive connector module;

FIG. 112 is a block diagram showing components of busbar mount of the positive connector module;

FIG. 113 is a block diagram showing components of battery cell interface of the positive connector module;

FIG. 114 is a block diagram showing components of positive female housing of the positive connector module;

FIG. 115 is a block diagram showing components of positive female terminal assembly of the positive connector module;

FIG. 116 is a block diagram showing components of busbar assembly;

FIG. 117 is a block diagram showing components of male housing assembly;

FIG. 118 is a block diagram showing components of male terminal assembly; and

FIG. 119 is a block diagram showing components of spring member.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistently with the disclosed methods and systems. Accordingly, the drawings and detailed descriptions are to be regarded as illustrative in nature, not restrictive or limiting.

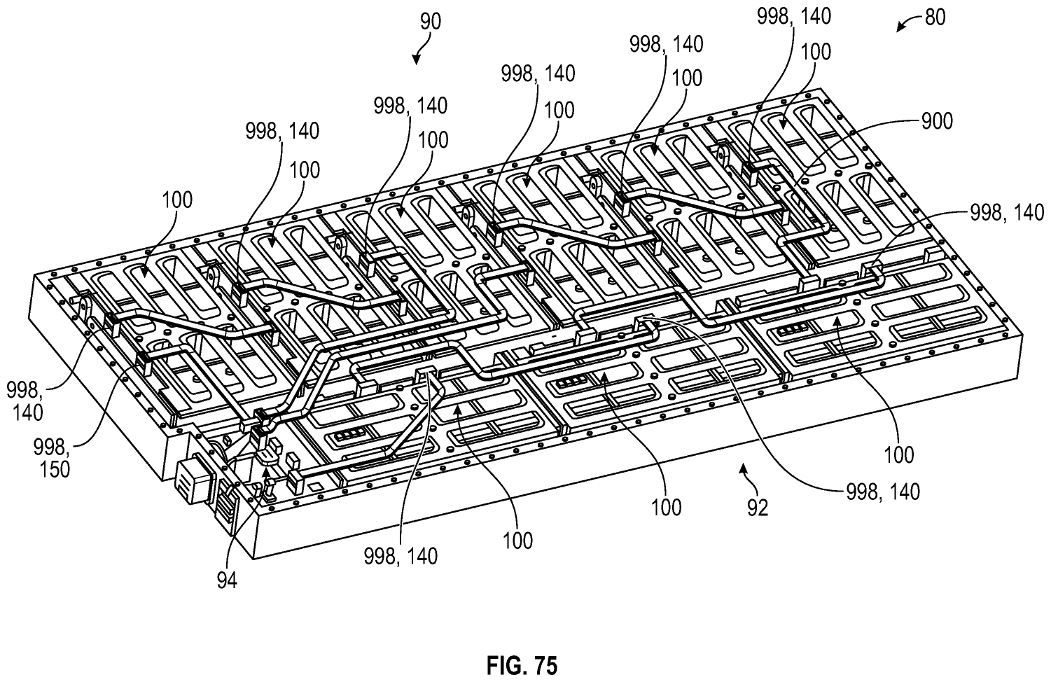

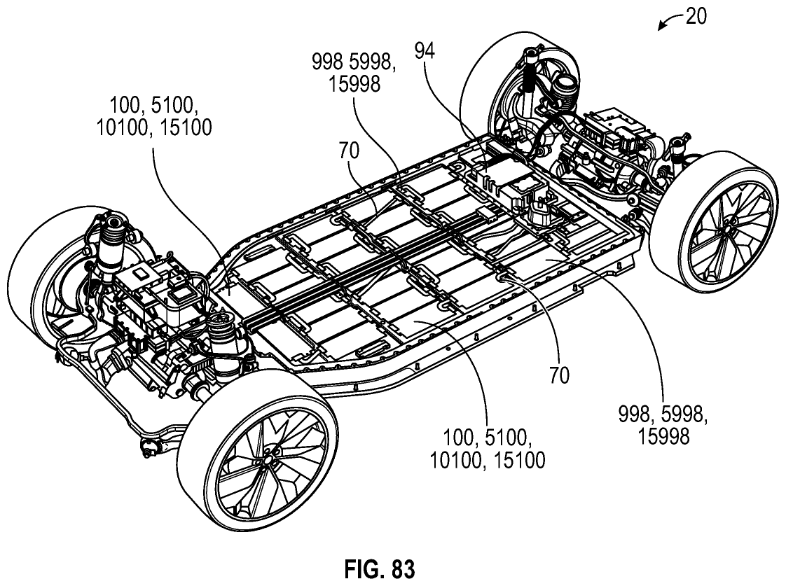

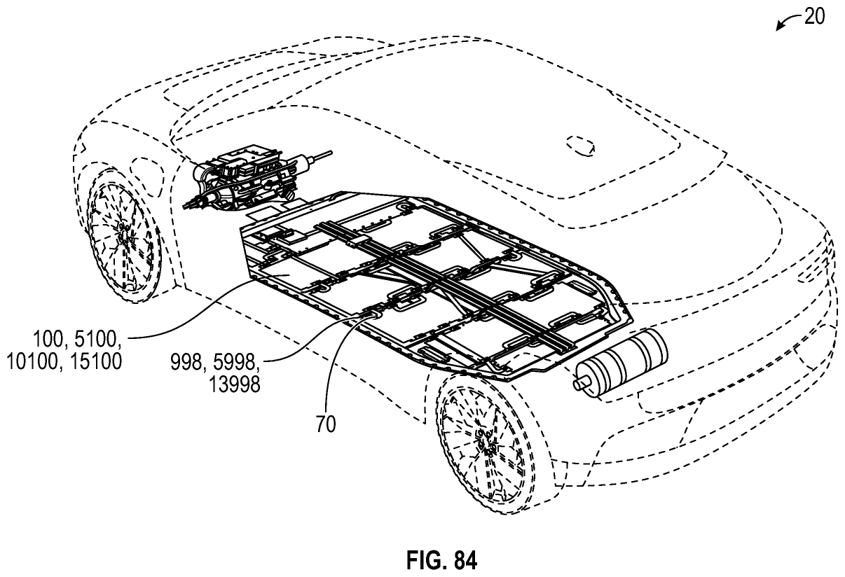

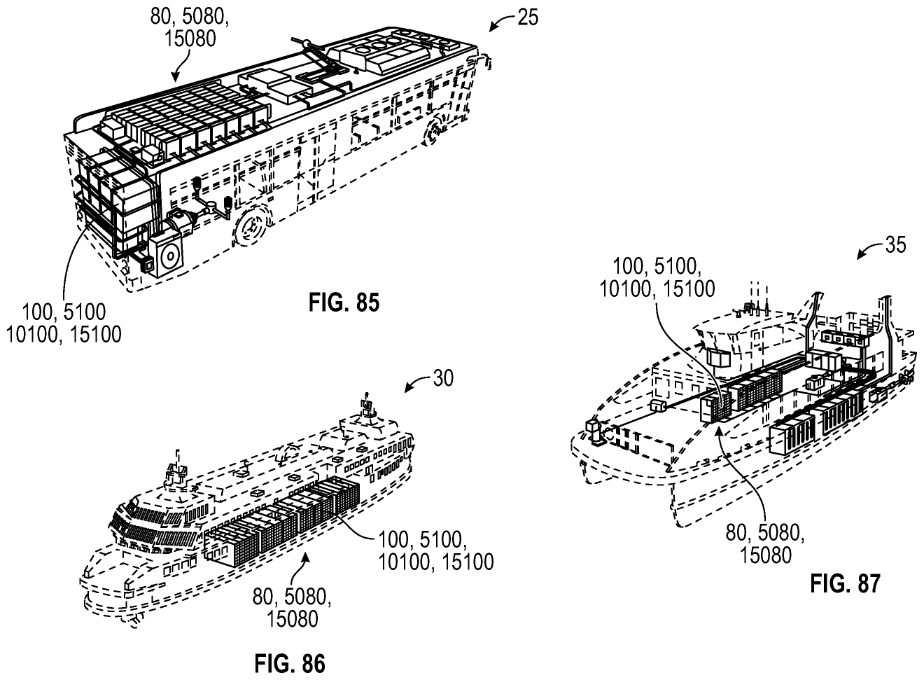

The Figures show applications 10 having a power distribution system 50 with a battery pack 80. Said applications 10 include, but are not limited to: an airplane, motor vehicle 20 (FIG. 84), a military vehicle (e.g., tank, personnel carrier, heavy-duty truck, and troop transport), a bus 25 (FIG. 85), a locomotive, a tractor, a boat, a submarine, large ship 30 (FIG. 86), ship 35 (FIG. 87), tanker, sailing yacht, telecommunications hardware (e.g., server), a power storage system (e.g., backup power storage systems), renewable energy hardware (e.g., wind turbines and solar cell arrays). In these applications 10, the power distribution system 50 is essential to meet industry standards, production, and performance requirements. As shown in FIGS. 75, 77, 80, and 83-87, each application, such as a ship 30, 35, bus 25, and/or motor vehicle 20, includes at least one battery pack 80 having: (i) a plurality of battery modules or boltless battery modules 100 and/or a plurality of battery cells or boltless battery cells 30169, and (ii) a plurality of busbar assemblies or boltless busbar assemblies 70 that couple the battery modules 100 and/or a plurality of boltless battery cells 30169 to one another. Additionally, other embodiments, configurations, and uses for the battery pack 80, battery modules 100, and boltless battery cells 30169 described within this application are contemplated by this disclosure.

The battery pack 80 includes a plurality of connector systems or boltless connector systems 998 that couples the battery cells 170 contained in the battery modules 100 to each other using a plurality of boltless busbar assemblies 70. In particular, the boltless connector system 998 includes: (i) a boltless female connector assembly or female terminal connector assembly 2000, 3000 of the battery modules 100, and (ii) a boltless male terminal connector assembly or male terminal connector assembly 1000 of the boltless busbar assembly 70. As such, each battery module 100 typically includes two female terminal connector assemblies 2000, 3000 that form the positive and negative external connections 140, 150 of battery module 100. One of the external connections 140, 150 of a first battery module 100 may be coupled to one of the external connections 140, 150 of a second battery module 100 using a boltless busbar assembly 70, while the other external connections 140, 150 of the first battery module 100 and the second battery module 100 may be coupled to other structures using two boltless busbar assemblies 70. Accordingly, a battery pack 80 that includes nine battery modules 100 (see FIG. 75) will typically have at least sixteen boltless connector systems 998 and preferably more than eighteen boltless connector systems 998.

### I. Battery Module Housing

The battery modules 100 include: (i) a battery module housing 110, (ii) the battery cells 170, and (iii) the electrical transfer assembly 200. The battery module housing 110 includes a plurality of walls 112 (e.g., an arrangement of four side walls 114a-114d, a bottom wall 114e, and a top wall 114f) that form a receiver 118 configured to receive and protect: (i) the battery cells 170 and (ii) electrical transfer assembly 200. The top wall 114f includes at least two battery module openings 116a, 116b formed there through, wherein said openings 116a, 116b are configured to receive an extent of the female connector assembly 2000, 3000 formed in an extent of the electrical transfer assembly 200. Specifically, the openings 116a, 116b allow for the male connector assembly 1000 to mate with the female connector assemblies 2000, 3000, which in turn allows electrical current to flow into and out of the battery cells 170 contained within the battery module 100. It should be understood that the connection between the female and male connector assemblies 1000, 2000, 3000 is boltless and may be “PCT” (push, click, tug) compliant. As discussed within this application, this boltless connection is a substantial advantage over traditional battery module connectors that utilize bolted connections.

### II. Battery Cells

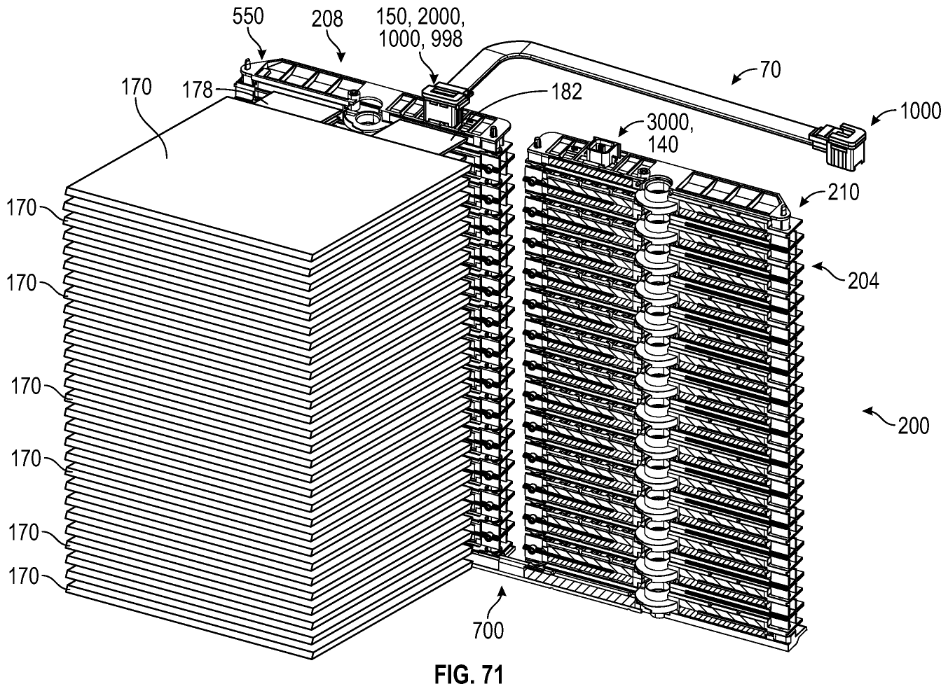

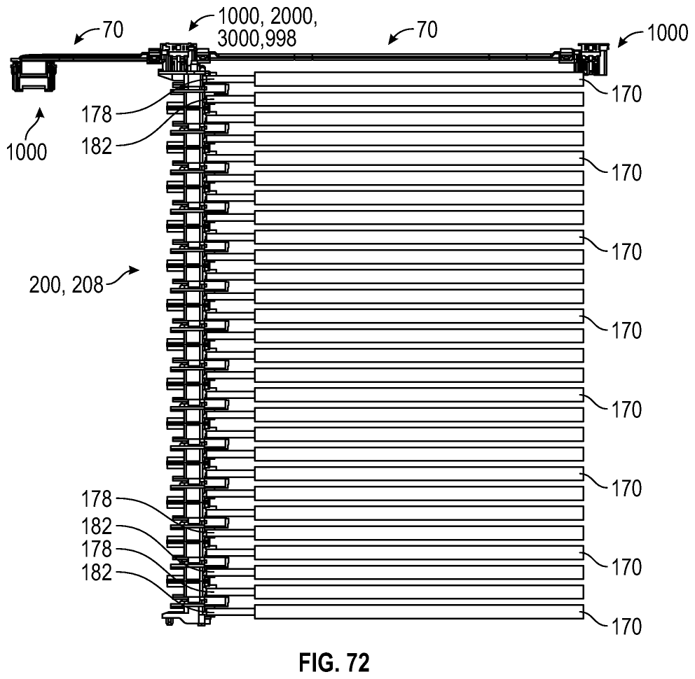

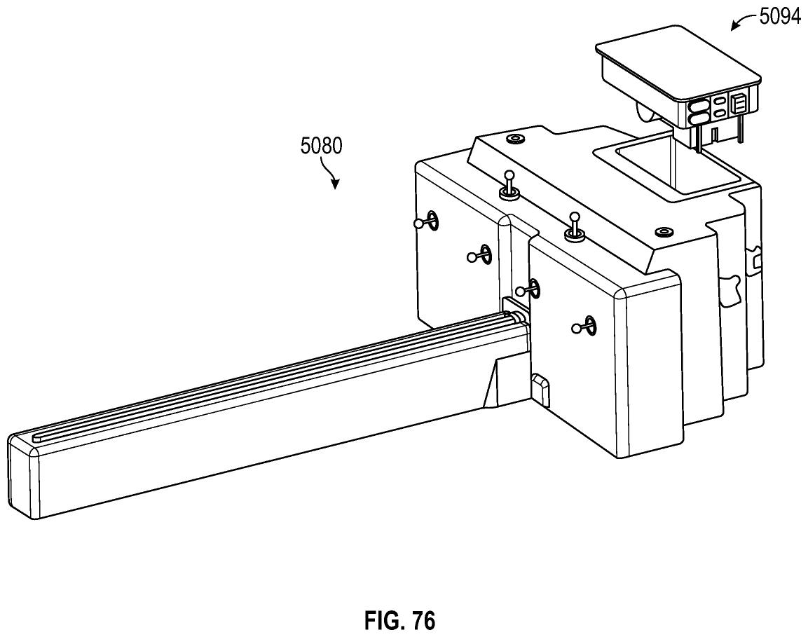

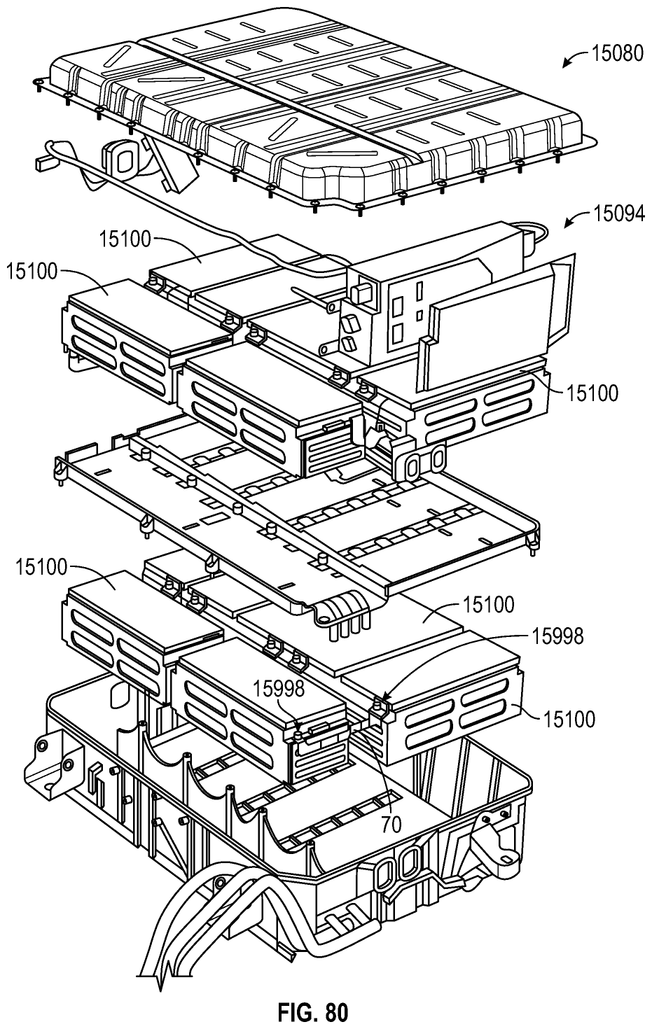

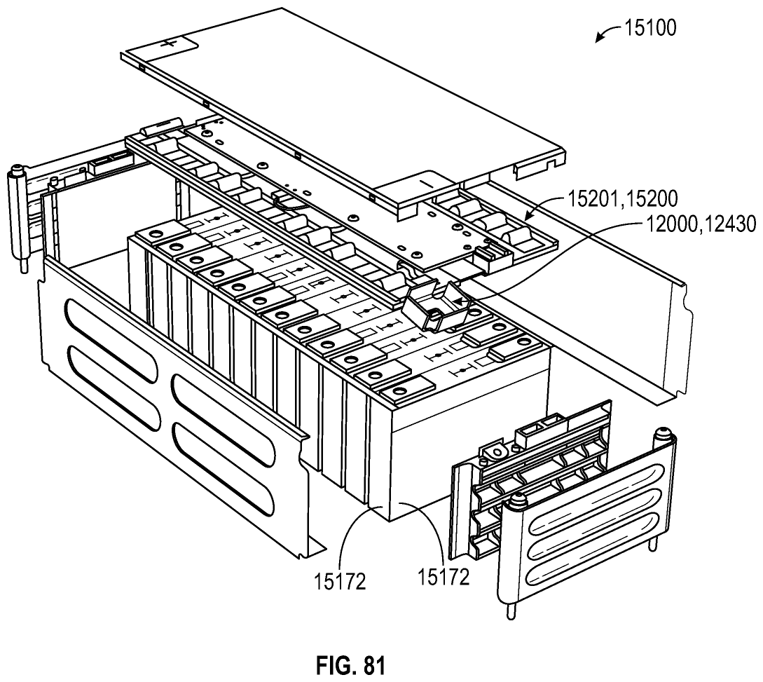

The battery modules 100 contain a plurality of battery cells 170, which may have a pouch configuration (see FIGS. 71-72), a cylindrical configuration (see FIGS. 76-79), a prismatic configuration (see FIGS. 80-81), any combination thereof, and/or any other known battery cell configuration. Specifically, the pouch configuration in FIGS. 71-72 includes: (i) housing 174, (ii) a positive terminal 178, and (iii) a negative terminal 182. Housing 174 is designed to house the materials that store the electrical charge, such as lithium or other similar metals. The positive and negative terminals 178, 182 couple the materials contained within the housing 174 to the electrical transfer assembly 200. The terminals 178, 182 may have a blade-shape configuration (see FIG. 71-72); however, other terminal shapes are possible (e.g., boltless connectors, bolted connectors, other structures that can be welded, press-fit, or sandwiched by the electrical transfer assembly 200). The positive and negative terminals 178, 182 are typically formed from different materials to facilitate the charging and discharging of the battery cell 170. For example, the positive terminal or anode 178 may be formed from: (i) graphite, (ii) silicon, or (iii) graphene, while the negative terminal or cathode 182 may be formed from: (i) cobalt, (ii) iron, (iii) nickel-magnesium, (iv) nickel, or (v) sulfur. It should be understood that other materials may be used for said terminals 178, 182. The battery cells 170 may have an output voltage that is between 0.2 volts and 10 volts, an amperage hour rating between 10 Ah to 100 Ah, and may have an energy density that is between 20 Wh/kg and 500 Wh/kg (see Qiao, Y., et. al. A 500 Wh/kg Lithium-Metal Cell Based on Anionic Redox. Joule, this issue, 1445-1458, which is hereby incorporated by reference).

### III. Electrical Transfer Assembly

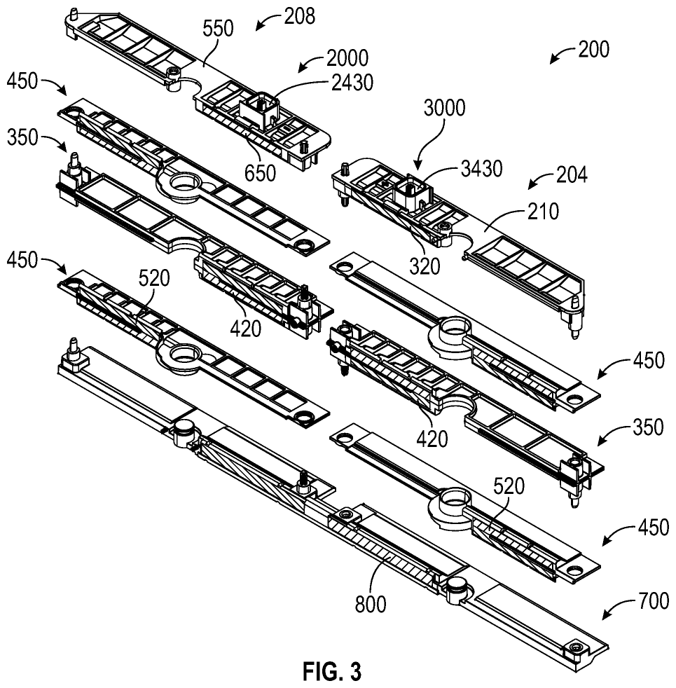

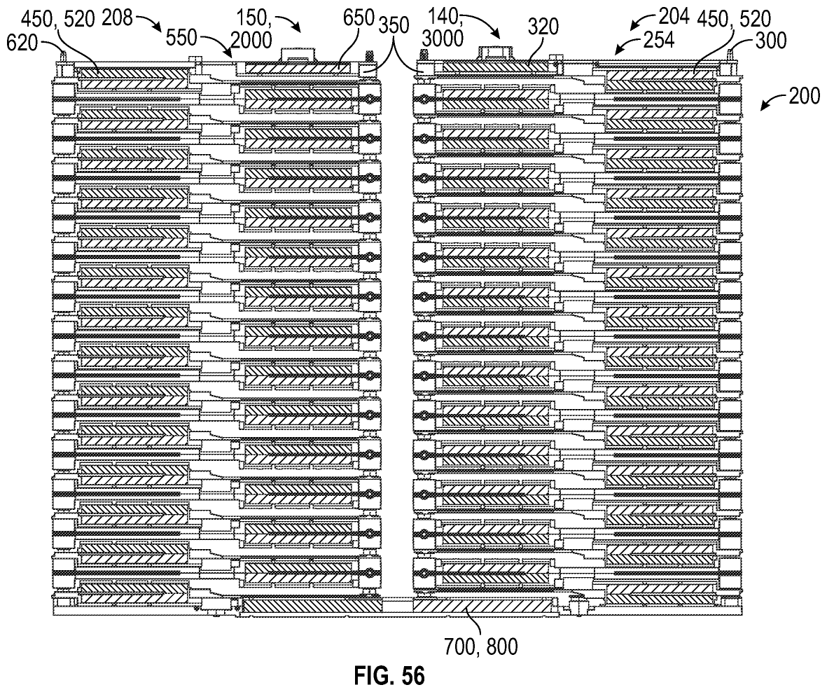

The electrical transfer assembly 200: (i) interconnects the battery cells 170 to one another and (ii) provides an external connection 140, 150, such that the plurality of battery cells 170 can be coupled to a component that is outside of the battery module housing 110. In particular, the electrical transfer assembly 200 connects a plurality of battery cells 170 in series to form: (i) a positive or first battery cell stack 204 and (ii) a negative or second battery cell stack 208. These serial connections are designed to increase the voltage of the battery module 100. To facilitate this design, the positional relationship of the positive and negative terminals 178, 182 are alternated for each battery cell 170 (see FIG. 72). As discussed in greater detail below, alternating the positive and negative terminals 178, 182 may require that the materials contained within the transfer assembly 200 also alternate. This is best seen in connection with FIGS. 3, 56 and 71, wherein the surface shading having a greater density or a steeper angle represents an extent of the busbar that is formed from aluminum and is designed to be coupled to the positive terminal 178 of the battery cell 170 and the surface shading that is less dense or a shallower angle represents an extent of the busbar that is formed from copper and is designed to be coupled to the negative terminal 182 of the battery cell 170.

The first and second battery cell stacks 204, 208 may contain any number of individual battery cells 170. For example, the first and second battery cell stacks 204, 208 may each contain: (i) between two battery cells 170 to any number of battery cells 170, (ii) preferably between eight battery cells 170 to three-hundred battery cells 170, (iii) more preferably between fourteen battery cells 170 and hundred battery cells 170, and (iv) most preferably between twenty battery cells 170 to fifty battery cells 170. To achieve these serial connections, the electrical transfer assembly 200 includes an interior interface module 350 and an exterior interface module 450. The specific structure and design of these modules 350, 450 will be discussed in greater detail below.

The electrical transfer assembly 200 also connects the first battery cell stack 204 and the second battery cell stack 208 in series using a jumper interface module 700. It should be understood that only a single jumper interface module 700 is included within the electrical transfer assembly 200 because the battery module 100 only contains two battery cell stacks 204, 208 of battery cells 170. In other embodiments, the jumper interface module 700 may be omitted because the battery module 100 may only contain one battery cell stack 204. Or, the battery module 100 may contain more than ten jumper interface modules 700 because the battery module 100 may have more than 20 battery cell stacks 204, 208. Nevertheless, it is preferable to have less than three jumper interface modules 700 within a single battery module 100 because servicing large battery modules within a battery pack is more difficult than servicing a battery pack 80 that includes multiple smaller battery modules. For example, it is more difficult to find and replace a single cell within a large module while under a time constraint to get the application 10 (e.g., vehicle, ship, boat, or etc.) operable again in comparison to replacing the battery module and then working to diagnose the problem after the service has been complete on the application 10 (e.g., vehicle, ship, boat, or etc.). The specific structure and design of this jumper module 700 are discussed in greater detail below.

As shown in the Figures, the electrical transfer assembly 200 contains at least one female connector assembly 2000, 3000 that is configured to receive an extent of a male connector assembly or boltless male connector assembly 1000. Preferably the electrical transfer assembly 200 includes two female connector assemblies 2000, 3000, wherein: (i) a first boltless female connector assembly, a first female connector assembly, positive boltless female connector assembly, or positive female connector assembly 3000 is (a) contained in the positive connector module 210, (b) provides a positive external connection 140 for the battery module 100, and (c) is designed to receive an extent of a positive male terminal assembly 1430, and (ii) a second boltless female connector assembly, second female connector assembly, negative boltless female connector assembly, or negative female connector assembly 2000 is (a) contained in the negative connector module 550, (b) provides a negative external connection 150 for the battery module 100, and (c) is designed to receive an extent of a negative male terminal assembly 1430. While the battery module 100 shown in the figures contains two female connector assemblies 2000, 3000, it should be understood the battery module 100 may have more or less female connector assemblies 2000, 3000. For example, the battery module 100 may only have a single female connector assembly 2000, 3000 or the battery module 100 may include over ten female connector assemblies 2000, 3000.

a. Negative Connector Module

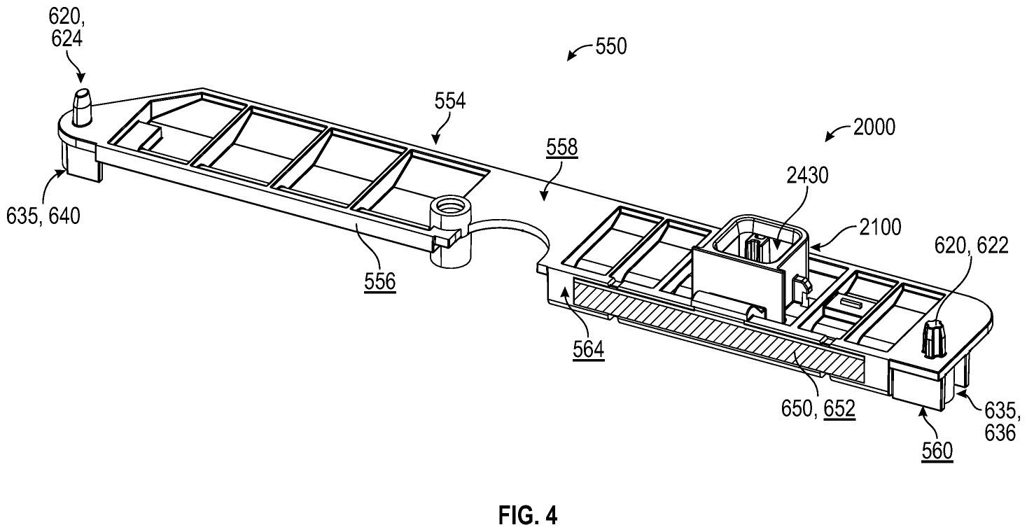

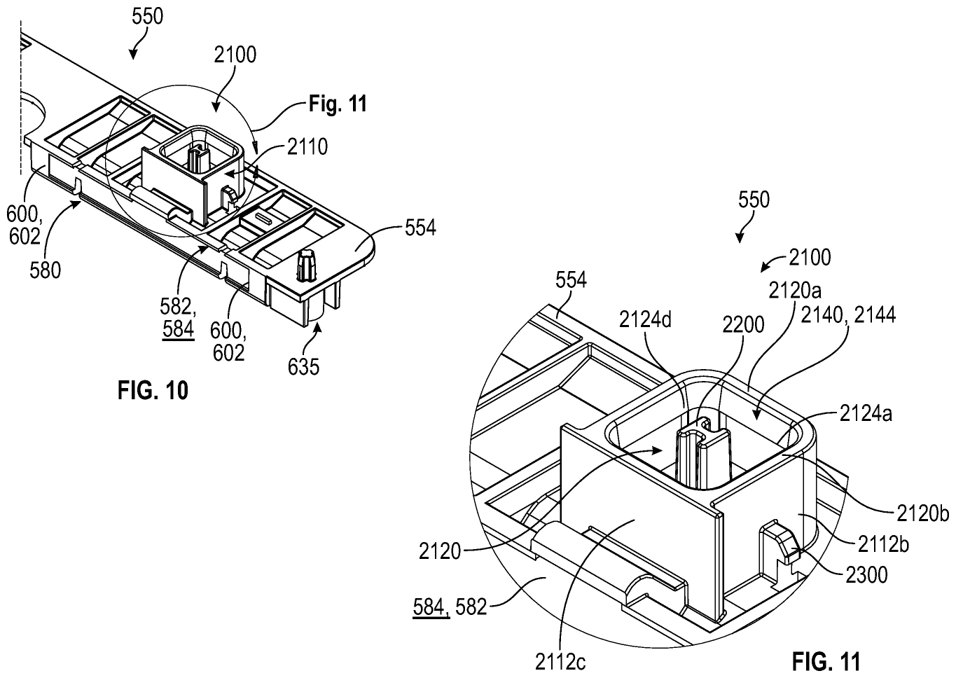

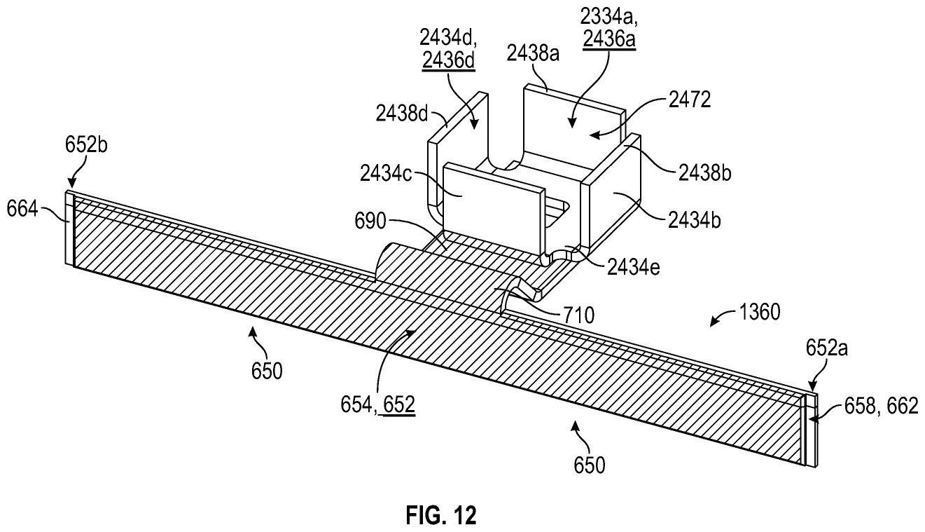

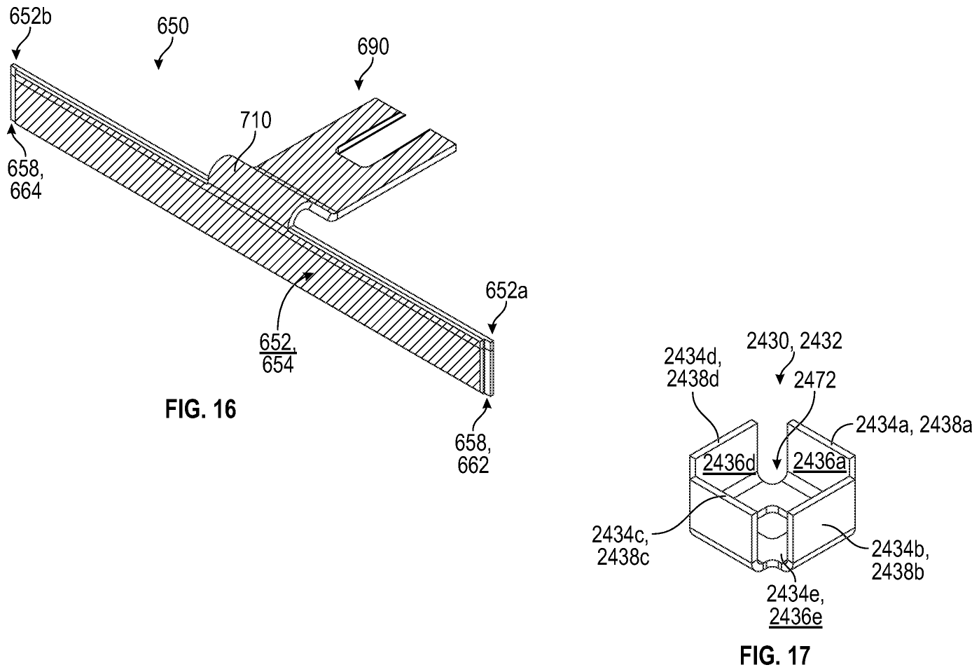

Referring to FIGS. 4-17, the negative connector module 550 includes: (i) a negative support structure 554, (ii) a negative busbar, internal negative busbar, second inner busbar, or second busbar 650, and (iii) a negative boltless female connector assembly, boltless female connector assembly, negative female connector assembly, or female connector assembly 2000. The negative support structure 554 has an elongated body and includes: (i) a busbar mount 580, (ii) a plurality of support projections 620, and (ii) a plurality of support receivers 635. The negative support structure 554 is designed to: (i) allow for the alignment of the negative busbar 650 with the negative terminal 182 of the battery cell 170 and (ii) provide enough space for the exterior interface module 450 to position the exterior busbar 520 outside of the negative busbar 650. This configuration allows the transfer assembly 200 to be properly coupled to the battery cells 170. The busbar mount 580 extends downward from an upper surface 558 of the negative support structure 554 and is designed to receive and position the negative busbar 650 for coupling with the negative terminal 182 of the battery cell 170. The busbar mount 580 includes: (i) mounting surface 584 and (ii) busbar coupler 600. The mounting surface 584 is depressed or recessed from the frontal surface 556 of the negative support structure 554, wherein said depression or recess from a busbar receiver 582. Said busbar receiver 582 is designed to receive the negative busbar 650 and place the front surface 652 of said busbar 650 substantially flush with an extent 564 of the interior support structure 554 that is adjacent to the mounting surface 584. In other words, the busbar receiver 582 has a depth, width, and height that is approximately equal to the depth, width, and height of the busbar 650. It should be understood that other embodiments: (i) the front surface 652 of said busbar 650 may not be substantially flush with an extent 564 of the negative support structure 554, and (ii) the mounting surface 584 and thus the busbar receiver 582 may be omitted.

The busbar coupler 600 includes at least one projection 602 that extends inward from an outer edge of mounting surface 584 and is designed to overlay an extent of the busbar 650, when the busbar 650 is inserted into the busbar receiver 582. To position the busbar 650 within the receiver 582 and under the projection 602, an assembler or machine will apply a force that is sufficient in order to cause the projection 602 to elastically deform to receive the busbar 650. Once the busbar 650 is received by the receiver 582, the projection 602 will return to its original position and as such it will overlay and extent of the busbar 650. By overlaying an extent of the busbar 650, the projection 602 ensures that the busbar 650 is retained within the receiver 582. It should be understood that other methods of coupling the busbar 650 to the negative support structure 554 may be used. For example, the busbar 650 may be inserted into a mold and the polymer that is used to form the support structure 554 may be injected around the busbar 650. In further embodiments, the coupler 600 may include additional structures (e.g., other projections), or different structures (e.g., some of which are disclosed below) that are designed to retain the busbar 650 within the receiver 582.

The plurality of support projections 620 and a plurality of support receivers 635 facilitate the boltless assembly of the transfer assembly 200. The plurality of support projections 620 include: (i) a first support projections 622 located near a first end of the support structure 554, and (ii) a second support projection 624 located near a second opposed end of the support structure 554. The first and second support projections 622, 624 extend upwards from an upper surface 558 of the support structure 554 are configured to interact with a receiver (not shown) that is mounted on the inner surface of the top wall 114f of the battery module 100. This opposed positional relationship of the support projections 622, 624 helps ensure that the entire support structure 554 is secured within and to the housing 110, while minimizing the number of projections 622, 624 and/or structures. This is desirable because: (i) it reduces the weight of the transfer assembly 200, thereby reducing the weight of the battery module 100, and (ii) does not require bolts or other connectors, thereby reducing failure modes and assembly times. Nevertheless, other configurations of the support projections 622, 624 are contemplated by this disclosure. For example, the support projections 622, 624 may be replaced with a support wall that extends around a portion or the entire periphery of the support structure 554. In another example, the support projections 622, 624 may extend from the sides of the support structure 554 instead of the upper surface 558 of the support structure 554. In a further embodiment, additional support projections 622, 624 may be added to extend from the rear and sides of the support structure 554, such that the transfer assembly 200 is secured within and to the battery module housing 110 in multiple different directions (e.g., top, side, and rear).

Like the plurality of support projections 620, the support structure 554 includes: (i) a first support receptacle 636 located near the first end of the support structure 554, and (ii) a second support receptacle 640 located near a second opposed end of the support structure 554. The first and second support receptacle 636, 640 extend downward from an lower surface 560. Said support receptacle 636, 640 are configured to interact with the first and second support projections 402, 404 that extend from other structures (e.g., interior interface module 350) within the transfer assembly 200. This opposed positional relationship of the support receptacle 636, 640 helps ensure that the entire support structure 554 is secured other structures 350, 450 within the battery module's housing 110, while minimizing the number of receptacle 636, 640 and/or structures. This is desirable because it reduces the weight of the transfer assembly 200 and in turn the weight of the battery module 100. Nevertheless, other configurations of the support receptacle 636, 640 are contemplated by this disclosure.

The negative female connector assembly 2000 is comprised of: (i) a negative female housing 2100 and (ii) a negative boltless female terminal assembly, boltless female terminal assembly, negative female terminal assembly, or female terminal assembly 2430. The female housing 2100 is designed to: (i) receive the female terminal assembly 2430, (ii) facilitate the coupling of the male terminal assembly 1430 with the female terminal assembly 2430, (iii) minimize the chance that a foreign object accidentally makes contact with the female terminal assembly 2430, and (iv) meet industry standards, such as USCAR specifications. In the Figures, the female housing 2100 is integrally formed with the negative support structure 554 and extends upward from an upper surface 558 of said support structure 554. These structures are integrally formed using an injection molding process, but it should be understood that other processes may be used (e.g., 3D printing and other types of molding). However, other structural arrangements are contemplated. For example, the female housing 2100 may be pivotally attached to one side of the support structure 554, removable coupled using a press-fit or snap-lock configuration, or may not be coupled to the support structure 554 at all and instead is coupled to the battery module housing 110 or the cell housing 174.

The female housing 2100 includes a wall arrangement 2110 having four sidewalls 2112a-2112d. Said sidewalls 2112a-2112d extend upward from an upper surface 558 of said support structure 554 and have a configuration that substantially matches the configuration of the female terminal assembly 2430. In the embodiment shown in the figures, the female terminal assembly 2430 has a cuboidal configuration and thus the sidewalls 2112a-2112d have a linear configuration and form a cuboidal receiver 2120. However, it should be understood that alterations to the shape of the female terminal assembly 2430 (e.g., use of a cylindrical terminal) may require that the shape and configuration of the sidewalls 2112a-2112d be altered to mirror the shape of the terminal (e.g., hollow cylinder).

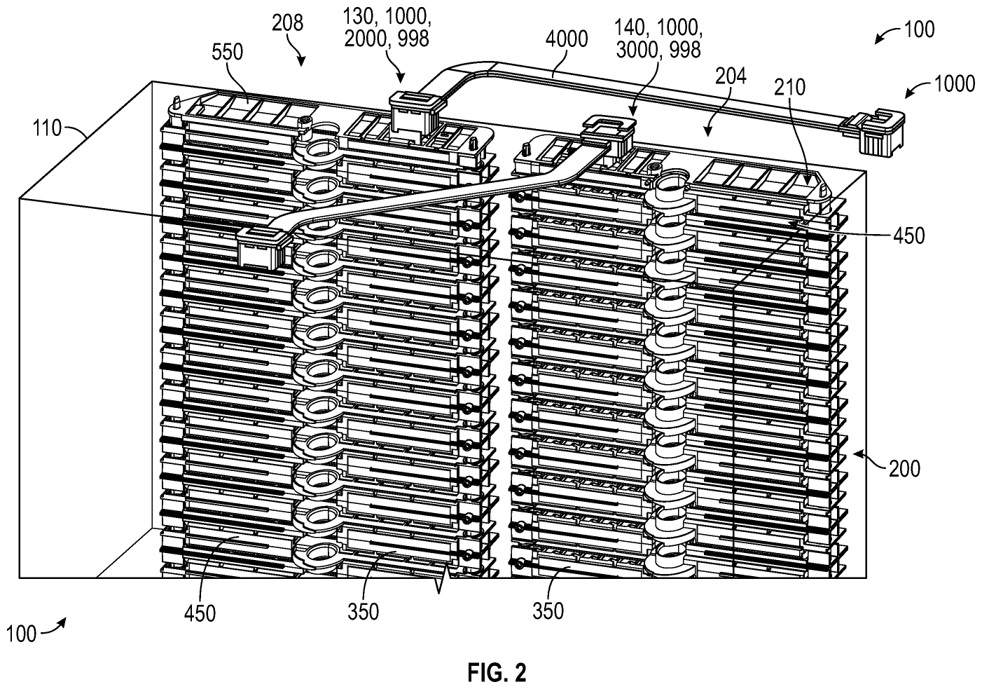

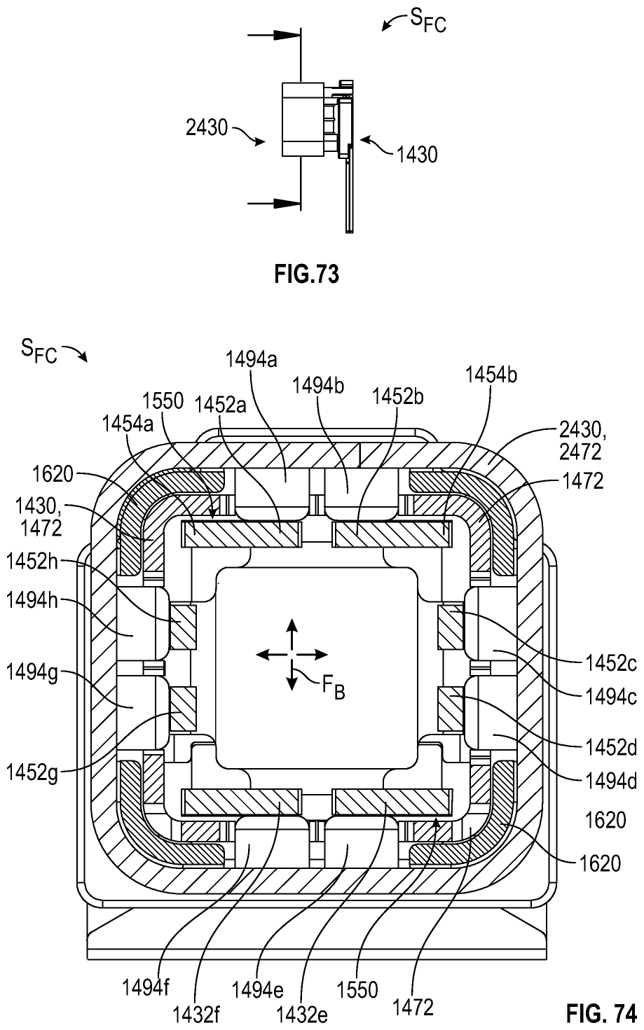

The sidewalls 2112a-2112d have a height that is greater than the height of the female terminal assembly 2430. The delta between these heights allows for the sidewalls 2112a-2112d to include at least one male compression means 2140. As shown in the Figures, the male compression means 2140 is a sloped or ramped surface 2144 that extends from a outermost edges 2120a-2120d of the sidewalls 2112a-2112d to the upper most edges 2430a-2430d of the female terminal assembly 2430. In the disclosed embodiment, the sloped or ramped surface 2144 extends from each of the outermost edges 2120a-2120d and has a substantially linear configuration. However, it should be understood that the sloped or ramped surface 2144 may only extend from one or two of the outermost edges 2120a-2120d. The male compression means 2140, and the sloped or ramped surface 2144 shown in the Figures, is designed to compress the contact arms 1494a-1494h as the male terminal assembly 1430 moves from being separated from the female terminal assembly 2430 in a disconnected state to being positioned within an extent of the female terminal assembly 2430 in a fully connected state S_{FC} (see FIGS. 2 and 71-74). As such, the distance between opposed outermost edges 2120a-2120d is equal to a sidewall distance, wherein the sidewall distance is greater than the rearmost edge distance that extends between opposed rearmost edges 2124a-2124d of the sloped or ramped surface 2144. And wherein the rearmost edge distance is greater than or equal to a receiver distance that extends between opposed inner surfaces 2434a-2434d of the receptacle 2472 of the female terminal assembly 2430. In particular, the sidewall distance is between 0.1% and 15% larger than the receiver distance, and where the receiver distance is equal to or between 0.1% and 3% larger than the rearmost edge distance. In other words, the sloped or ramped surface 2144 is angled relative to the outer surface of the sidewalls 2112a-2112d and/or the inner surfaces 2434a-2434d of the receptacle 2472 of the female terminal assembly 2430. In particular, the interior angle that extends between the inner surface of the sloped or ramped surface 2144 and the outer surface of the sidewalls 2112a-2112d is between 0.1 degrees and 10 degrees.

This sloped or ramped surface 2144 is made from a polymer or plastic material and, as such has a coefficient of friction that is lower than a coefficient of friction associated with a metal surface. In other words, a first friction value is formed when the extent (e.g., a contact arm 1494a-1494h) of the boltless male terminal assembly 1430 engages with a male terminal compression means 2140 formed from a non-metallic material (e.g., plastic). In an alternative embodiment, a second friction value would be formed if the extent (e.g., a contact arm 1494a-1494h) of the boltless male terminal assembly 1430 was to engage with a male terminal compression means formed from a metallic material (e.g., copper). Comparing the friction value from the disclosed embodiment to the friction value alternative embodiment, it should be understood that the first or friction value from the disclosed embodiment is less than the second or friction value alternative embodiment.

The lower coefficient of friction reduces the force that is required to insert the male terminal assembly 2430 into the female terminal assembly 1430. This is beneficial because: (i) industry specifications, including USCAR 25, has requirements that the insertion force cannot be greater than 45 newtons for a class 2 connector and 75 newtons for a class 3 connector and (ii) the use of a greater spring biasing force, which thereby increases the insertion force, is desirable to help ensure that the contact arms of the male terminal assembly remain in contact with the inner surfaces 2434a-2434d of the receptacle 2472 of the female terminal assembly 2430. Further, this lower coefficient of friction is beneficial because the boltless connector assembly 998 can move from the disconnected state to a fully connected state while meeting class 2/class 3 USCAR specifications without requiring a lever assist. Eliminating the lever assist reduces the size, weight, and cost of manufacturing the connector system 998. It should be understood that to further reduce the coefficient of friction, the sloped or ramped surface 2144 may be coated with a substance that reduces this coefficient or the sloped or ramped surface 2144 may be made from a material that has an even lower coefficient of friction.

Due to the configuration of the male and female connectors 1000, 2000, different levels of force are required during various stages of moving the boltless connector system 998 moves from the disconnected state to the fully connected state S_{FC}. For example, a first force is required to move the boltless male terminal assembly 1430 when an extent (e.g., a contact arm 1494a-1494h) of the boltless male terminal assembly 1430 is in sliding engagement with the male terminal compression means 2140 and a second force is required to move the boltless male terminal assembly 1430 when the extent (e.g., a contact arm 1494a-1494h) boltless male terminal assembly 1430 is positioned in the female terminal receiver 2473. Comparing the forces, it should be understood that the second force is less than the first force. This is beneficial because it provides the user with a tactical feedback to inform the user that the male terminal assembly 1430 is properly seated within the female terminal assembly 2430. In fact, this tactical feedback fells to the user like the boltless male terminal assembly 1430 is being pulled into the female terminal assembly 2430.

To minimize the chance that a foreign object accidentally makes contact with the female terminal assembly 2430, the housing 2100 may include an optional touch proof post 2200. As disclosed within PCT/US2019/036070, the touch proof post 2200 is configured to fit within a touch proof post opening 1510 that is formed within the front wall of the male terminal 1470. In particular, the distance between the outermost edges 2120a-2120d of the sidewalls 2112a-2112d and an outermost edge 2215 of the touch proof post 2200 is smaller than 10 mm and preferably less than 6 mm. The shape of the touch proof post opening 1510 is configured to substantially mirror the shape of the touch proof post 2200. Here, the touch proof probe opening 1510 has a substantially rectangular shape and, more specifically a substantially square shape, while the touch proof post 2200 is in the form of an elongated rectangular prism with two recesses formed in opposite sides of the prism. The mirror of these shapes helps ensure proper insertion of the touch proof post 2200 with the touch proof probe opening 1510 and may provide a reduction in the vibration between the male connector assembly 1430 and the female terminal assembly 2430. This reduction in the vibration between these components may help reduce failures of the connector system. It should be understood that the touch proof post 2200 and its associated opening 1510 may be omitted or may have another configuration (e.g., as disclosed in U.S. Provisional Application No. 63/222,859, which is incorporated herein by reference).

To minimize the change that the male connector assembly 1000 can be disconnected from the female connector assembly 2000, the female connector assembly 2000 may include an optional non-deformable female CPA structure 2300 that is designed and configured to interact with the male CPA structures 1170, when the connector assemblies 1000, 2000 are coupled to one another. Said non-deformable female CPA structure 2300 is integrally formed with a sidewall 2112a-2112d of the housing 2100. Additional details about the structure and/or function of the female CPA structure 2300 are disclosed in PCTUS2019/036070, PCTUS2020/049870, PCTUS2021/033446, all of which are incorporated herein by reference.

The female terminal assembly 2430 of the female connector assembly 2000 is comprised of female terminal body 2432, which has a plurality of sidewalls 2434a-2434d are integrally formed with a rear wall 2434e. Each of the sidewalls 2434a-2434d and rear wall 2434e have inner surfaces 2436a-2436e, whose combination forms cuboidal terminal receptacle 2472. Said cuboidal terminal receptacle 2472 has a receiver distance that extends between the inner surfaces 2436a-2436d of opposed sidewalls 2434a-2434d. As discussed above, the receiver distance is: (i) less than the sidewall distance and (ii) equal to or greater than the rearmost edge distance. Additionally, the receiver distance is between 0.1% and 15% smaller than a male terminal assembly distance that extends between the outermost extents of opposed contact arms 1494a-1494h. By forming a terminal receptacle 2472 that has a receiver distance that is less than the male terminal assembly distance ensures that the contact arms 1494a-1494h are compressed when the male terminal assembly 1430 is inserted into the female terminal assembly 2430. This compression of the male terminal assembly 1430 compresses the internal spring member 1440c. As such, the spring member 1440c exerts an outwardly directed biasing force on the contact arms 1494a-1494h to help ensure that they remain in contact with the inner surfaces 2436a-2436d of the terminal receptacle 2472 to facilitate the electrical and mechanical coupling of the male terminal assembly 1430 with the female terminal assembly 2430.

The female terminal assembly 2430 is typically formed from metal and preferably a highly conductive metal, such as copper. The female terminal assembly 2430 may be plated or clad with Ni—Ag to prevent the busbar 650 from corroding during and/or after the female terminal assembly 2430 is welded to the busbar 650. As shown in the Figures, the sidewalls 2434a-2434d are not be integrally formed with one another and instead are only integrally formed with the rear wall 2434e. In other embodiments, the female terminal assembly 2430 may have integrally formed sidewalls 2434a-2434d, the sidewalls 2434a-2434d may be made from a different material, and/or the female terminal assembly 2430 may not be plated or clad with Ni—Ag. Once the female terminal assembly 2430 is fabricated, it can be coupled to the negative busbar 650 and installed within the female housing 2100.

The negative busbar 650, shown in FIGS. 2-4, 5, 9, and 12-16, includes: (i) a battery cell interface 654, (ii) a female terminal interface 690, and (iii) an intermediate segment 710 that joins the battery cell interface 654 with the female terminal interface 690. The battery cell interface 654 is designed to: (i) be coupled to a pouch style battery cell 170 (see FIGS. 71-72), and (ii) be inserted within the busbar receiver 582 formed in the negative support structure 554 and retained within said receiver 582 by the busbar coupler 600. To couple the battery cell interface 654 to said battery cells 170, and more specifically the negative terminal 182 of the battery cells 170, a weldment process (e.g., ultrasonic, laser, resistive, pressure, flash, friction, diffusion, explosive, cold forming, or another type of welding method may be used) is utilized. Using said welding process, eliminates the need for threaded connectors and therefore reduces resistive losses, reduces failure modes, and is faster to assemble. However, in other embodiments, non-weldment (e.g., friction fit, bolted connectors, or other mechanical/chemical connection method) or a combination of non-weldment and weldment processes may be utilized. Additionally, to facilitate the coupling between battery cell interface 654 and the negative battery cell terminal 182 and allow for electrical current to transfer between the busbar 650 and the terminal 182, the battery cell interface 654 is entirely formed from a copper. In other words, the battery cell interface 654 is not bimetallic. While copper is utilized in this embodiment (as shown by the use of surface shading having less density or a shallower angle), it should be understood that other materials or combinations of materials may be used.

As discussed above, the busbar coupler 600 shown in the Figures includes at least one projection 602 that extends inward from an outer edge of mounting surface 584 and is designed to overlay an extent of the busbar 650, when the busbar 650 is inserted into the busbar receiver 582. To allow for projection 602 to overlay an extent of the busbar 650, the busbar 650 includes a support structure coupler 658 that is shown as coupling recesses 662, 664 that extend inward from the opposed ends 652a, 652b of the busbar 650. The configuration of the busbar receiver 582, busbar coupler 600, and support structure coupler 658 function together to: (i) fix the busbar 650 to the support structure 554, (ii) place the frontal surface 652 of the battery cell interface 654 substantially flush with the frontal surface 556 of the support structure 554, and (iii) position the busbar 650 to be coupled to the battery cell 170. It should be understood that alternative structures and/or methods of accomplishing the above points may be used in other embodiments. In particular, the busbar receiver 582, busbar coupler 600, and support structure coupler 658 may be replaced with any type of busbar retaining means. Said retaining means may take on any known shape of configuration that can reliably couple the busbar 650 to the support structure 554.

The female terminal interface 690: (i) has a width and a length that is sufficient (e.g., larger than) to receive the rear wall 2434e of the female terminal assembly 2430, (ii) is designed to fit around the touch proof post 2200, and (iii) allows for current transfer from the intermediate segment 710 to the female terminal assembly 2430. In the embodiment shown in the Figures, the female terminal interface 690 has a U-shaped configuration with an opening 694 formed therein that enables the female terminal interface 690 to be laterally inserted around the touch proof post 2200. Once the female terminal interface 690 has been inserted around the touch proof post 2200 and the battery cell interface 654 is properly seated in the busbar receiver 582, the female terminal body 2432 may be coupled thereto to form a coupled state. Said coupling may utilize a weldment process (e.g., ultrasonic, laser, resistive, pressure, flash, friction, diffusion, explosive, cold forming, or another type of welding method may be used). In other embodiments, the female terminal body 2432 may be coupled the female terminal interface 690 using a non-weldment (e.g., friction fit, bolted connectors, or other mechanical/chemical connection method) method, or a combination of a weldment and a non-weldment method. In this embodiment, the female terminal interface 690 is made of a single material (e.g., copper) and thus is not bimetallic. Additionally, the female terminal interface 690 may be made from the same material as the battery cell interface 654 and therefore the combination of these structures is not bimetallic. However, in other embodiments: (i) the U-shaped structure may be omitted because the female terminal interface 690 may not be designed to fit around the touch proof post 2200, (ii) the female terminal interface 690 may be made from a different material and thus these structures and busbar 650 may be bimetallic, and/or (iii) may be plated or clad with another material (e.g., tin).

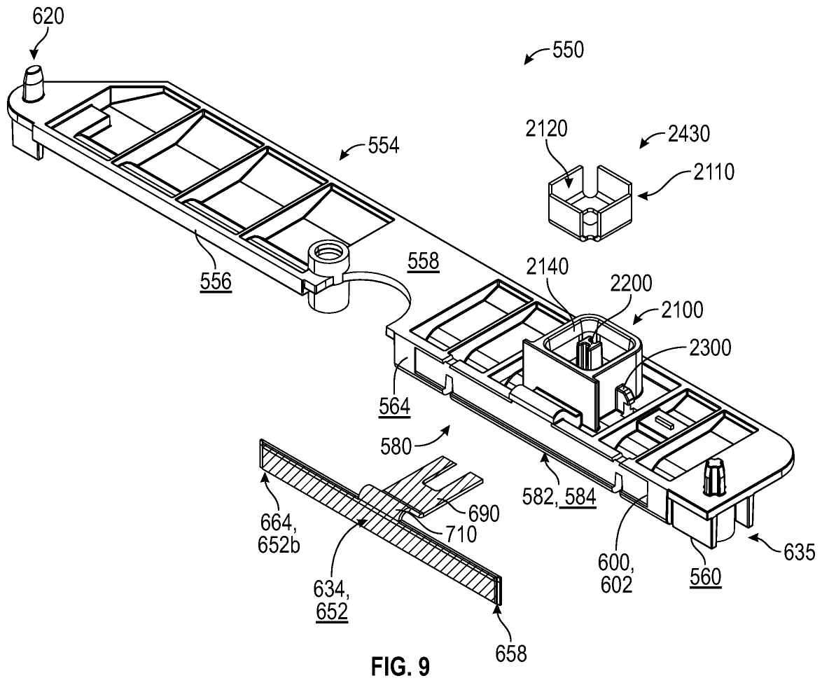

The intermediate segment 710 joins the battery cell interface 654 to female terminal interface 690. In this embodiment, intermediate segment 710 is made a single material (e.g., copper) and thus is not bimetallic. Additionally, the intermediate segment 710 may be made from the same material as one of: (i) the battery cell interface 654 or (ii) female terminal interface 690 and therefore the combination of these structures is not bimetallic. Finally, the intermediate segment 710 may be made from the same material as the battery cell interface 654 and female terminal interface 690 and therefore the combination of these structures is not bimetallic. In this final configuration, the all aspects of the busbar 650 are formed from the same material (e.g., copper) and thus the busbar 650 is not bimetallic. However, if a combination of materials are used in an alternative embodiment, these components may be joined using laser welding, resistive butt welding, pressure welding, flash butt welding, friction welding, diffusion welding, explosive welding, cold forming, or another type of welding or fusion method. The intermediate segment 710 is designed such that it places the battery cell interface 654 substantially perpendicular to female terminal interface 690. This configuration is desirable because it allows for the battery cells 170 to be horizontally stacked (see FIG. 71-72) within the battery module 100, while allowing the female terminal body 2432 to be accessible from the top of the battery module 100. Alternatively, if these structures were not substantially perpendicular and instead were parallel, then the female terminal body 2432 would be accessible from the side of the battery module 100. This configuration is not desirable in light of the current configuration of the battery pack 80; however, it may be desirable in other configurations of battery packs 80. Overall and as best seen in FIGS. 9 and 16-17, the female terminal body 2432 and the negative busbar 650 are not integrally formed for various reasons, including assembly, desirability of plating the terminal body 2432, and ease of manufacturing. While the figures show these components as not integrally formed with one another, it should be understood that they may be integrally formed in other embodiments.

b. Interior Interface Module

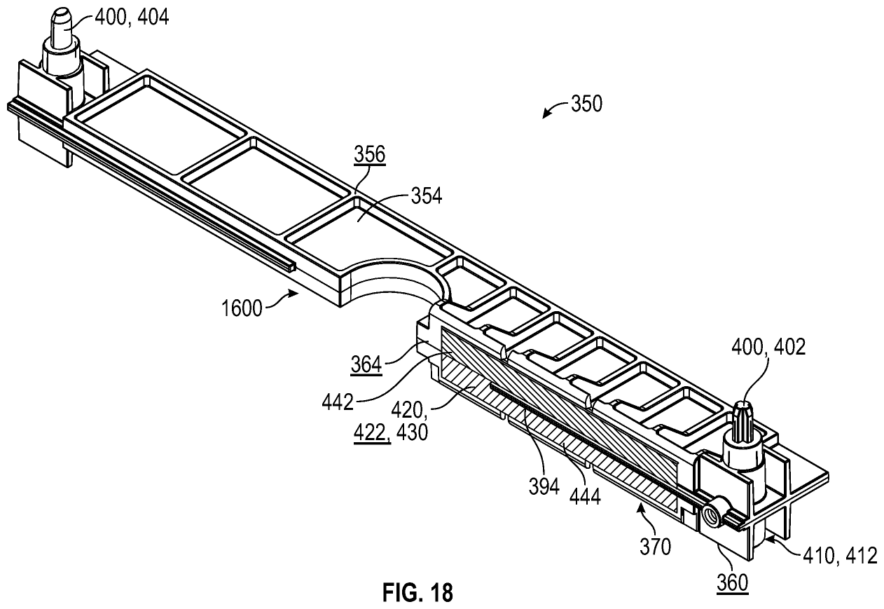

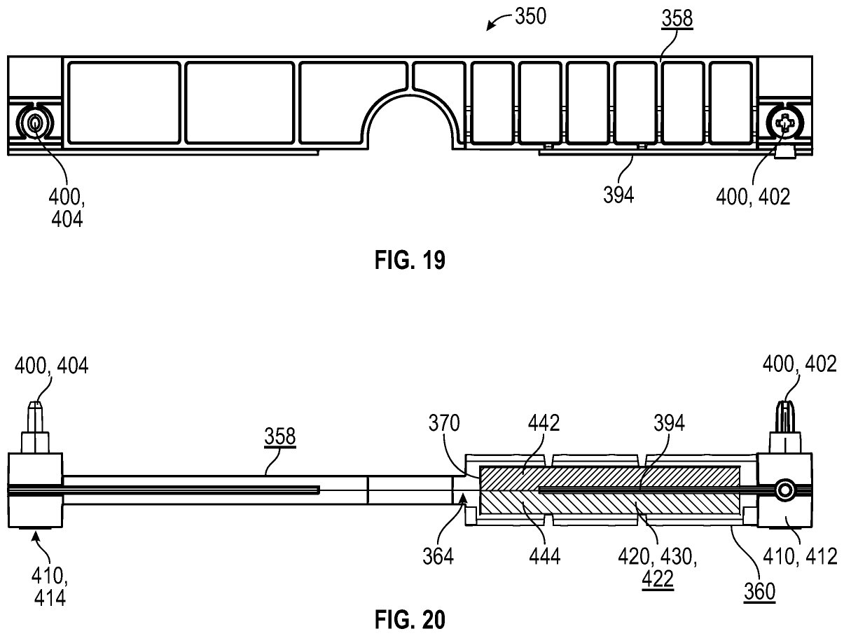

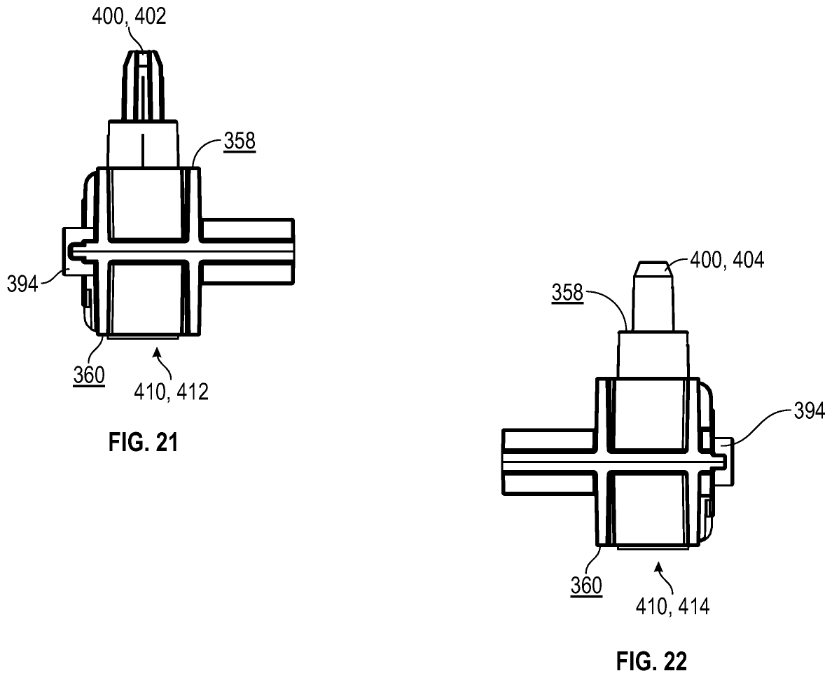

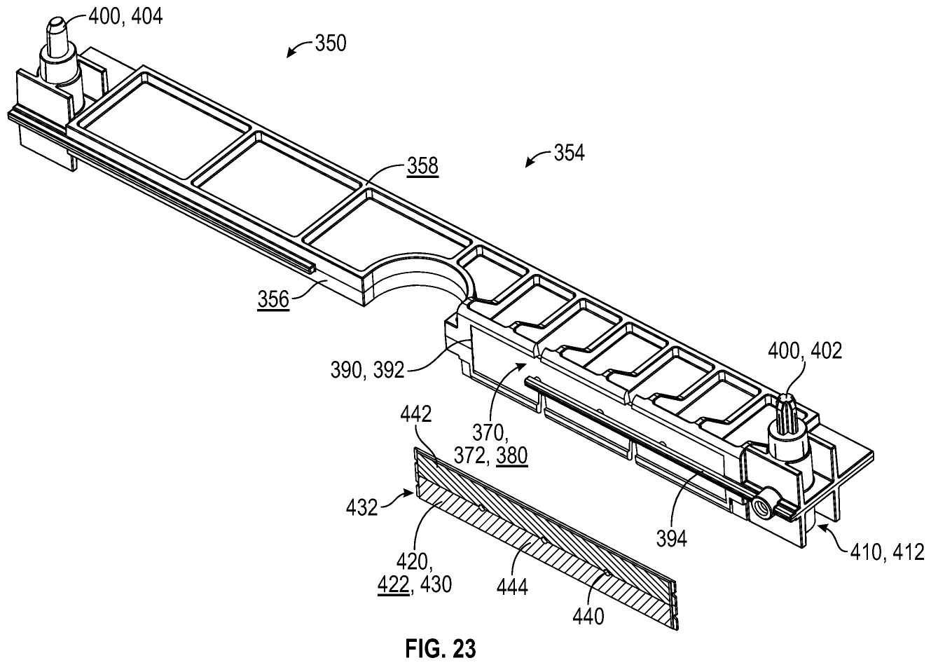

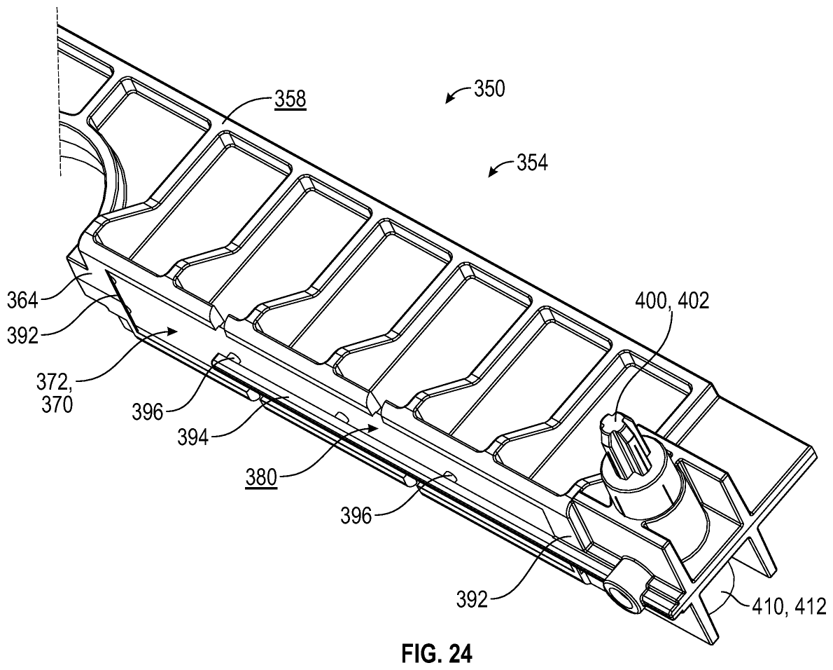

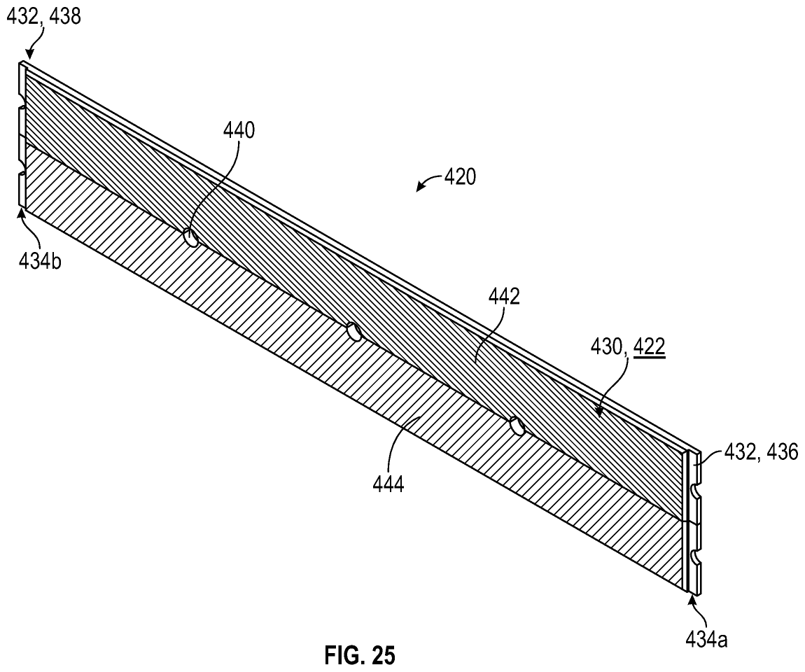

Referring to FIGS. 18-25, the interior interface module 350 includes: (i) an interior support structure 354, and (ii) an interior busbar, internal interior busbar, or fifth inner busbar 420. The interior support structure 354 has an elongated body and includes: (i) a busbar mount 370, (ii) a plurality of support projections 400, and (iii) a plurality of support receptacle 410. The interior support structure 354 is designed to: (i) allow for the alignment of the interior busbar 420 with the terminals 178, 182 of the battery cells 170 and (ii) provide enough space to position the interior busbar 420 inside of the exterior busbar 520. This configuration allows the transfer assembly 200 to be properly coupled to the battery cells 170. The busbar mount 370 extends downward from an upper surface 358 of the interior support structure 354 and is designed to receive and position the interior busbar 420 for coupling with the negative terminal 182 of the battery cell 170. The busbar mount 370 includes: (i) mounting surface 380 and (ii) busbar coupler 390. The mounting surface 380 is depressed or recessed from the frontal surface 356 of the interior support structure 354, wherein said depression or recess from a busbar receiver 372. Said busbar receiver 372 is designed to receive the interior busbar 420 and place the front surface 422 of said busbar 420 substantially flush with an extent 364 of the interior support structure 354 that is adjacent to the mounting surface 380. In other words, the busbar receiver 372 has a depth, width, and height that is approximately equal to the depth, width, and height of the busbar 420. It should be understood that other embodiments: (i) the frontal surface 422 of said busbar 420 may not be substantially flush with an extent 364 of the interior support structure 354, and (ii) the mounting surface 380 and thus the busbar receiver 372 may be omitted.

The busbar coupler 390 includes: (i) at least one projection 392 that extends inward from an outer edge of mounting surface 380 and is designed to overlay an extent of the busbar 420, when the busbar 420 is inserted into the busbar receiver 372, and (ii) a busbar retaining member 394 with projections 396 that are configured to extend through the busbar 420 and into the mounting surface 380. To position the busbar 420 within the receiver 372 and under the projection 392, an assembler or machine will apply a force that is sufficient in order to cause the projection 392 to elastically deform to receive the busbar 420. Once the busbar 420 is received by the receiver 372, the projection 392 will return to its original position and as such it will overlay and extent of the busbar 420. By overlaying an extent of the busbar 420, projection 392 ensures that the busbar 420 is retained within the receiver 372. After the busbar 420 is seated within the receiver 372, the assembler or machine will align the projections 396 with apertures 440 formed in the busbar 420 and apply a force sufficient to force the projections 396 into openings formed in the mounting surface 380. The projections 396 are retained within said openings due to a friction or pressure fit design. It should be understood that other methods of coupling the busbar 420 to the interior support structure 354 may be used. For example, the busbar 420 may be inserted into a mold, and the polymer that is used to form the support structure 354 may be injected around the busbar 420. In further embodiments, the coupler 390 may include additional structures (e.g., other projections), or different structures (e.g., some of which are disclosed below) that are designed to retain the busbar 420 within the receiver 372.

The plurality of support projections 400 and a plurality of support receptacle 410 facilitate the boltless assembly of the transfer assembly 200. The plurality of support projections 400 includes: (i) a first support projection 402 located near a first end of the support structure 354, and (ii) a second support projection 404 located near a second opposed end of the support structure 354. The first and second support projections 402, 404 extend upwards from an upper surface 358 of the support structure 354 are configured to interact with: (i) plurality of support receptacles 410 of the adjacent interior support structure 354, (ii) plurality of support receivers 770 of the jumper support structure 702, or (iii) plurality of support projections 310 of the positive support structure 254. This opposed positional relationship of the support projections 402, 404 helps ensure that the entire support structure 354 is secured within and to the housing 110, while minimizing the number of projections 402, 404 and/or structures. This is desirable because: (i) it reduces the weight of the transfer assembly 200, thereby reducing the weight of the battery module 100, and (ii) does not require bolts or other connectors, thereby reducing failure modes and assembly times. Nevertheless, other configurations of the support projections 402, 404 are contemplated by this disclosure. For example, the support projections 402, 404 may be replaced with a support wall that extends around a portion or the entire periphery of the support structure 354. In another example, the support projections 402, 404 may extend from the sides of the support structure 354 instead of the upper surface 358 of the support structure 354. In a further embodiment, additional support projections 402, 404 may be added to extend from the rear and sides of the support structure 354, such that the transfer assembly 200 is secured within and to the battery module housing 110 in multiple different directions (e.g., top, side, and rear).

Like the plurality of support projections 400, the support structure 354 includes: (i) a first support receptacle 412 located near the first end of the support structure 354, and (ii) a second support receptacle 414 located near a second opposed end of the support structure 354. The first and second support receptacles 412, 414 extend downward from a lower surface 360. Said support receptacle 412, 414 are configured to interact with: (i) plurality of support projections 400 of the adjacent interior support structure 354, (ii) plurality of support projections 760 of the jumper support structure 702, or (iii) plurality of support projections 310 of the positive support structure 254. This opposed positional relationship of the support receptacle 412, 414 helps ensure that the entire support structure 354 is secured other structures 350, 450 within the battery module's housing 110, while minimizing the number of receptacle 412, 414 and/or structures. This is desirable because it reduces the weight of the transfer assembly 200 and in turn the weight of the battery module 100. Nevertheless, other configurations of the support receptacle 412, 414 are contemplated by this disclosure.

The interior busbar 420, shown in FIGS. 18, 20, 23, 25, includes a battery cell interface 430. The battery cell interface 430 is designed to: (i) be coupled to multiple pouch style battery cell 170 (see FIGS. 71-72), and (ii) be inserted within the busbar receiver 372 that is formed in the interior support structure 354 and retained within said receiver 372 by the busbar coupler 390. To couple the battery cell interface 430 to said battery cells 170, a weldment process (e.g., ultrasonic, laser, resistive, pressure, flash, friction, diffusion, explosive, cold forming, or another type of welding method may be used) is utilized. Using said welding process, eliminates the need for threaded connectors and therefore reduces resistive losses, reduces failure modes, and is faster to assemble. However, in other embodiments, non-weldment (e.g., friction fit, bolted connectors, or other mechanical/chemical connection method) or a combination of non-weldment and weldment processes may be utilized.

The interior busbar 420 is formed from two different materials to: (i) facilitate the coupling between: (a) the battery cell interface 430, (b) the positive battery cell terminal 178, and (c) the negative battery cell terminal 182, and (ii) allow for electrical current to transfer between said structures. In particular, a first portion 442 of the interior busbar 420 is formed from a first material (e.g., aluminum) and a second portion 444 of the interior busbar 420 is formed from a second material (e.g., copper). As such, the interior busbar 420 is bimetallic. Said bimetallic configuration is beneficial due to the structure and chemical makeup of the battery cells 170. To form this bimetallic busbar 420, the first and second portions 442, 444 are coupled to one another using any known process, including laser welding, resistive butt welding, pressure welding, flash butt welding, friction welding, diffusion welding, explosive welding, or cold forming. Additionally, the first and second portions 442, 444 may have structures that interlock (e.g., dove tale) or overlap to help ensure that the portions 442, 444 remain joined as a single busbar.

Forming the busbar 420 from two different materials allows the first portion 442 to be coupled to the negative terminal 182 of a first battery cell 170, while allowing the second portion 444 to be coupled to the positive terminal 178 of a second battery cell 170. The coupling of these two battery terminals 178, 182 to the busbar 420 connects the battery cells 170 in series and thus includes the voltage of the combination of battery cells 170 is increased. The designer will continue coupling battery cells 170 in series until the desired voltage for the battery module 100 is reached. This may require coupling only two battery cells 170 to one another for low voltage applications or coupling over 25 battery cells 170 together for a high voltage application. While aluminum (as shown by the use of surface shading having greater density or a steeper angle) and copper (as shown by the use of surface shading having less density or a shallower angle) are utilized in this embodiment, it should be understood that other materials or combinations of materials may be used. For example, the busbar 430 may be made of a single material if the battery cells 170 are altered to make such a configuration possible.

As discussed above, the busbar coupler 390 shown in the Figures includes at least one projection 392 that extends inward from an outer edge of mounting surface 380 and is designed to overlay an extent of the busbar 420, when the busbar 420 is inserted into the busbar receiver 372. To allow for projection 392 to overlay an extent of the busbar 420, the busbar 420 includes a support structure coupler 432 that is shown as coupling recesses 436, 438 that extend inward from the opposed ends 434a, 434b of the busbar 420. Additionally, the support structure coupler 432 includes apertures 440 are formed within the busbar 420 to receive projections 396 of a retaining member 394, wherein said projections 396 are configured to extend through the apertures 440 and are received by mounting surface 380 of the busbar mount 370. The configuration of the busbar receiver 372, busbar coupler 390, busbar retaining member 394, support structure coupler 432, and busbar apertures 440 functions together to: (i) fix the busbar 420 to the support structure 354, (ii) place the frontal surface 422 of the battery cell interface 430 substantially flush with the frontal surface 356 of the support structure 354, and (iii) position the busbar 420 to be coupled to the battery cell 170. It should be understood that alternative structures and/or method of accomplishing the above points may be used in other embodiments. In particular, the busbar receiver 372, busbar coupler 390, busbar retaining member 394, support structure coupler 432, and busbar apertures 440 may be replaced with any type of busbar retaining means. Said retaining means may take on any known shape of configuration that can reliably couple the busbar 420 to the support structure 354.

c. Exterior Interface Module

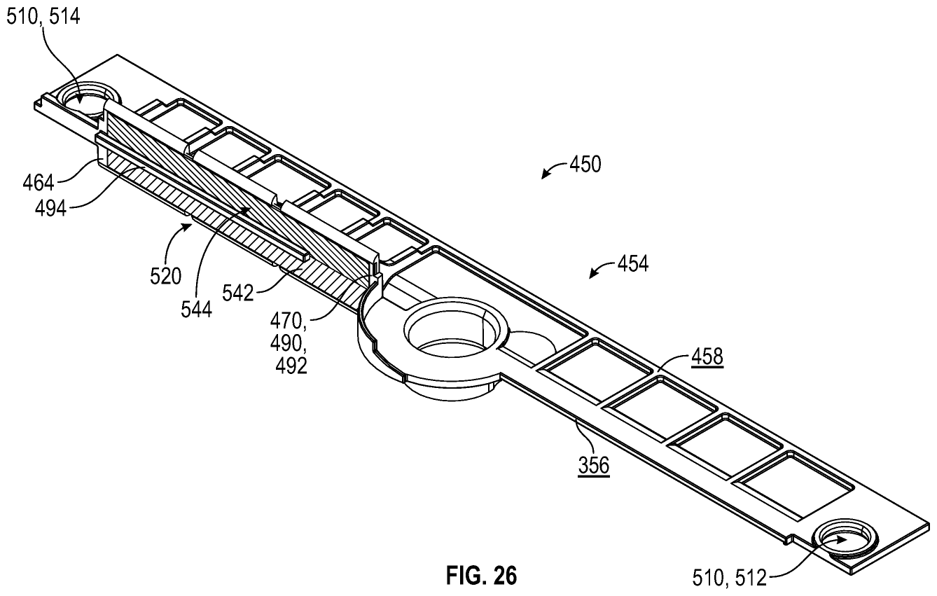

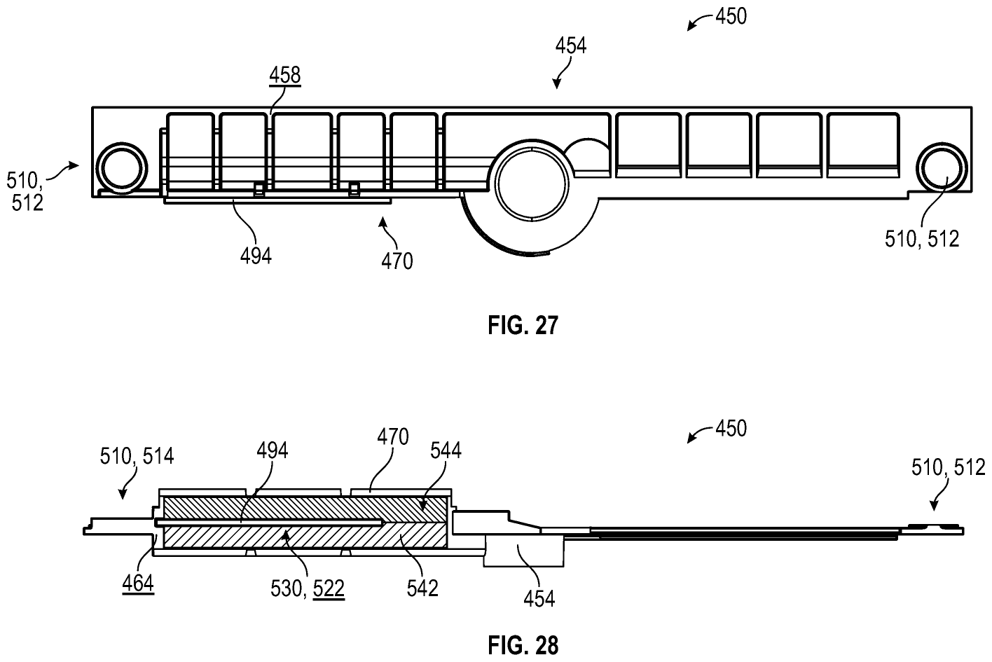

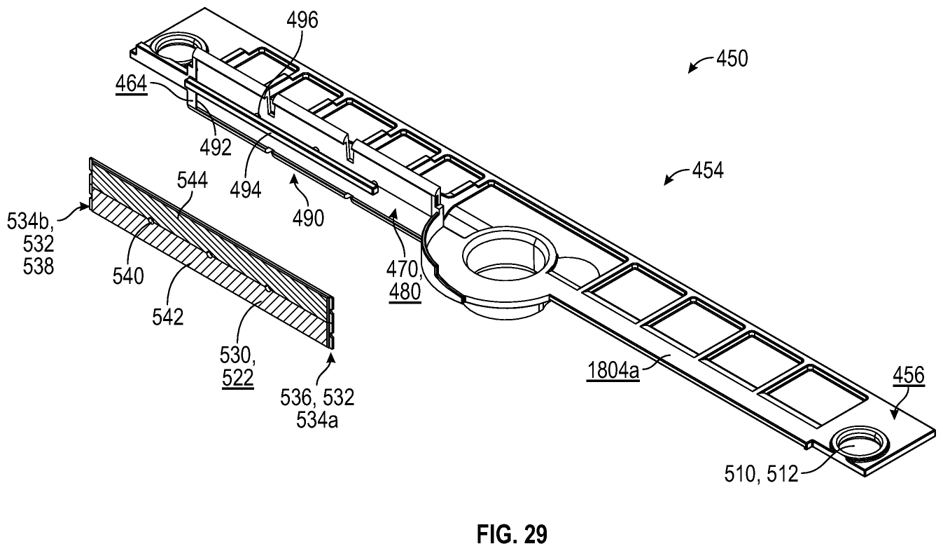

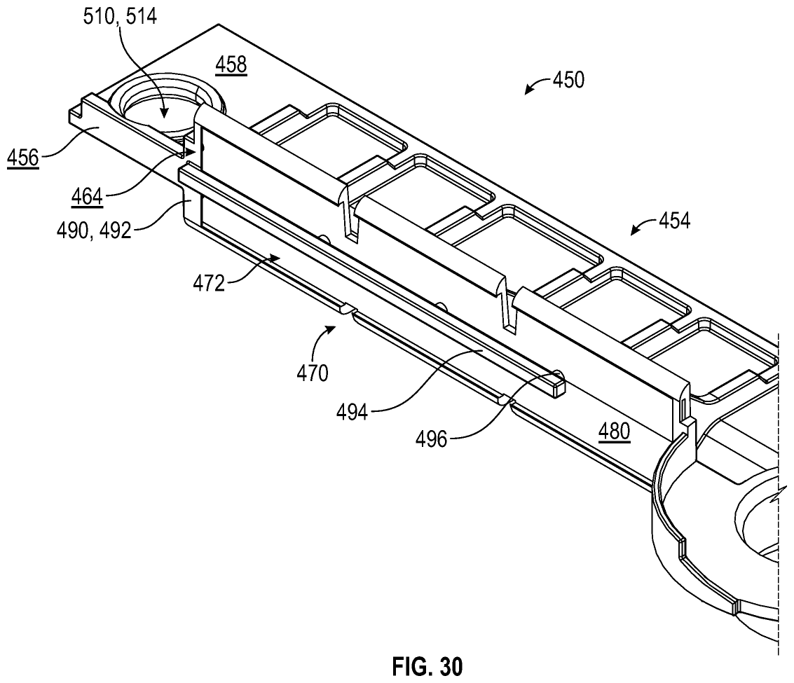

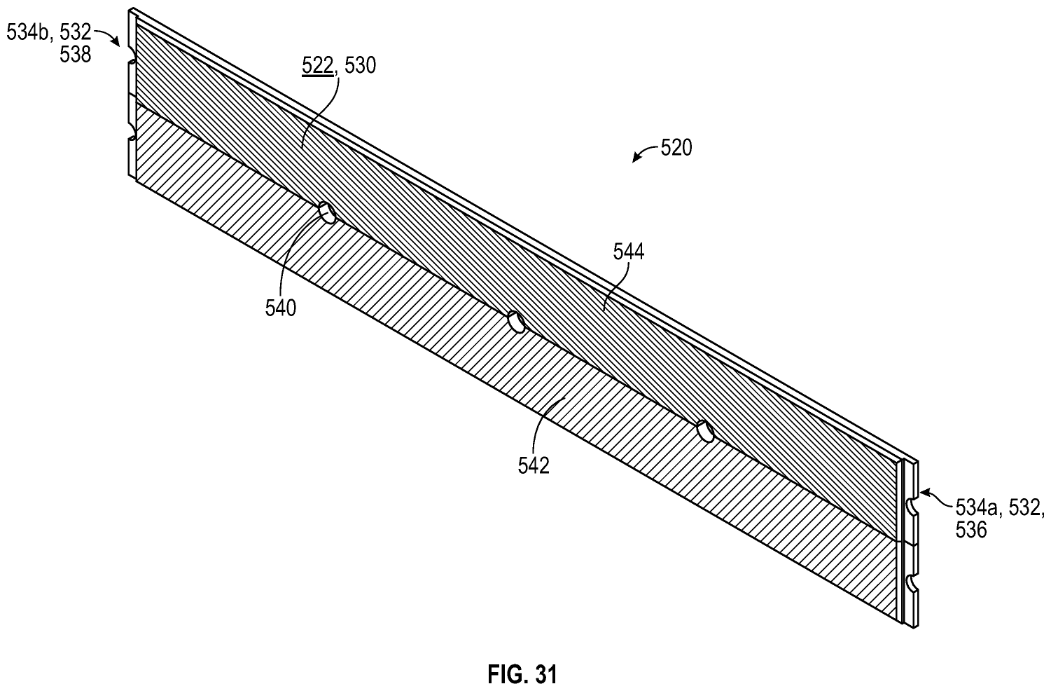

Referring to FIGS. 26-31, the exterior interface module 450 includes: (i) an exterior support structure 454, and (ii) an exterior busbar, internal exterior busbar, fourth inner busbar 520. The exterior support structure 454 has an elongated body and includes: (i) a busbar mount 470, (ii) a plurality of support apertures 510. The exterior support structure 454 is designed to: (i) allow for the alignment of the exterior busbar 520 with the terminals 178, 182 of the battery cells 170 and (ii) provide enough space to position the exterior busbar 520 outside of the interior busbar 420. This configuration allows the transfer assembly 200 to be properly coupled to the battery cells 170. The busbar mount 470 extends downward from an upper surface 458 of the exterior support structure 454 and is designed to receive and position the exterior busbar 520 for coupling with the negative terminal 182 of the battery cell 170. The busbar mount 470 includes: (i) mounting surface 480 and (ii) busbar coupler 490. The mounting surface 480 is depressed or recessed from the frontal surface 456 of the exterior support structure 454, wherein said depression or recess from a busbar receiver 472. Said busbar receiver 472 is designed to receive the exterior busbar 520 and place the front surface 522 of said busbar 520 substantially flush with an extent 464 of the exterior support structure 454 that is adjacent to the mounting surface 480. In other words, the busbar receiver 472 has a depth, width, and height that is approximately equal to the depth, width, and height of the busbar 520. It should be understood that other embodiments: (i) the frontal surface 522 of said busbar 520 may not be substantially flush with an extent 464 of the exterior support structure 454, and (ii) the mounting surface 480 and thus the busbar receiver 472 may be omitted.

The busbar coupler 490 includes: (i) at least one projection 492 that extends inward from an outer edge of mounting surface 480 and is designed to overlay an extent of the busbar 520, when the busbar 520 is inserted into the busbar receiver 472, and (ii) a busbar retaining member 494 with projections 496 that are configured to extend through the busbar 520 and into the mounting surface 480. To position the busbar 520 within the receiver 472 and under the projection 492, an assembler or machine will apply a force that is sufficient in order to cause the projection 492 to elastically deform to receive the busbar 520. Once the busbar 520 is received by the receiver 472, the projection 492 will return to its original position and as such it will overlay and extent of the busbar 520. By overlaying an extent of the busbar 520, projection 492 ensures that the busbar 520 is retained within the receiver 472. After the busbar 520 is seated within the receiver 472, the assembler or machine will align the projections 496 with apertures 540 formed in the busbar 520 and apply a force sufficient to force the projections 496 into openings formed in the mounting surface 480. The projections 496 are retained within said openings due to a friction or pressure fit design. It should be understood that other methods of coupling the busbar 520 to the exterior support structure 454 may be used. For example, the busbar 520 may be inserted into a mold and the polymer that is used to form the support structure 454 may be injected around the busbar 520. In further embodiments, the coupler 490 may include additional structures (e.g., other projections), or different structures (e.g., some of which are disclosed below) that are designed to retain the busbar 520 within the receiver 472.

The plurality of support apertures 510 facilitates the boltless assembly of the transfer assembly 200. In particular, the support structure 454 includes: (i) a first support aperture 512 located near the first end of the support structure 454, and (ii) a second support aperture 514 located near a second opposed end of the support structure 454. This opposed positional relationship of the support aperture 512, 514 helps ensure that the entire support structure 454 within the battery module's housing 110, while minimizing the number of apertures 512, 514 and/or structures. This is desirable because it reduces the weight of the transfer assembly 200 and in turn the weight of the battery module 100. The first and second support apertures 512, 514 are configured to receive the plurality of support projections 400 of the interior interface module 350. As discussed above, the support projections 400, and specifically the first and second support projections 402, 404, associated with a first interior interface module 350 interact with the plurality of support receptacles 410, and specifically the first and second support receptacle 412, 414, associated with a second interior interface module 350. The plurality of support apertures 510, and specifically the first and second apertures 512, 514, are designed to surround an extent of the combination of the projections 402, 404 and receptacle 412, 414. In other words, the exterior interface module 450 is not fixed into a single position within the transfer assembly 200. Instead, the exterior interface module 450 can moved up or down and side to side, as needed to facilitate the mounting of the battery cells 170. Due to the interaction between the support apertures 510, support projections 400, and support receptacles 410, support apertures 510 must be positioned such that the support projections 400 and support receptacles 410 and be inserted within the support apertures 510. It should be understood that other method and/or structures may be used to couple the exterior interface module 450 within the transfer assembly 200.

The exterior busbar 520, shown in FIGS. 26, 28, 29, and 31, includes a battery cell interface 530. The battery cell interface 530 is designed to: (i) be coupled to multiple pouch style battery cell 170 (see FIGS. 71-72), and (ii) be inserted within the busbar receiver 472 that is formed in the exterior support structure 454 and retained within said receiver 472 by the busbar coupler 490. To couple the battery cell interface 530 to said battery cells 170, a weldment process (e.g., ultrasonic, laser, resistive, pressure, flash, friction, diffusion, explosive, cold forming, or another type of welding method may be used) is utilized. Using said welding process, eliminates the need for threaded connectors and therefore reduces resistive losses, reduces failure modes, and is faster to assemble. However, in other embodiments, non-weldment (e.g., friction fit, bolted connectors, or other mechanical/chemical connection method) or a combination of non-weldment and weldment processes may be utilized.

The exterior busbar 520 is formed from two different materials to: (i) facilitate the coupling between: (a) the battery cell interface 530, (b) the positive battery cell terminal 178, and (c) the negative battery cell terminal 182, and (ii) allow for electrical current to transfer between said structures. In particular, a first portion 542 of the exterior busbar 520 is formed from a first material (e.g., copper) and a second portion 544 of the exterior busbar 520 is formed from a second material (e.g., aluminum). As such, the exterior busbar 520 is bimetallic. Said bimetallic configuration is beneficial due to the structure and chemical makeup of the battery cells 170. To form this bimetallic busbar 520, the first and second portions 542, 544 are coupled to one another using any known process, including laser welding, resistive butt welding, pressure welding, flash butt welding, friction welding, diffusion welding, explosive welding, or cold forming. Additionally, the first and second portions 542, 544 may have structures that interlock (e.g., dove tale) or overlap to help ensure that the portions 542, 544 remain joined as a single busbar.

Forming the busbar 520 from two different materials allows the first portion 542 to be coupled to the negative terminal 182 of a first battery cell 170, while allowing the second portion 544 to be coupled to the positive terminal 178 of a second battery cell 170. The coupling of these two battery terminals 178, 182 to a single busbar 520 connects the battery cells 170 in series and thus includes the voltage of the combination of battery cells 170 is increased. The designer will continue coupling battery cells 170 in series until the desired voltage for the battery module 100 is reached. This may require coupling only two battery cells 170 to one another for low voltage applications or coupling over 25 battery cells 170 together for a high voltage application. While aluminum (as shown by the use of surface shading having greater density or a steeper angle) and copper (as shown by the use of surface shading having less density or a shallower angle) are utilized in this embodiment, it should be understood that other materials or combinations of materials may be used. For example, the busbar 530 may be made of a single material if the battery cells 170 are altered to make such a configuration possible.

As discussed above, the busbar coupler 490 shown in the Figures includes at least one projection 492 that extends inward from an outer edge of mounting surface 480 and is designed to overlay an extent of the busbar 520, when the busbar 520 is inserted into the busbar receiver 472. To allow for projection 492 to overlay an extent of the busbar 520, the busbar 520 includes a support structure coupler 532 that is shown as coupling recesses 536, 538 that extend inward from the opposed ends 534a, 534b of the busbar 520. Additionally, the support structure coupler 532 includes apertures 540 are formed within the busbar 520 to receive projections 496 of a retaining member 494, wherein said projections 496 are configured to extend through the apertures 540 and are received by mounting surface 480 of the busbar mount 470. The configuration of the busbar receiver 472, busbar coupler 490, busbar retaining member 494, support structure coupler 532, and busbar apertures 540 function together to: (i) fix the busbar 520 to the support structure 454, (ii) place the frontal surface 522 of the battery cell interface 530 substantially flush with the frontal surface 456 of the support structure 454, and (iii) position the busbar 520 to be coupled to the battery cell 170. It should be understood that alternative structures and/or method of accomplishing the above points may be used in other embodiments. In particular, the busbar receiver 472, busbar coupler 490, busbar retaining member 494, support structure coupler 532, and busbar apertures 540 may be replaced with any type of busbar retaining means. Said retaining means may take on any known shape of configuration that can reliably couple the busbar 520 to the support structure 454.

d. Jumper Interface Module

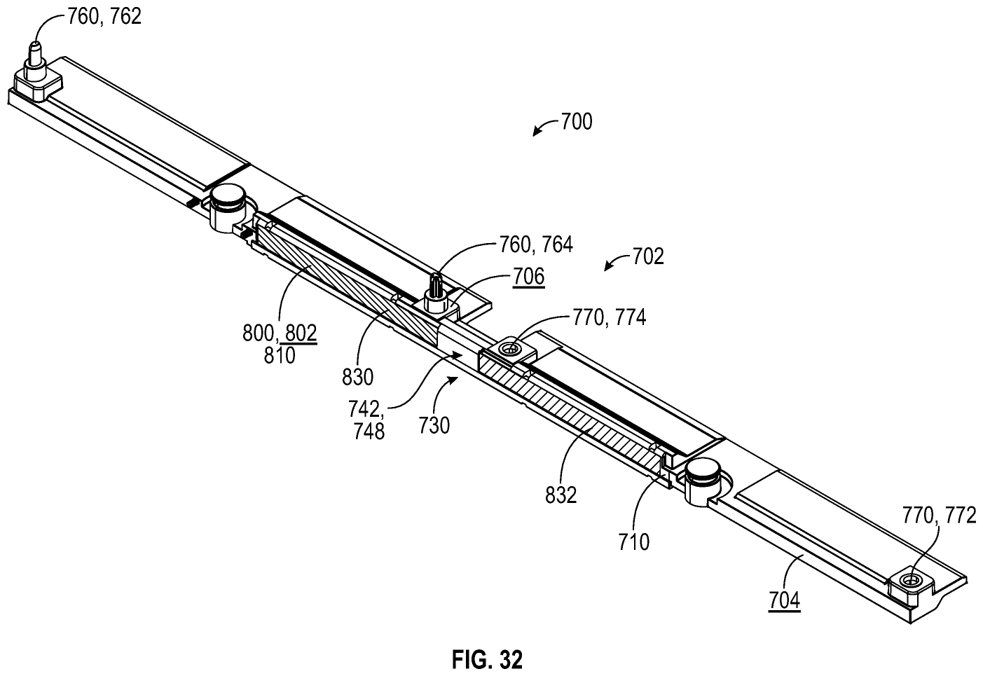

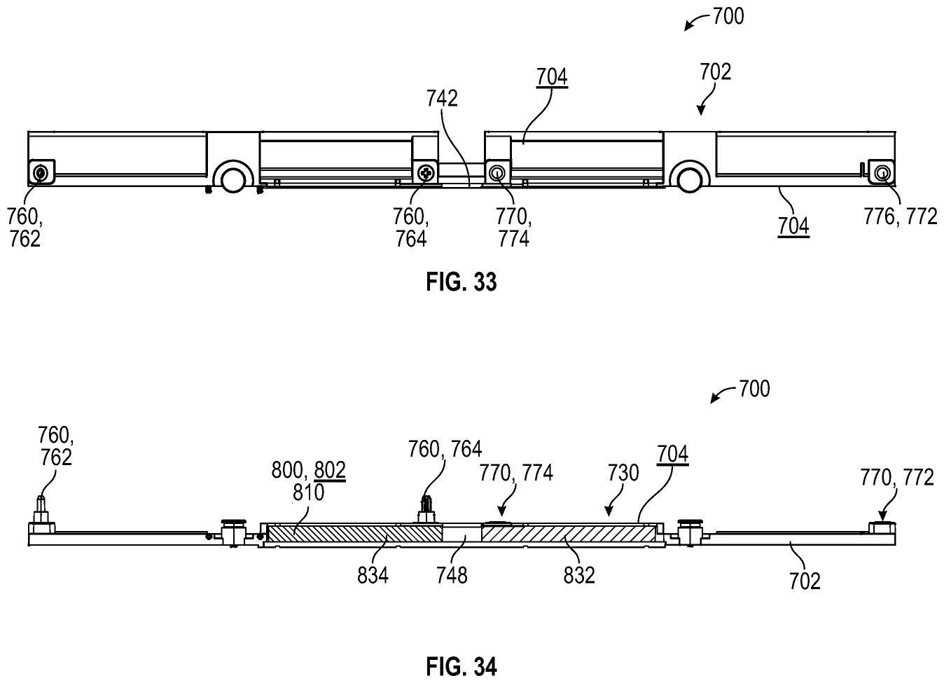

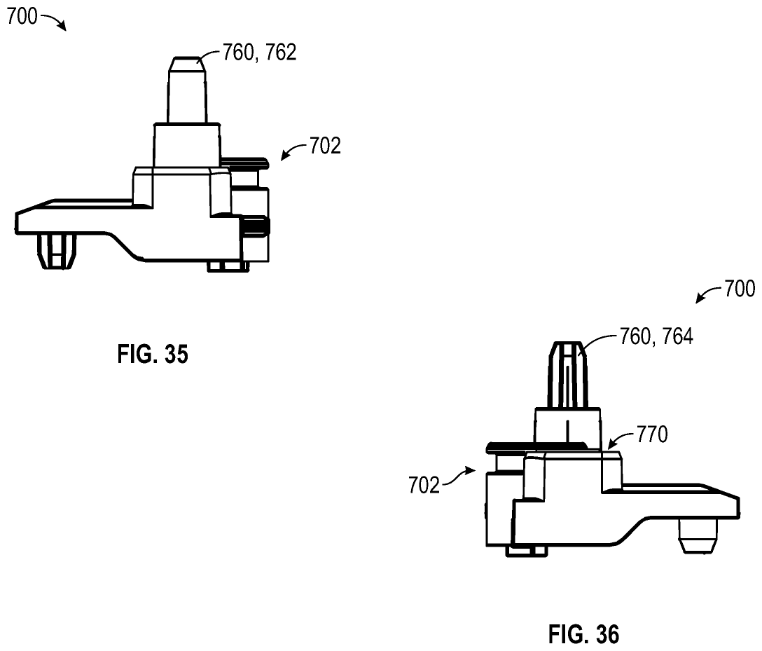

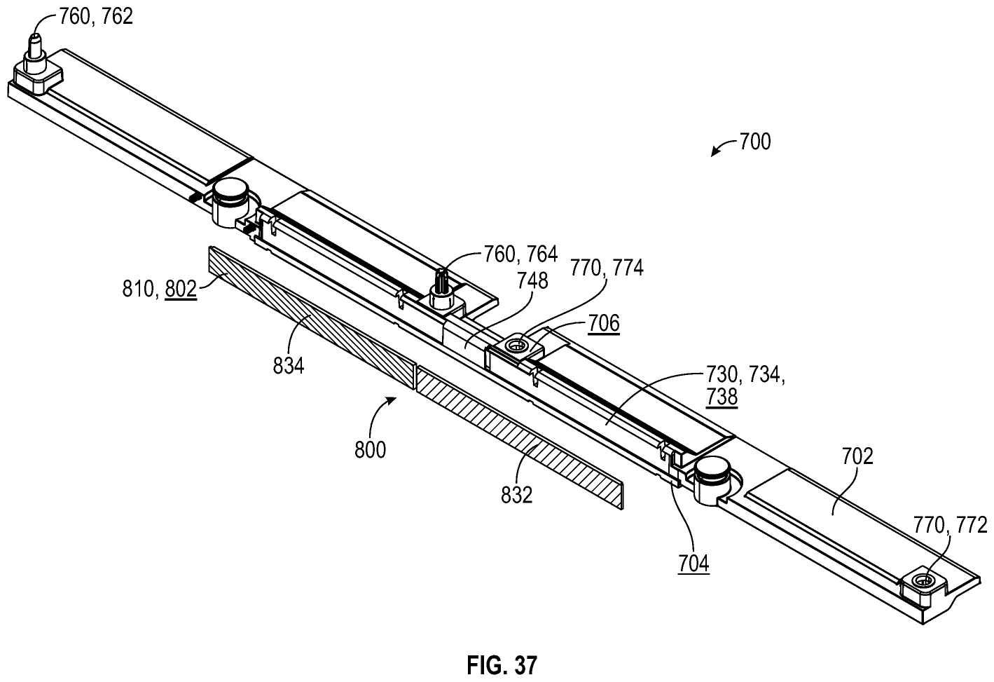

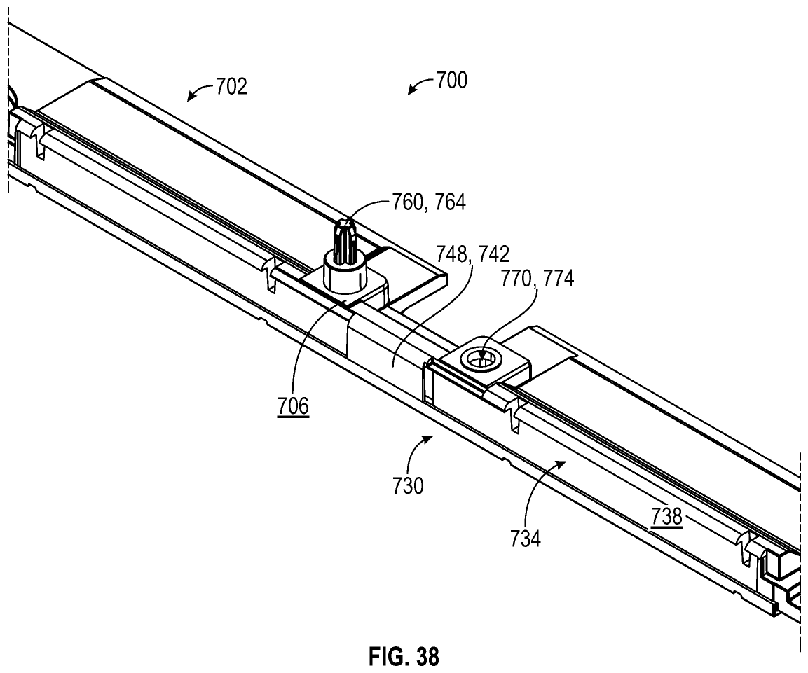

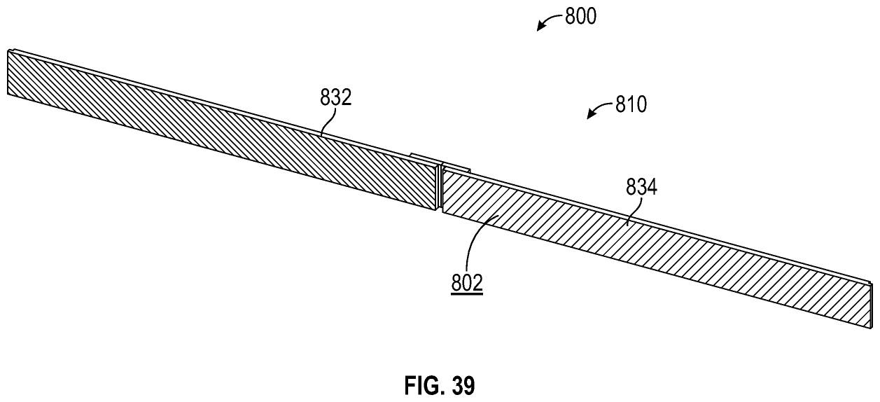

Referring to FIGS. 32-39, the jumper interface module 700 includes: (i) an jumper support structure 702, and (ii) an jumper busbar, internal jumper busbar, third inner busbar, or third busbar 800. The jumper support structure 702 has an elongated body and includes: (i) a busbar mount 730, (ii) a plurality of support projections 760, and (iii) a plurality of support receptacle 770. The jumper support structure 702 is designed to: (i) allow for the alignment of the jumper busbar 800 with the terminals 178, 182 of the battery cells 170 and (ii) provide support for the positive cell stack 204 and negative cell stack 208. The busbar mount 730 extends downward from an upper surface 706 of the jumper support structure 702 and is designed to receive and position the jumper busbar 800 for coupling with the: (i) negative terminal 182 of the battery cell 170, and (ii) positive terminal 178 of the battery cell 170. The busbar mount 730 includes: (i) mounting surface 738 and (ii) busbar coupler 742. The mounting surface 738 is depressed or recessed from the frontal surface 704 of the jumper support structure 702, wherein said depression or recess from a busbar receiver 734. Said busbar receiver 734 is designed to receive the jumper busbar 800 and place the front surface 802 of said busbar 800 substantially flush with an extent 710 of the jumper support structure 702 that is adjacent to the mounting surface 738. In other words, the busbar receiver 734 has a depth, width, and height that is approximately equal to the depth, width, and height of the busbar 800. It should be understood that other embodiments: (i) the frontal surface 802 of said busbar 800 may not be substantially flush with an extent 710 of the jumper support structure 702, and (ii) the mounting surface 738 and thus the busbar receiver 734 may be omitted.

The busbar coupler 742 includes a busbar retaining member 748 that is configured to overlie an extend of the busbar 800 and specifically a central extent of the busbar 800. To position the busbar 800 within the receiver 734 and under the projection 744, an assembler or machine will: (i) apply a force that is sufficient in order to position the busbar 800 within the receiver 734, and (ii) couple the retaining member 748 to a frontal extent of the support structure 702, wherein the retaining member 748 overlies an extent of the busbar 800. By overlaying an extent of the busbar 800, the retaining member 748 ensures that the busbar 800 is retained within the receiver 734. It should be understood that other methods of coupling the busbar 800 to the jumper support structure 702 may be used. For example, the busbar 800 may be inserted into a mold and the polymer that is used to form the support structure 702 may be injected around the busbar 800. In further embodiments, the coupler 742 may include additional structures (e.g., other projections), or different structures (e.g., some of which are disclosed below) that are designed to retain the busbar 800 within the receiver 734.

The plurality of support projections 760 and a plurality of support receptacle 770 facilitate the boltless assembly of the transfer assembly 200. The plurality of support projections 760 include: (i) a first support projection 762 located near a first end of the support structure 702, and (ii) a second support projection 764 located near the middle of the support structure 702. The first and second support projections 762, 764 extend upwards from an upper surface 706 of the support structure 702 are configured to interact with: (i) plurality of support receptacles 410 of the adjacent interior interface module 350. This positional relationship of the support projections 762, 764 helps ensure that negative cell stack 208 is supported, while minimizing the number of projections 762, 764 and/or structures. This is desirable because: (i) it reduces the weight of the transfer assembly 200, thereby reducing the weight of the battery module 100, and (ii) does not require bolts or other connectors, thereby reducing failure modes and assembly times. Nevertheless, other configurations of the support projections 762, 764 are contemplated by this disclosure. For example, the support projections 762, 764 may be replaced with a support wall that extends around a portion or the entire periphery of the support structure 702. In another example, the support projections 762, 764 may extend from the sides of the support structure 702 instead of the upper surface 706 of the support structure 702. In a further embodiment, additional support projections 762, 764 may be added to extend from the rear and sides of the support structure 702, such that the transfer assembly 200 is secured within and to the battery module housing 110 in multiple different directions (e.g., top, side, and rear).

Like the plurality of support projections 760, the support structure 702 includes: (i) a first support receptacle 772 located near the second end of the support structure 702, and (ii) a second support receptacle 774 located near the middle of the support structure 702. The first and second support receptacles 772, 774 extend downward from an upper surface 706. Said support receptacles 772, 774 are configured to interact with the plurality of support projections 410 of the interior interface module 350. This positional relationship of the support receptacle 772, 774 helps ensure that the entire support structure 702 is secured other structures 350, 450 within the battery module's housing 110, while minimizing the number of receptacle 772, 774 and/or structures. This is desirable because it reduces the weight of the transfer assembly 200 and in turn the weight of the battery module 100. Nevertheless, other configurations of the support receptacle 772, 774 are contemplated by this disclosure.

The jumper busbar 800, shown in FIGS. 32, 34, 37, 39, includes a battery cell interface 810. The battery cell interface 810 is designed to: (i) be coupled to multiple pouch style battery cell 170 (see FIGS. 71-72), and (ii) be inserted within the busbar receiver 734 that is formed in the jumper support structure 702 and retained within said receiver 734 by the busbar coupler 742. To couple the battery cell interface 810 to said battery cells 170, a weldment process (e.g., ultrasonic, laser, resistive, pressure, flash, friction, diffusion, explosive, cold forming, or another type of welding method may be used) is utilized. Using said welding process, eliminates the need for threaded connectors and therefore reduces resistive losses, reduces failure modes, and is faster to assemble. However, in other embodiments, non-weldment (e.g., friction fit, bolted connectors, or other mechanical/chemical connection method) or a combination of non-weldment and weldment processes may be utilized.

The jumper busbar 800 is formed from two different materials to: (i) facilitate the coupling between: (a) the battery cell interface 810, (b) the positive battery cell terminal 178, and (c) the negative battery cell terminal 182, and (ii) allow for electrical current to transfer between said structures. In particular, a first portion 830 of the jumper busbar 800 is formed from a first material (e.g., aluminum) and a second portion 832 of the jumper busbar 800 is formed from a second material (e.g., copper). As such, the jumper busbar 800 is bimetallic. Said bimetallic configuration is beneficial due to the structure and chemical makeup of the battery cells 170. To form this bimetallic busbar 800, the first and second portions 830, 832 are coupled to one another using any known process, including laser welding, resistive butt welding, pressure welding, flash butt welding, friction welding, diffusion welding, explosive welding, or cold forming. Additionally, the first and second portions 830, 832 may have structures that interlock (e.g., dove tale) or overlap to help ensure that the portions 830, 832 remain joined as a single busbar.

Forming the busbar 800 from two different materials allows the first portion 830 to be coupled to the negative terminal 182 of a first battery cell 170, while allowing the second portion 830 to be coupled to the positive terminal 178 of a second battery cell 170. The coupling of these two battery terminals 178, 182 to a single busbar 800 connects the positive cell stack 204 in series with the negative cell stack 208. While aluminum (as shown by the use of surface shading having greater density or a steeper angle) and copper (as shown by the use of surface shading having less density or a shallower angle) are utilized in this embodiment, it should be understood that other materials or combinations of materials may be used. For example, the busbar 810 may be made of a single material if the battery cells 170 are altered to make such a configuration possible.

e. Positive Connector Module

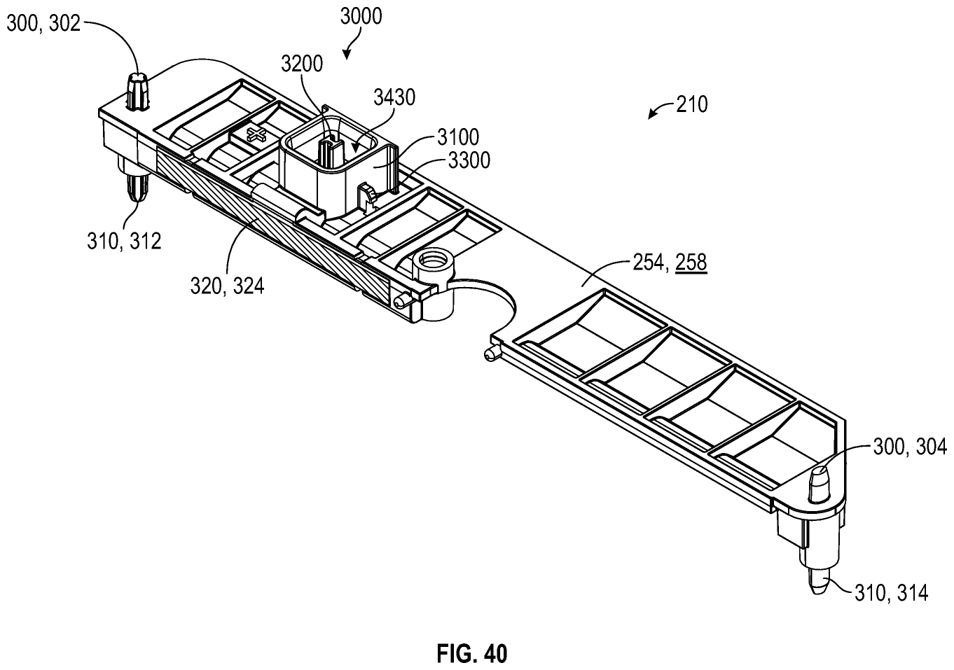

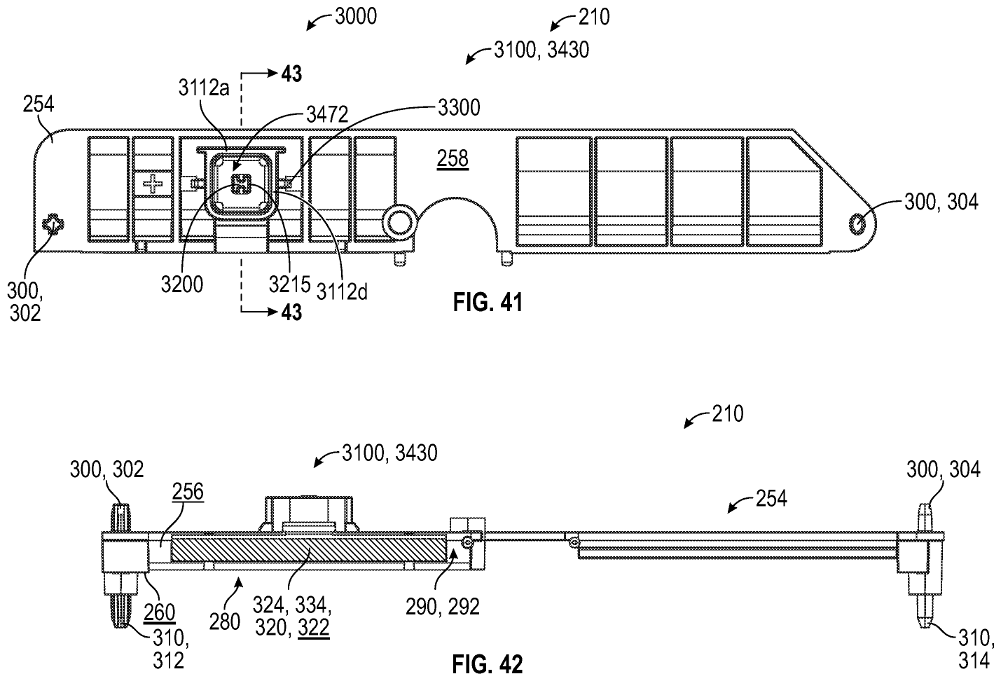

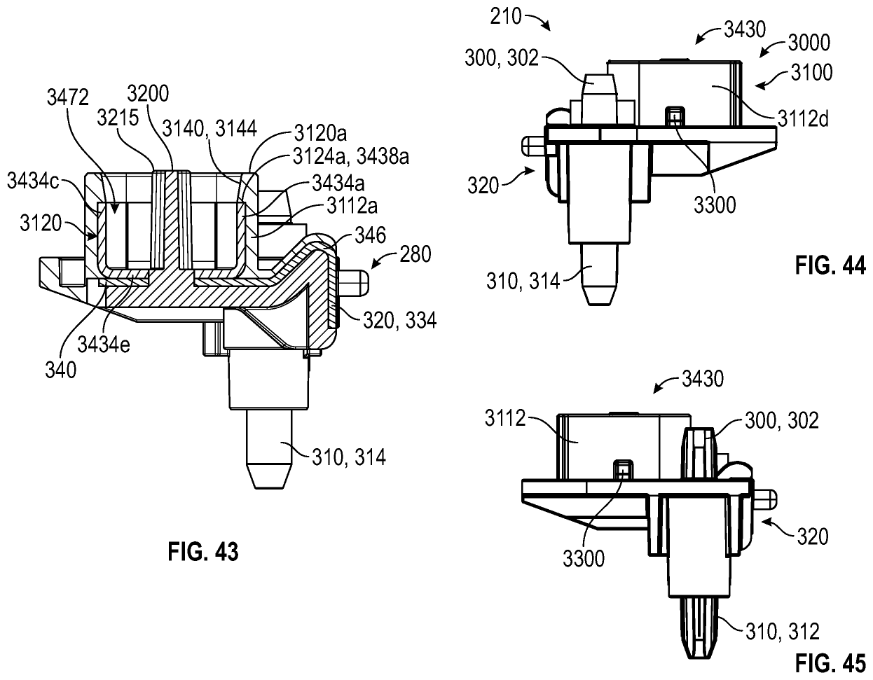

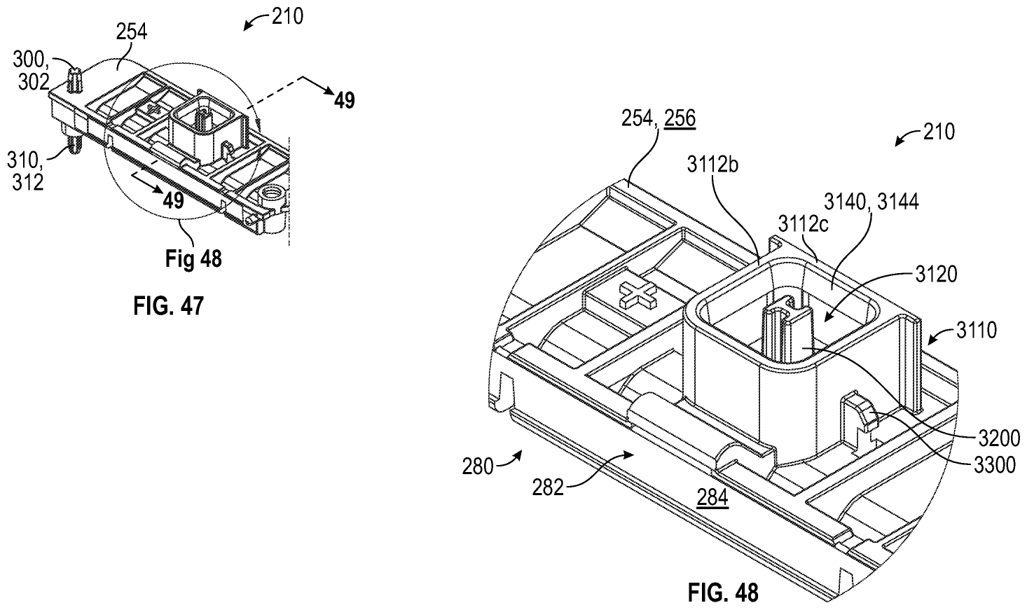

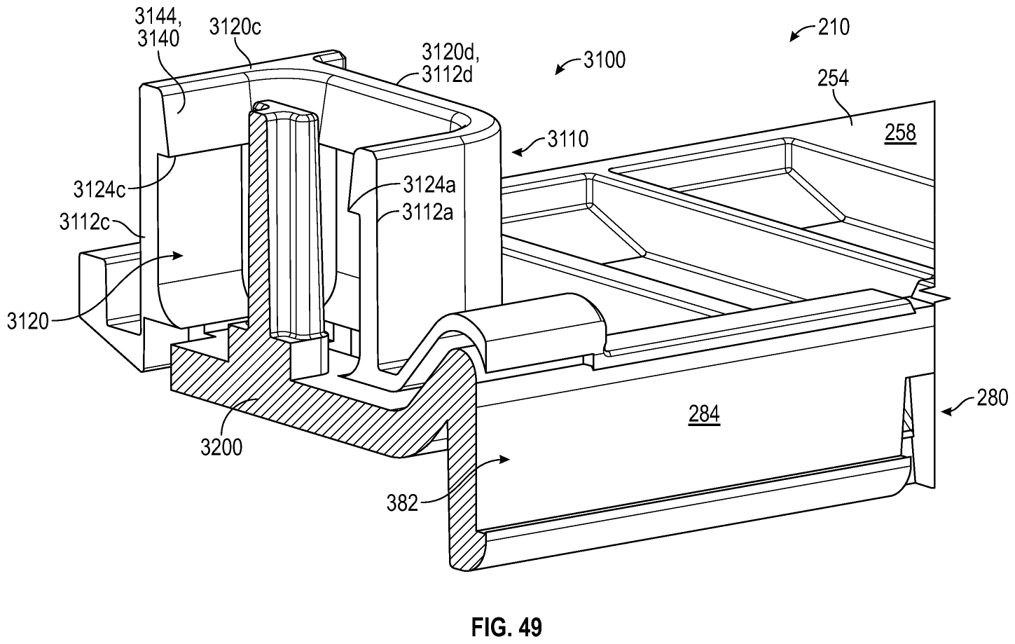

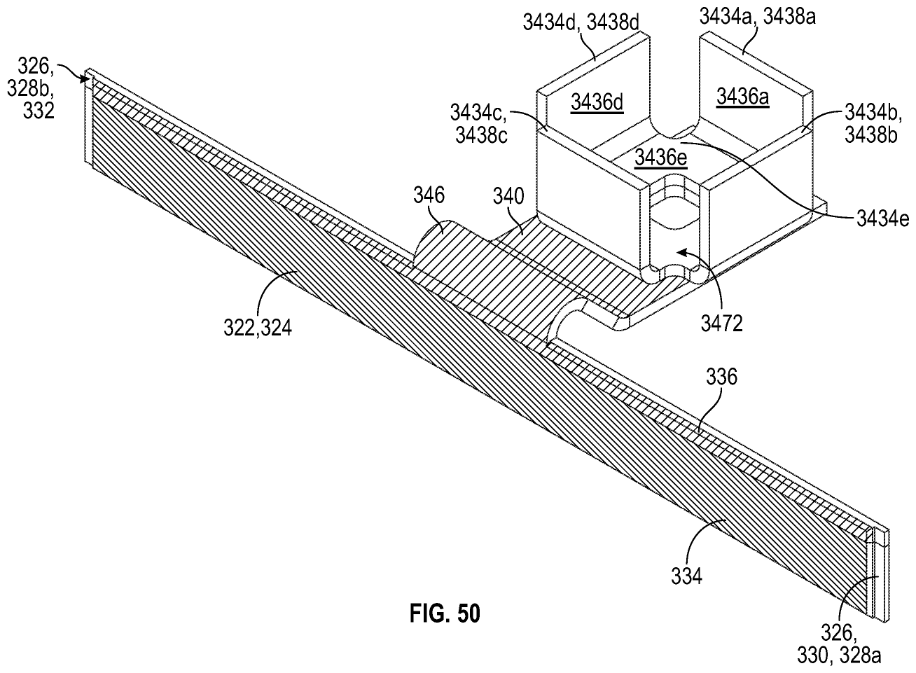

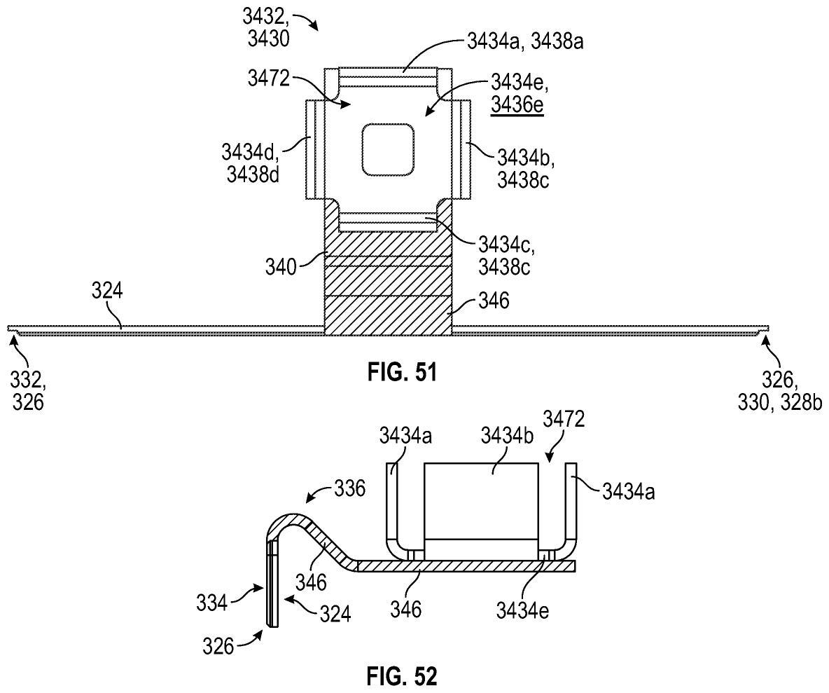

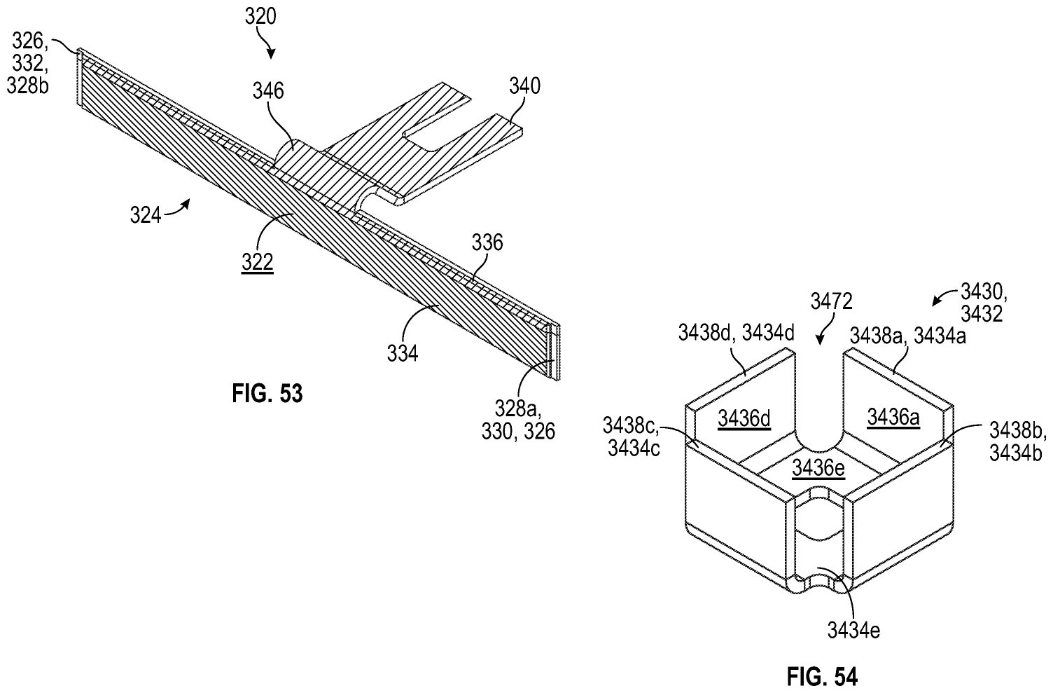

Referring to FIGS. 40-54, the positive connector module 210 includes: (i) a positive support structure 254, (ii) a positive busbar, internal positive busbar, or first inner busbar, or first busbar 320, and (iii) a positive boltless female connector assembly, boltless female connector assembly, positive female connector assembly, or female connector assembly 3000. The positive support structure 254 has an elongated body and includes: (i) a busbar mount 280, (ii) a plurality of upper support projections 300, and (ii) a plurality of lower support projections 310. The positive support structure 254 is designed to: (i) allow for the alignment of the positive busbar 320 with the positive terminal 178 of the battery cell 170 and (ii) provide enough space for the interior interface module 350 to position the positive busbar 320 inside of the positive busbar 320. This configuration allows the transfer assembly 200 to be properly coupled to the battery cells 170. The busbar mount 280 extends downward from an upper surface 258 of the positive support structure 254 and is designed to receive and position the positive busbar 320 for coupling with the positive terminal 178 of the battery cell 170. The busbar mount 280 includes: (i) mounting surface 284 and (ii) busbar coupler 290. The mounting surface 284 is depressed or recessed from the frontal surface 256 of the positive support structure 254, wherein said depression or recess from a busbar receiver 282. Said busbar receiver 282 is designed to receive the positive busbar 320 and place the front surface 322 of said busbar 320 substantially flush with an extent 264 of the positive support structure 254 that is adjacent to the mounting surface 284. In other words, the busbar receiver 282 has a depth, width, and height that is approximately equal to the depth, width, and height of the busbar 320. It should be understood that other embodiments: (i) the front surface 322 of said busbar 320 may not be substantially flush with an extent 264 of the positive support structure 254, and (ii) the mounting surface 284 and thus the busbar receiver 282 may be omitted.

The busbar coupler 290 includes at least one projection 292 that extends inward from an outer edge of mounting surface 284 and is designed to overlay an extent of the busbar 320, when the busbar 320 is inserted into the busbar receiver 282. To position the busbar 320 within the receiver 282 and under the projection 292, an assembler or machine will apply a force that is sufficient in order to cause the projection 292 to elastically deform to receive the busbar 320. Once the busbar 320 is received by the receiver 282, the projection 292 will return to its original position and as such it will overlay and extent of the busbar 320. By overlaying an extent of the busbar 320, the projection 292 ensures that the busbar 320 is retained within the receiver 282. It should be understood that other methods of coupling the busbar 320 to the positive support structure 254 may be used. For example, the busbar 320 may be inserted into a mold and the polymer that is used to form the support structure 254 may be injected around the busbar 320. In further embodiments, the coupler 290 may include additional structures (e.g., other projections), or different structures (e.g., some of which are disclosed below) that are designed to retain the busbar 320 within the receiver 282.

The plurality of upper support projections 300 and a plurality of lower support projections 310 facilitate the boltless assembly of the transfer assembly 200. The plurality of upper support projections 300 include: (i) a first upper support projection 302 located near a first end of the support structure 254, and (ii) a second upper support projection 304 located near a second opposed end of the support structure 254. The first and second support projections 302, 304 extend upwards from an upper surface 258 of the support structure 254 are configured to interact with a receiver (not shown) that is mounted on the inner surface of the top wall 114f of the battery module 100. This opposed positional relationship of the support projections 302, 304 helps ensure that the entire support structure 254 is secured within and to the housing 110, while minimizing the number of projections 302, 304 and/or structures. This is desirable because: (i) it reduces the weight of the transfer assembly 200, thereby reducing the weight of the battery module 100, and (ii) does not require bolts or other connectors, thereby reducing failure modes and assembly times. Nevertheless, other configurations of the support projections 302, 304 are contemplated by this disclosure. For example, the support projections 302, 304 may be replaced with a support wall that extends around a portion or the entire periphery of the support structure 254. In another example, the support projections 302, 304 may extend from the sides of the support structure 254 instead of the upper surface 258 of the support structure 254. In a further embodiment, additional support projections 302, 304 may be added to extend from the rear and sides of the support structure 254, such that the transfer assembly 200 is secured within and to the battery module housing 110 in multiple different directions (e.g., top, side, and rear).

Like the plurality of upper support projections 300, the support structure 254 includes: (i) a first lower support projection 312 located near the first end of the support structure 254, and (ii) a second lower support projection 314 located near a second opposed end of the support structure 254. The first and second support receptacle 312, 314 extend downward from an lower surface 260 and are configured to interact with the first and second support receptacles 412, 414 that extend from the interior interface module 350 within the transfer assembly 200. This opposed positional relationship of the support receptacle 312, 314 helps ensure that the entire support structure 254 is secured other structures 350, 450 within the battery module's housing 110, while minimizing the number of receptacle 312, 314 and/or structures. This is desirable because it reduces the weight of the transfer assembly 200 and in turn the weight of the battery module 100. Nevertheless, other configurations of the support receptacle 312, 314 are contemplated by this disclosure.

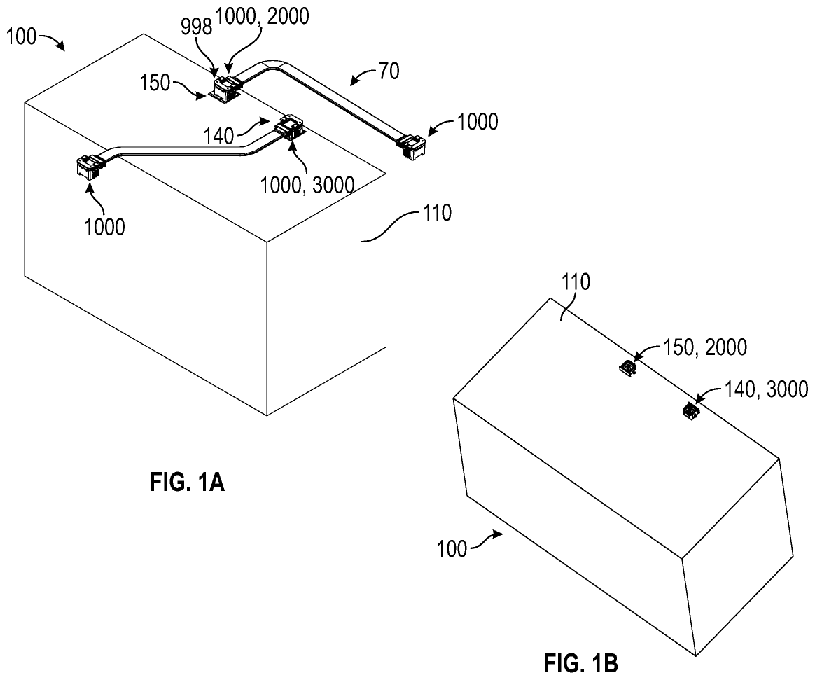

Identical to the positive female connector assembly 2000 as described above, the positive boltless female connector assembly 3000 is comprised of: (i) a positive female housing 3100 and (ii) a positive female terminal assembly 3430. The female housing 3100 is designed to: (i) receive the female terminal assembly 3430, (ii) facilitate the coupling of the male terminal assembly 1430 with the female terminal assembly 3430, (iii) minimize the chance that a foreign object accidentally makes contact with the female terminal assembly 3430, and (iv) meet industry standards, such as USCAR specifications. For sake of brevity, the above disclosure in connection with female connector assembly 2000 will not be repeated below, but it should be understood that across embodiments like numbers represent like structures. For example, the disclosure relating to positive female housing 3100 applies in equal force to positive female housing 3100 and the positive female terminal assembly 3430 applies in equal force to positive female terminal assembly 3430. While the embodiment discussed in FIGS. 1-75 utilize identical female connector assemblies 2000, 3000, it should be understood that in other embodiments, the female connector assembly 2000, 3000 may not be identical. For example, one connector assembly 2000 may have a circular configuration and the other connector assembly 3000 may have a rectangular configuration. In another embodiment, one connector assembly 2000 may have a square configuration and the other connector assembly 3000 may have a rectangular configuration.

The positive busbar 320, shown in FIGS. 40, 42, 46, 50-52, and 53, includes: (i) a battery cell interface 324, (ii) a female terminal interface 340, and (iii) an intermediate segment 346 that joins the battery cell interface 324 with the female terminal interface 340. The battery cell interface 324 is designed to: (i) be coupled to a pouch style battery cell 170 (see FIGS. 71-72), and (ii) be inserted within the busbar receiver 282 formed in the positive support structure 254 and retained within said receiver 282 by the busbar coupler 290. To couple the battery cell interface 324 to said battery cells 170, and more specifically the positive terminal 178 of the battery cells 170, a weldment process (e.g., ultrasonic, laser, resistive, pressure, flash, friction, diffusion, explosive, cold forming, or another type of welding method may be used) is utilized. Using said welding process, eliminates the need for threaded connectors and therefore reduces resistive losses, reduces failure modes, and is faster to assemble. However, in other embodiments, non-weldment (e.g., friction fit, bolted connectors, or other mechanical/chemical connection method) or a combination of non-weldment and weldment processes may be utilized.

Additionally, to facilitate the coupling between battery cell interface 324 and the positive battery cell terminal 178 and allow for electrical current to transfer between the busbar 320 and the terminal 178, the positive busbar 320 is formed from two different materials to: (i) facilitate the coupling between: (a) the battery cell interface 430, (b) the positive battery cell terminal 178, and (c) a male terminal assembly 1430 that is positively charged, and (ii) allow for electrical current to transfer between said structures. In particular, a first portion 334 of the battery cell interface 324 is formed from a first material (e.g., aluminum) and a second portion 336 of the battery cell interface 324 is formed from a second material (e.g., copper). As such, the battery cell interface 324 is bimetallic. Said bimetallic configuration is beneficial due to the structure and chemical makeup of the battery cells 170 and the charging/discharging of the battery module via the positive external connection 140. To form this battery cell interface 324, the first and second portions 334, 336 are coupled to one another using any known process, including laser welding, resistive butt welding, pressure welding, flash butt welding, friction welding, diffusion welding, explosive welding, or cold forming. Additionally, the first and second portions 334, 336 may have structures that interlock (e.g., dove tale) or overlap to help ensure that the portions 334, 336 remain joined as a single busbar.

Forming the battery cell interface 324 from two different materials allows the first portion 334 to be coupled to the positive terminal 178 of a first battery cell 170, while allowing the second portion 336 to be coupled to the positive external connection 140. The coupling of these structures facilitates the charging and discharging of the battery cell 170. While aluminum (as shown by the use of surface shading having greater density or a steeper angle) and copper (as shown by the use of surface shading having less density or a shallower angle) are utilized in this embodiment, it should be understood that other materials or combinations of materials may be used. For example, the battery cell interface 324 may be made of a single material if the battery cells 170 are altered to make such a configuration possible.

As discussed above, the busbar coupler 290 shown in the Figures includes at least one projection 292 that extends inward from an outer edge of mounting surface 284 and is designed to overlay an extent of the busbar 320, when the busbar 320 is inserted into the busbar receiver 282. To allow for projection 292 to overlay an extent of the busbar 320, the busbar 320 includes a support structure coupler 326 that is shown as coupling recesses 330, 332 that extend inward from the opposed ends 322a, 322b of the busbar 320. The configuration of the busbar receiver 282, busbar coupler 290, and support structure coupler 326 function together to: (i) fix the busbar 320 to the support structure 254, (ii) place the frontal surface 322 of the battery cell interface 324 substantially flush with the frontal surface 256 of the support structure 254, and (iii) position the busbar 320 to be coupled to the battery cell 170. It should be understood that an alternative structures and/or method of accomplishing the above points may be used in other embodiments. In particular, the busbar receiver 282, busbar coupler 290, and support structure coupler 326 may be replaced with any type of busbar retaining means. Said retaining means may take on any known shape of configuration that can reliably couple the busbar 320 to the support structure 254.

The female terminal interface 340: (i) has a width and a length that is sufficient (e.g., larger than) to receive the rear wall 3434e of the female terminal assembly 3430, (ii) is designed to fit around the touch proof post 3200, and (iii) allows for current transfer from the intermediate segment 346 to the female terminal assembly 3430. In the embodiment shown in the Figures, the female terminal interface 340 has a U-shaped configuration with an opening 342 formed therein that enables the female terminal interface 340 to be laterally inserted around the touch proof post 3200. Once the female terminal interface 340 has been inserted around the touch proof post 3200 and the battery cell interface 324 is properly seated in the busbar receiver 282, the female terminal body 3432 may be coupled thereto to form a coupled state. Said coupling may utilize a weldment process (e.g., ultrasonic, laser, resistive, pressure, flash, friction, diffusion, explosive, cold forming, or another type of welding method may be used). In other embodiments, the female terminal body 3432 may be coupled the female terminal interface 340 using a non-weldment (e.g., friction fit, bolted connectors, or other mechanical/chemical connection method) method, or a combination of a weldment and a non-weldment method. In this embodiment, the female terminal interface 340 is made a single material (e.g., copper) and thus is not bimetallic. Additionally, the female terminal interface 340 may be made from the same material as the second portion 336 of the battery cell interface 324 and therefore the combination of these structures is not bimetallic. Finally, the female terminal interface 340 may be made from a different material from the first portion 334 of the battery cell interface 324 and therefore the combination of these structures is bimetallic. Accordingly, the positive busbar 320 is bimetallic. However, in other embodiments: (i) the U-shaped structure may be omitted because the female terminal interface 340 may not be designed to fit around the touch proof post 2200, (ii) the female terminal interface 340 may be made from the same material as the first portion 334, and/or (iii) may be plated or clad with another material (e.g., tin).

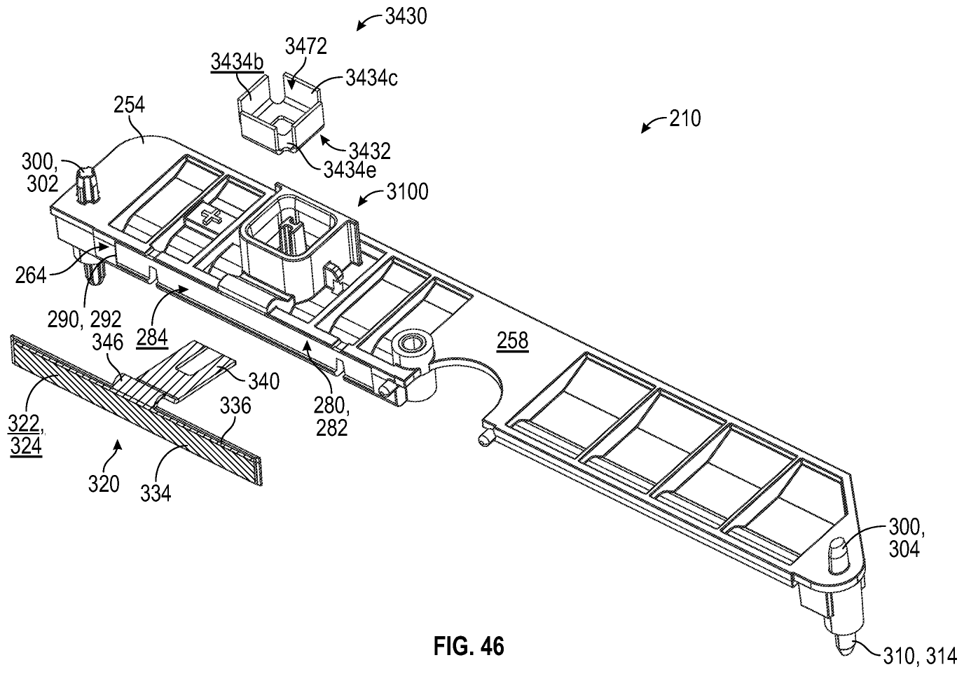

The intermediate segment 346 joins the battery cell interface 324 to female terminal interface 340. In this embodiment, intermediate segment 346 is made a single material (e.g., copper) and thus is not bimetallic. Additionally, the intermediate segment 346 may be made from the same material as one of: (i) the first portion 334 of the battery cell interface 324, (ii) the second portion 336 of the battery cell interface 324, or (iii) female terminal interface 340. Accordingly, the combination of the second portion 336 of the battery cell interface 324, intermediate segment 346 and the female terminal interface 340 may not be bimetallic. Finally, the intermediate segment 346 may be made from (e.g., copper): (i) the same material (e.g., copper) as the second portion 336 of the battery cell interface 324 and the female terminal interface 340, and (ii) a different material (e.g., aluminum) as the first portion 334 of the battery cell interface 324 and therefore the combination of these structures are bimetallic. However, if a combination of materials are used in an alternative embodiment, these components may be joined using laser welding, resistive butt welding, pressure welding, flash butt welding, friction welding, diffusion welding, explosive welding, cold forming, or another type of welding or fusion method. The intermediate segment 346 is designed such that it places the battery cell interface 324 substantially perpendicular to female terminal interface 340. This configuration is desirable because it allows for the battery cells 170 to be horizontally stacked (see FIG. 71-72) within the battery module 100, while allowing the female terminal body 3432 to be accessible from the top of the battery module 100. Alternatively, if these structures were not substantially perpendicular and instead were parallel, then the female terminal body 3432 would be accessible from the side of the battery module 100. This configuration is not desirable in light of the current configuration of the battery pack 80; however, it may be desirable in other configurations of battery packs 80. Overall and as best seen in FIGS. 46 and 53-54, the female terminal body 3432 and the positive busbar 320 are not integrally formed for various reasons, including assembly, desirability of plating the terminal body 3432, and ease of manufacturing. While the figures show these components as not integrally formed with one another, it should be understood that they may be integrally formed in other embodiments.

### IV. Assembled Transfer Assembly

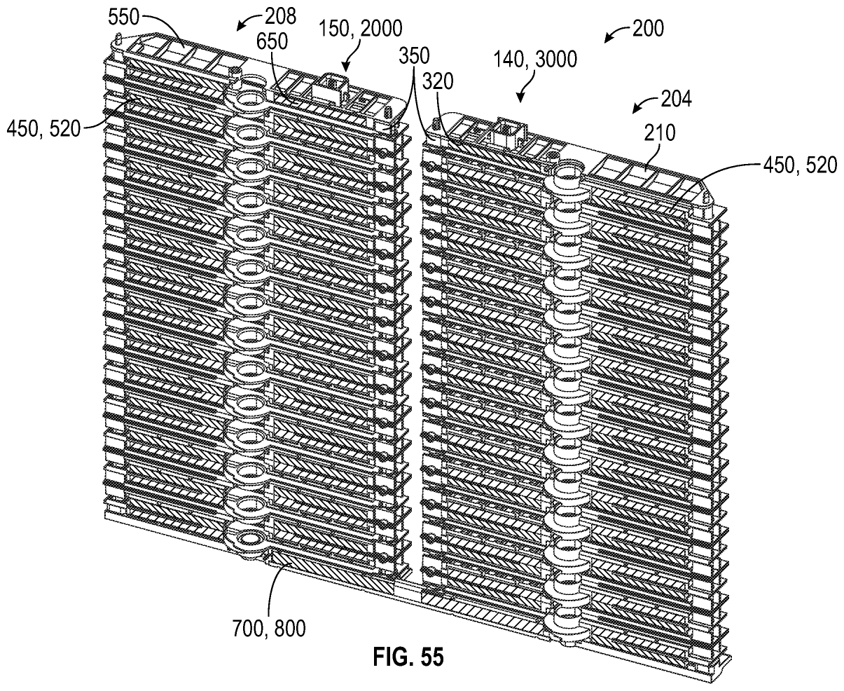

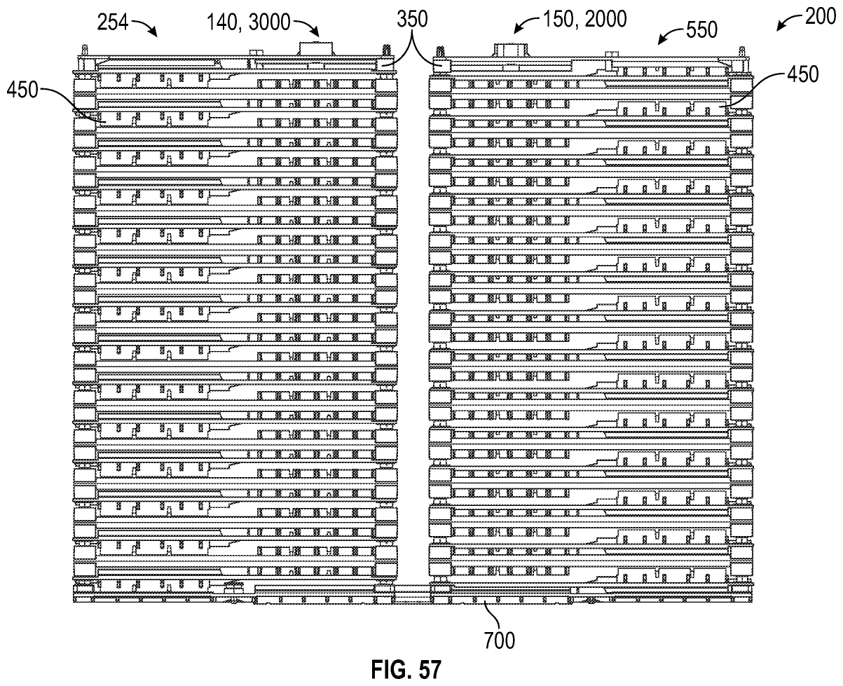

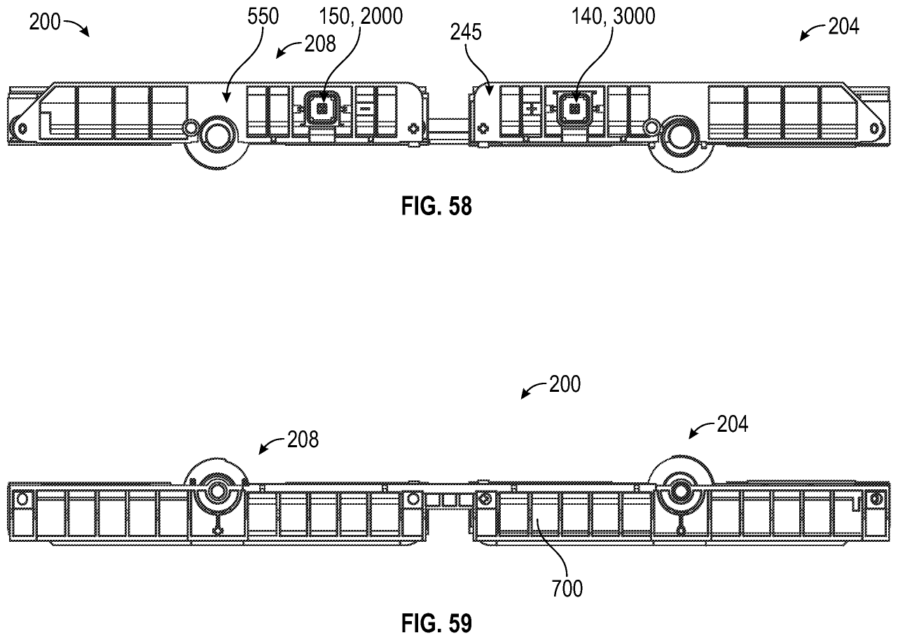

FIGS. 55-59 show a fully assembled boltless transfer assembly 200 that is suitable for installation within a battery module housing 110. As shown this exemplary embodiment, the transfer assembly 200 includes: (i) a positive cell stack 204 having: (a) a positive connector module 210, (b) 13 internal interface modules 350, and (c) 13 exterior interface modules 450, (ii) a negative cell stack 208 having: (a) a negative connector module 550, (b) 13 internal interface modules 350, and (c) 13 exterior interface modules 450, and (iii) a jumper interface module 700 that couples the positive cell stack 204 to the negative cell stack 208. As such, this design allows for 28 battery cells 170 to be coupled to each cell stack 204, 208. To enable the battery module 100 to have an approximate voltage output of 48 volts, each battery cell 170 would need to output about 0.85 volts. It should be understood that the transfer assembly 200 may include any number of: (i) internal interface modules 350 and (ii) exterior interface modules 450. For example, the transfer assembly 200 may have: (i) a two exterior interface modules 450, and (ii) a jumper interface module 700. In other example, the transfer assembly 200 may have: (i) more than one hundred internal interface modules 350, (ii) more than one hundred exterior interface modules 450, (iii) 5 jumper interface module 700.

Once the transfer assembly 200 has been assembled and the battery cells 170 are coupled thereto, the combination of the structure 200 and cells 170 are typically secured in a housing 110 to form the battery module 100. While the transport structure 200 is designed to be secured within housing 110 without the use of bolts or threaded connectors, it should be understood that some embodiments may utilize such bolts or threaded connectors to help ensure that structure 200 is secured within housing 110. However, it should be understood that the use of such bolts or threaded connectors in the depicted embodiment are not utilized to: (i) couple the battery cells 170 to the transfer assembly 200, or (ii) electrically couple the module 100 to another device (e.g., another battery module 100). As described above, other embodiments may utilize bolts or threaded connectors to couple the battery cells 170 to the transport structure 200, but this disclosure does not contemplate replacing both the positive and negative external connections 140, 150 with a bolted connection in any embodiment. In alternative embodiments, the battery module housings 110 may be omitted and the transport structures 200 may just be installed within a battery pack 80. In a further alternative embodiment, the battery pack 80 may be omitted and the transport structure 200 may just be installed within the application 10 of the structure 200, wherein said application 10 may be a vehicle 20 (FIG. 84), a bus 25 (FIG. 85), a locomotive, a tractor, a boat, a submarine, large ship 30 (FIG. 86), ship 35 (FIG. 87), tanker, sailing yacht, telecommunications hardware, a power storage system, and/or renewable energy hardware.

### V. Boltless Busbar

FIG. 60 shows a boltless busbar assembly 70, which includes: (i) a conductor or external busbar 4000, and (ii) at least one male connector assembly 1000. The conductor 4000 may be any known conductor, which includes conventional busbars, braded wires, solid wires, or the busbars described in PCT/US2020/050018 or provisional patent application No. 63/234,320. The male connector assembly 1000 includes multiple components that are designed to be positioned external to the top wall 114f of the battery module housing 110 and provide power outside of the battery module 100 to an external device (e.g., another battery module 100 contained in the battery pack 80, radiator fan, heated seat, power distribution component, or another current drawing component). As shown in the Figures, the male connector assembly 1000 does not include a lever to assist in the coupling of the male connection assembly 1000 to the female connection assembly 2000. While the below disclosed focuses on a single male connector assembly 1000, it should be understood that this male connector assembly can be used in connection with the negative external connection 150 and the positive external connection 140. In other words, the following disclosure covers both the positive and negative connectors because the connectors are identical. For sake of brevity, the following disclosure will not be repeated for a positive connector assembly and a negative connector assembly and a single set of reference numbers will be utilized for both of these connector assemblies. As such, the male connector assembly 1000 is primarily composed of: (i) the exterior male housing assembly 1100, (ii) the male terminal assembly 1430.

The male housing assembly 1100 encases or surrounds a substantial extent of the other components contained within the male connector assembly 1430. The exterior housing assembly 1100 generally includes: (i) an exterior housing 1104 and (ii) a deformable connector position assurance (“CPA”) 1170. The exterior housing 1104 includes two arrangements of walls, wherein: (i) the first side wall arrangement 1106 has a rectangular shape and is designed to receive an extent of the conductor 4000 and (ii) the second side wall arrangement 1108 has a cubic shape and is designed to receive a substantial extent of the male terminal assembly 1430. The second arrangement of walls 1108 includes a non-deformable CPA receiver 1160 that extends from at least one of the walls 1108b and preferably two walls 1108d and is designed to receive an extent of the deformable CPA 1170. The two arrangements of walls are typically formed from an insulating material that is designed to isolate the electrical current that flows through the male connector assembly 1000 from other components. Additional details about the exterior housing assembly 1100 are described within PCT/US2019/36070. It should be understood that the male housing assembly 1100 does not include a lever to assist in the coupling of the male connection assembly 1000 to the female connection assembly 2000.

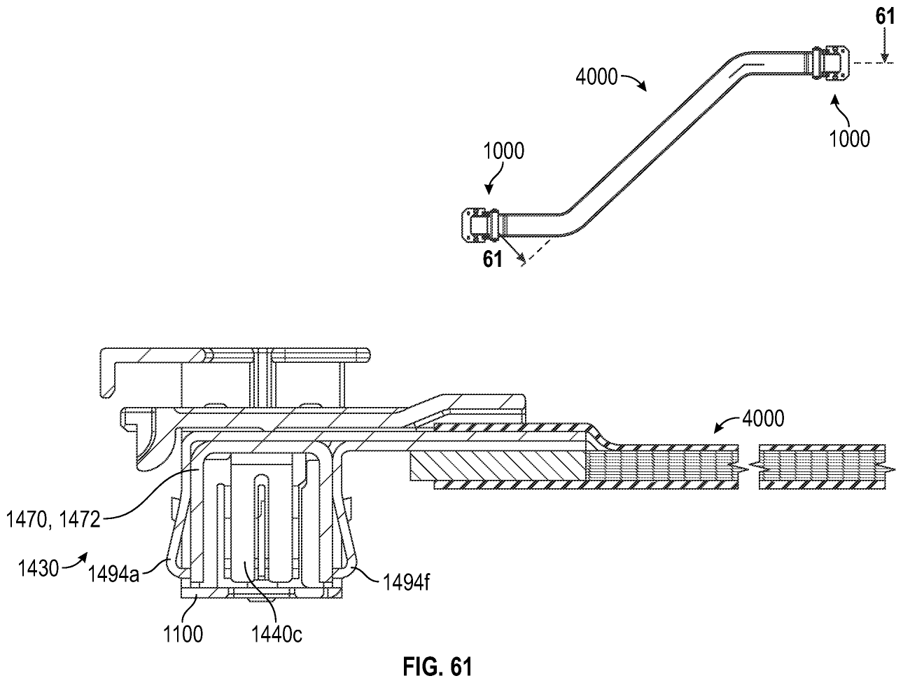

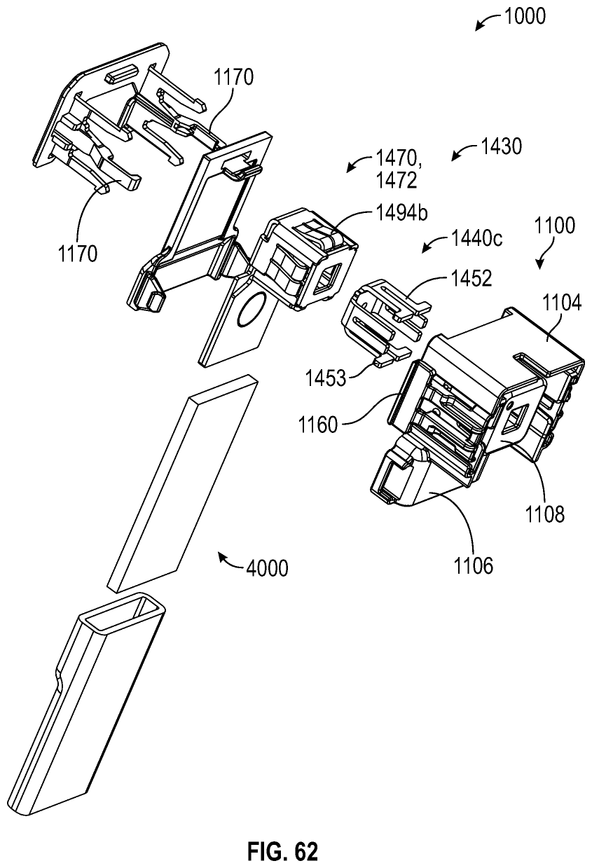

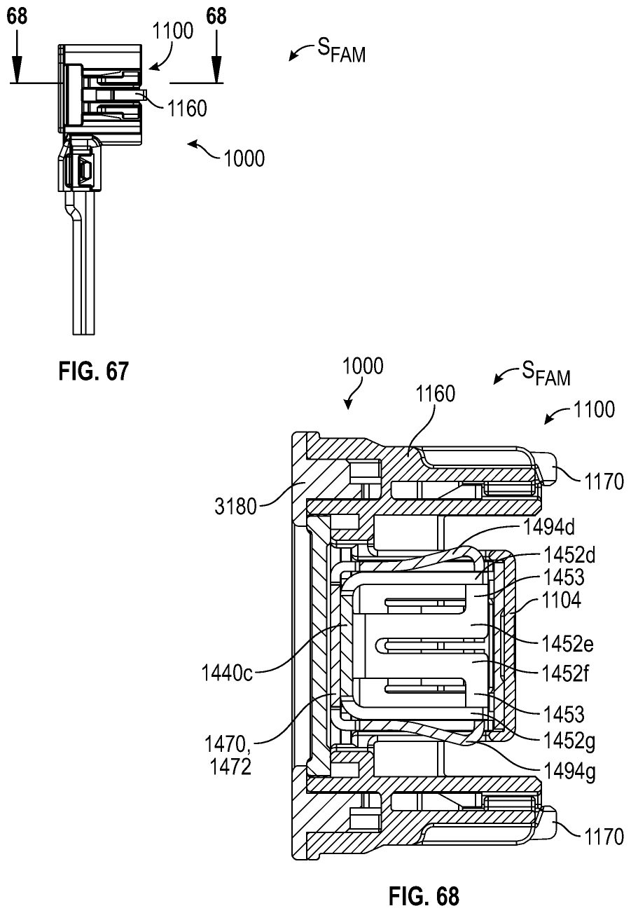

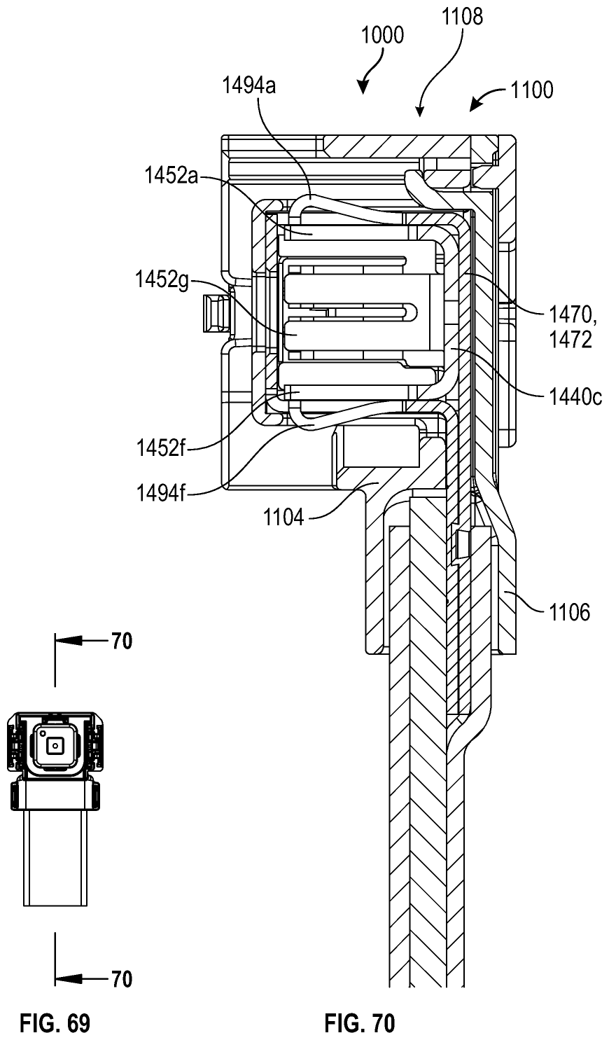

FIGS. 61-70 and 74 provide various views of the male terminal assembly 1430, wherein said assembly 1430 includes a spring member 1440c and a male terminal 1470. The male terminal 1470 includes a male terminal body 1472 and a male terminal connection member or plate 1474. Said male terminal body 1472 includes: (i) a first or front male terminal wall 1480 with a touch proof post opening 1510 formed therein, (ii) an arrangement of male terminal side walls 1482a-1482d, and (iii) a second or rear male terminal wall 1484. The combination of these walls 1480, 1482a-1482d forms a spring receiver 1486 that is designed to receive the internal spring member, male spring member, or second spring member 1440c.

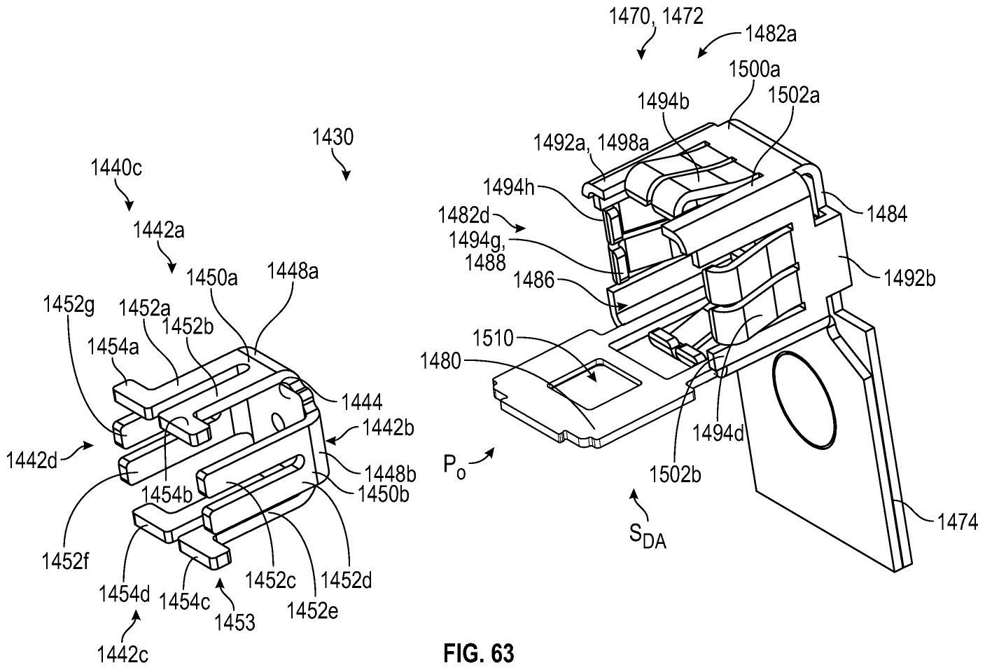

Referring to FIG. 63, the internal spring member 1440c includes an arrangement of spring member side walls 1442a-1442d and a rear spring wall 1444. The arrangement of spring member side walls 1442a-1442d each is comprised of: (i) a first or arched spring section 1448a-1448d, (ii) a second spring section, a base spring section, or a middle spring section 1450a-1450d, (iii) a third section or spring arm 1452a-1452h, and (iv) a forth section or centering means 1453. The arched spring sections 1448a-1448d extend between the rear spring wall 1444 and the base spring sections 1450a-1450d and position the base spring sections 1450a-1450d substantially perpendicular to the rear spring wall 1444. In other words, the outer surface of the base spring sections 1450a-1450d is substantially perpendicular to the outer surface of the rear spring wall 1444.

The base spring sections 1450a-1450d are positioned between the arched sections 1448a-1448d and the spring arms 1452a-1452h. As shown in FIG. 63, the base spring sections 1450a-1450d are not connected to one another and thus gaps are formed between the base spring sections 1450a-1450d of the spring member 1440c. The gaps aid in omnidirectional expansion of the spring arms 1452a-1452h, which facilitates the mechanical coupling between the male terminal 1470 and the female terminal assembly 2430. The spring arms 1452a-1452h extend from the base spring sections 1450a-1450d of the spring member 1440c, away from the rear spring wall 1444, and terminate at a free end 1446. The spring arms 1452a-1452h are generally planar and are positioned as such the outer surface of the spring arms 1452a-1452h are coplanar with the outer surface of the base spring sections 1450a-1450d. Unlike the spring arm 31 that is disclosed within FIGS. 4-8 of PCT/US2018/019787, the free end 1446 of the spring arms 1452a-1452h do not have a curvilinear component. Instead, the spring arms 1452a-1452h have a substantially planar outer surface. This configuration is beneficial because it ensures that the forces associated with the spring member 1440c are applied substantially perpendicular to the free end 1488 of the male terminal body 1472. In contrast, the curvilinear components of the spring arm 31 are disclosed within FIGS. 4-8 of PCT/US2018/019787 do not apply a force in this manner.

Like the base spring sections 1450a-1450d, the spring arms 1452a-1452h are not connected to one another. In other words, there are spring arm openings that extend between the spring arms 1452a-1452h. This configuration allows for the omnidirectional movement of the spring arms 1452a-1452h, which facilitates the mechanical coupling between the male terminal 1470 and the female terminal assembly 2430. In other embodiments, the spring arms 1452a-1452h may be coupled to other structures to restrict their omnidirectional expansion. The number and width of individual spring arms 1452a-1452h and openings may vary. In addition, the width of the individual spring arms 1452a-1452h is typically equal to one another; however, in other embodiments one of the spring arms 1452a-1452h may be wider than other spring arms.

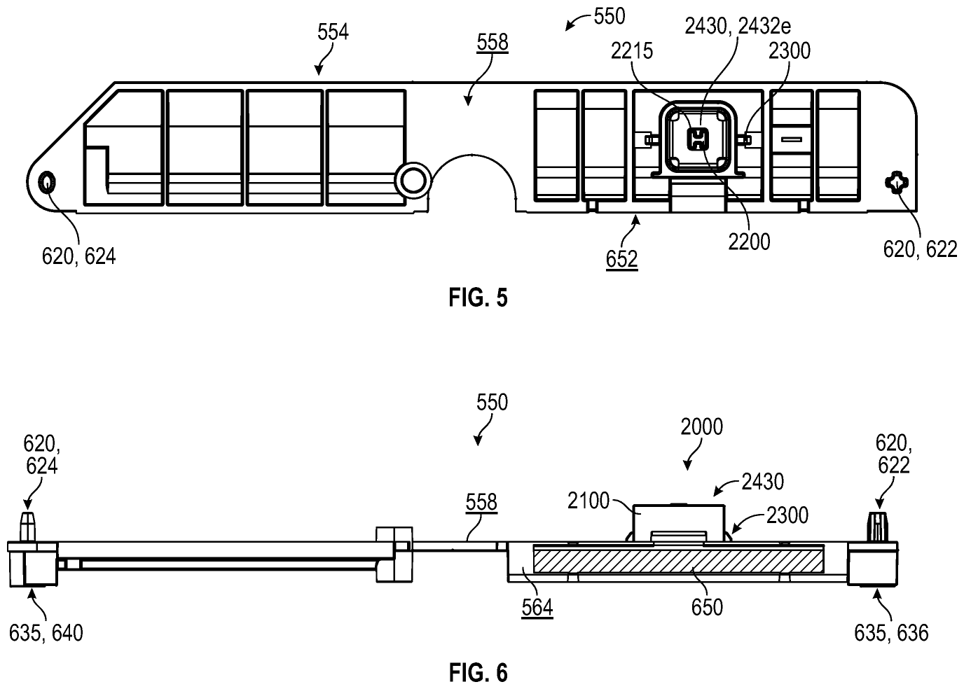

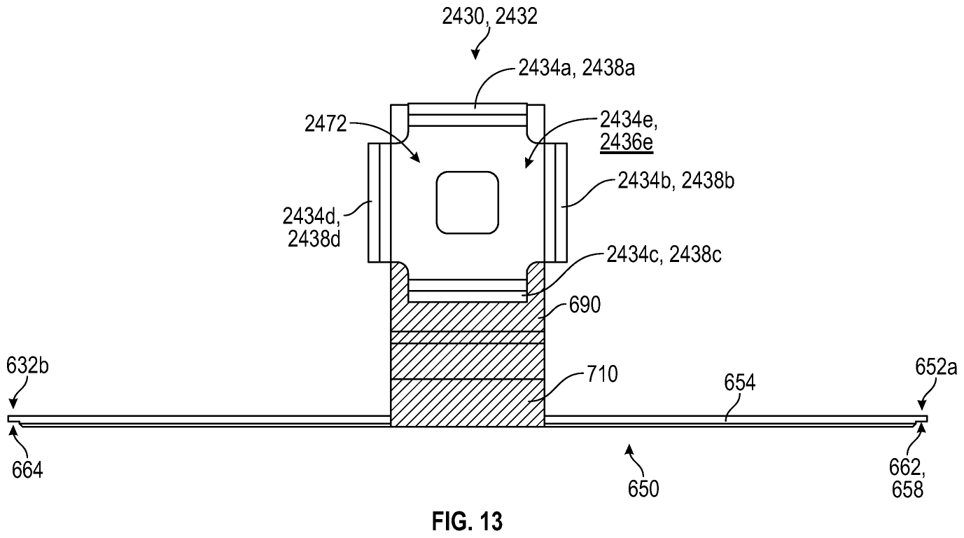

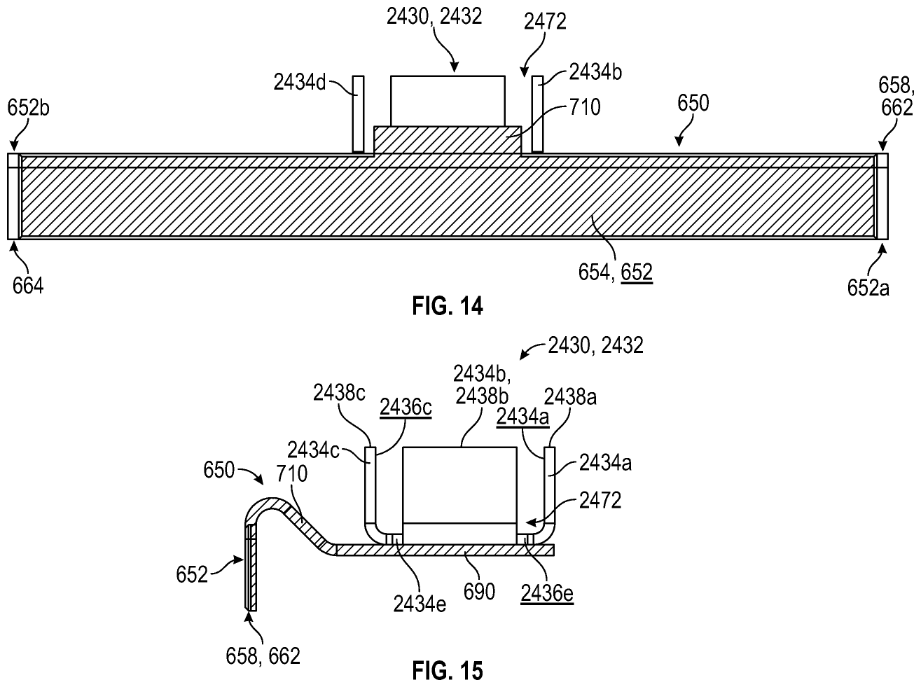

A previous design of the spring member 1440pd is disclosed in connection with FIGS. 5-6 of PCT/US2019/36127 and FIG. 13 of PCT/US2021/043686 shows how the spring member 1440pd may be perfectly aligned within the male terminal body 1472pd of the male terminal assembly 1430pd. However, due to manufacturing tolerances and imperfect assembly methods, the spring member 1440pd may become misaligned or cocked within the male terminal body 1472pd during assembly of the male terminal assembly 1430pd. An example of this misalignment is shown in FIG. 14 of PCT/US2021/043686, wherein angle theta θ shows this misalignment as it extends between the inner surface of the spring receive and the outer surface of the spring member 1440pd. In certain embodiments, angle theta θ may be between 1 degree and 5 degrees. In order to help avoid this misalignment, the spring member 1440c disclosed herein includes centering means 1453, which is shown as anti-rotation projections 1454a-1454d. The anti-rotation projections 1454a-1454d help center the spring member 1440c by limiting the amount the spring member 1440c can rotate within the male terminal body 1472 due to the interaction between the outer surface of the projections 1454a-1454d and an inner surface of the side wall portions 1492a-1492d of the male terminal body 1472. Properly centering the spring member 1440c within the male terminal body 1472, provides many advantages over terminals that are not properly centered or aligned within the male terminal assembly 1430, wherein these advantages includes: (i) ensuring that the spring member 1440c applies a proper force on the male terminal body 1472 to provide a proper connection between the male terminal assembly 1430 and the female terminal assembly 2430, (ii) helps improve the durability and useable life of the terminal assemblies 1430, 2430, and (iv) other beneficial features that are disclosed herein or can be inferred by one of ordinary skill in the art from this disclosure.

It should be understood that is other embodiments the centering or alignment means 1453 may take other forms, such as: (i) projections that extend outward from the first and second spring arms 1452a, 1452b that are positioned within a single side wall, (ii) projections that extend outward from the first and fifth spring arms 1452a, 1452e, wherein the projections are situated diagonally opposite from one another, (iii) projections that extend outward from all spring arms 1452a-1452h, wherein the projections associated with 1452c, 1452d, 1452g, 1452h are offset positional relationship in comparison to the projections associated with 1452a, 1452b, 1452e, 1452f, (iv) projections that extend inward from the inside walls of the male terminal body 1472, (v) projections that extend inward towards the center of the connector from the contact arms 1494a-1494h, (vi) cooperative dimensioned spring retainer, (vii) projections, tabs, grooves, recesses, or extents of other structures that are designed to help ensure that the spring member 1440c is centered within the male terminal body 1472 and cannot rotate within the spring receiver 1486. For example, a projection may extent from the front or rear walls of the male terminal body 1472 and they may be received by an opening formed within the spring member 1440c.

It should further be understood that instead of utilizing a mechanical based centering or alignment means 1453, the centering means 1453 may be force based, wherein such forces that may be utilized are magnetic forces or chemical forces. In this example, the rear wall of the spring member 1440c may be welded to the rear wall of the male terminal body 1472. In contrast to a mechanical or force based centering means 1453, the centering means 1453 may be a method or process of forming the male terminal assembly 1430. For example, the centering means 1453 may not be a structure, but instead may simultaneous printing of the spring member 1440c within the male terminal body 1472 in a way that does not require assembly. In other words, the centering means 1453 may take many forms (e.g., mechanical based, force based, or process based) to achieve the purpose of centering the spring member 1440c within the male terminal body 1472.

The internal spring member 1440c is typically formed from a single piece of material (e.g., metal); thus, the spring member 1440c is a one-piece spring member 1440c or has integrally formed features. In particular, the following features are integrally formed: (i) the arched spring section 1448a-1448d, (ii) the base spring section 1450a-1450d, (iii) the spring arm 1452a-1452h, and (iv) the centering means 1453. To integrally form these features, the spring member 1440c is typically formed using a die forming process. The die forming process mechanically forces the spring member 1440c into shape. As discussed in greater detail below and in PCT/US2019/036010, when the spring member 1440c is formed from a flat sheet of metal, installed within the male terminal 1472 and connected to the female receptacle 2472, and is subjected to elevated temperatures, the spring member 1440c applies an outwardly directed spring thermal force S_{TF} on the contact arms 1494a-1494h due in part to the fact that the spring member 1440c attempts to return to a flat sheet. However, it should be understood that other types of forming the spring member 1440c may be utilized, such as casting or using an additive manufacturing process (e.g., 3D printing). In other embodiments, the features of the spring member 1440c may not be formed from a one-piece or be integrally formed, but instead formed from separate pieces that are welded together.

In an alternative embodiment that is not shown, the spring member 1440c may include recesses and associated strengthening ribs. As discussed in PCT/US2019/036010, these changes to the configuration of the spring member 1440c alter the forces that are associated with the spring member 1440c. In particular, the spring biasing force S_{BF} is the amount of force that is applied by the spring member 1440c to resist the inward deflection of the free end 1446 of the spring member 1440c when the male terminal assembly 1430 is inserted within the female terminal assembly 2430. Specifically, this inward deflection occurs during the insertion of the male terminal assembly 1430 due to the fact that an extent of an outer surface of the male terminal body 1472 is slightly larger than the interior of the female receptacle 2472. Thus, when the male terminal assembly 1430 is inserted into the female terminal assembly 2430, the extent of the outer surface is forced towards the center 1490 of the male terminal 1470. This inward force on the outer surface displaces the free end 1446 of the spring member 1440c inward (i.e., towards the center 1490). The spring member 1440c resists this inward displacement by providing a spring biasing force S_{F}.

FIGS. 61-70 show a male terminal 1470 that includes the male terminal body 1472 and a male terminal connection plate 1474. Specifically, the male terminal connection plate 1474 is coupled to the male terminal body 1472 and is configured to receive an extent of a structure (e.g., busbar) that connects the male terminal assembly 1430 to a device (e.g., second battery module 100) outside of the connector system 998. The conductor 4000 is typically welded to the connection plate 1474; however, other methods (e.g., forming the conductor 4000 as a part of the connection plate 1474) of connecting the conductor 4000 to the connection plate 1474 are contemplated by this disclosure.

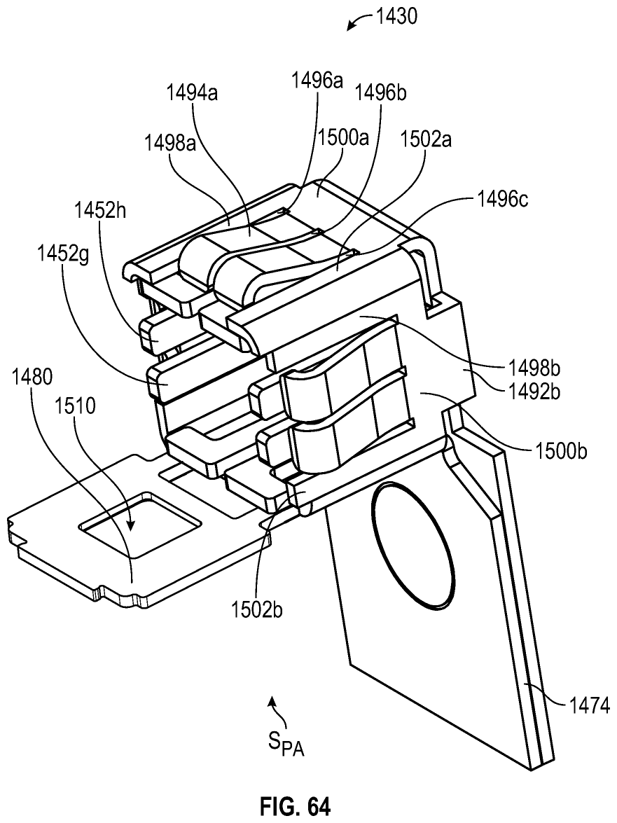

As shown in FIGS. 61-70 the arrangement of male terminal side walls 1482a-1482d are coupled to one another and generally form a rectangular prism. The arrangement of male terminal side walls 1482a-1482d includes: (i) a side wall portion 1492a-1492d, which generally has a “U-shaped” configuration, (ii) contact arms 1494a-1494h, and (iii) a plurality of contact arm openings 1496a-14961. As best shown in FIG. 64, the side wall portions 1492a-1492d are substantially planar and have a U-shaped configuration. The U-shaped configuration is formed from three substantially linear segments, wherein a second or intermediate segment 1500a-1500d is coupled on one end to a first or end segment 1498a-1498d and on the other end to a third or opposing end segment 1502a-1502d. The contact arms 1494a-1494h extend: (i) from an extent of the intermediate segment 1500a-1500d of the side wall portion 1492a-1492d, (ii) away from the rear male terminal wall 1484, (iii) across an extent of the contact arm openings 1496a-14961, and (iv) terminate just short of the front male terminal wall 1480. This configuration is beneficial over the configuration of the terminals shown in FIGS. 9-15, 18, 21-31, 32, 41-42, 45-46, 48 and 50 in PCT/US2018/019787 because it allows for: (i) can be shorter in overall length, which means less metal material is needed for the formation and the male terminal 1470 can be installed in narrower, restrictive spaces, (ii) has a higher current carrying capacity, (iii) is easier to assemble, (iv) improved structural rigidity because the contact arms 1494a-1494h are positioned inside of the first male terminal side wall portion 1492a-1492d, (iv) benefits that are disclosed in connection with PCT/US2019/036010, and (v) other beneficial features that are disclosed herein or can be inferred by one of ordinary skill in the art from this disclosure.

The contact arm openings 1496a-14961 are integrally formed with the intermediate portion 1500a-1500d of the male terminal side walls 1482a-1482d. The contact arm openings 1496a-14961 extend along the lateral length of the contact arms 1494a-1494h in order to create a configuration that permits the contact arms 1494a-1494h not to be laterally connected to: (i) another contact arm 1494a-1494h or (ii) a structure other than the extent of the male terminal side wall portion 1492a-1492d to which the contact arms 1494a-1494h are coupled thereto. Additionally, the contact arm openings 1496a-14961 are aligned with the spring arm openings. This configuration of openings forms the same number of spring arms 1452a-1452h as the number of contact arms 1494a-1494h. In other words, FIGS. 63 and 66 show eight spring arms 1452a-1452h and eight contact arms 1494a-1494h. It should be understood that in other embodiments, the number of spring arms 1452a-1452h may not match the number of contact arms 1494a-1494h. For example, there may be fewer than one spring arms 1452a-1452h.

The contact arms 1494a-1494h extend away from the rear male terminal wall 1484 at an outward angle. In particular, the outward angle may be between 0.1 degree and 16 degrees between the outer surface of the extent of the male terminal side wall 1492a-1492d and the outer surface of the first extent of the contact arms 1494a-1494h, preferably between 5 degrees and 12 degrees and most preferably between 7 degrees and 8 degrees. This outward angle is shown in multiple figures, but may be best visualized in connection with FIGS. 61, 68, and 70. This configuration allows the contact arms 1494a-1494h to be deflected or displaced inward and towards the center 1490 of the male terminal 1470 by the female receptacle 2472, when the male terminal assembly 1430 is inserted into the female terminal assembly 2430. In particular, the male terminal body 1472 has an outer perimeter that extends around the outermost extent of the contact arms 1494a-1494h. In a disconnected state (i.e., when the male terminal body 1472 is not inserted within the female terminal assembly 2430), the outer perimeter of the male terminal body has a first uncompressed dimension when the male terminal body. In a fully connected state S_{FC} (i.e., when the male terminal body 1472 is inserted within the female terminal assembly 2430 (see FIG. 74)), the outer perimeter of the male terminal body has a uncompressed dimension. And wherein the compressed dimension is less than the uncompressed dimension. In this disclosed embodiment, the uncompressed dimension is between 1% and 15% larger than the compressed dimension due to the configuration and design of the male terminal body 1472 and the female terminal body 2430.

This inward deflection is best shown in FIGS. 74, which is evidenced by the gap 1550. This inward deflection helps ensure that a proper mechanical and electrical connection is created by ensuring that the contact arms 1494a-1494h are placed in contact with the female receptacle 2472.

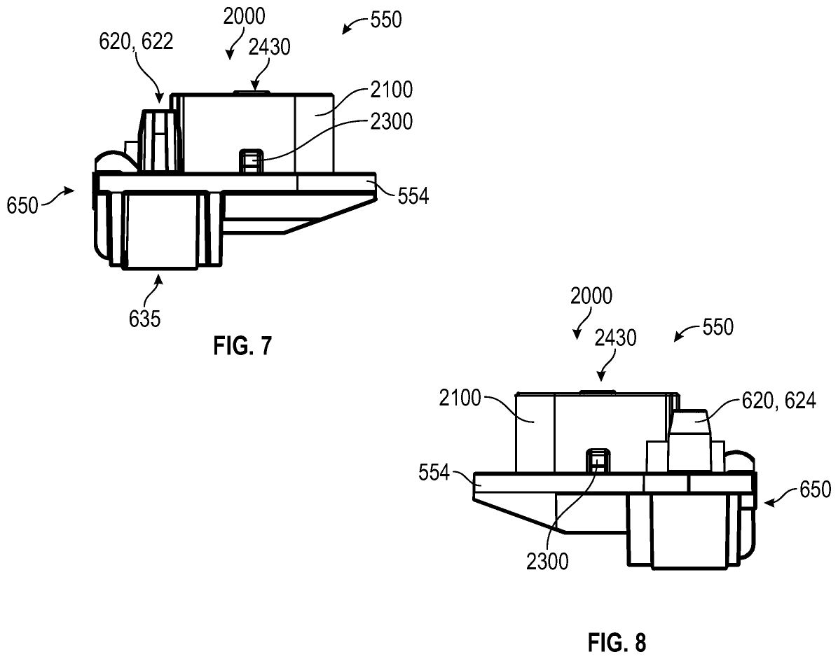

As shown in FIG. 61-70, the terminal ends of the contact arms 1494a-1494h are positioned: (i) within an aperture formed by the U-shaped side wall portions 1492a-1492d, (ii) substantially parallel to the male terminal side wall 1492a-1492d, and (iii) in contact the planar outer surface of the spring arms 1452a-1452h, when the spring member 1440c is inserted into the spring receiver 1486. This configuration is beneficial over the configuration shown in FIGS. 3-8 in PCT/US2018/019787 because the assembler of the male terminal assembly 1430 does not have to apply a significant force in order to deform a majority of the contact arms 1494a-1494h outward to accept the spring member 1440c. This required deformation can best be shown in FIG. 6 of PCT/US2018/019787 due to the slope of the contact arm 11 and the fact the outer surface of the spring arm 31 and the inner surface of the contact arm 11 are adjacent to one another without a gap formed therebetween. In contrast to FIGS. 3-8 in PCT/US2018/019787, FIG. 7 of the present application show a very small gap that is formed between the outer surfaces of the spring member 1440c and the inner surface of the contact arms 1494a-1494h. Accordingly, very little force is required to insert the spring member 1440c into the spring receiver 1486 due to the fact the assembler does not have to force the contact arms 1494a-1494h to significantly deform during the insertion of the spring member 1440c.

The male terminal 1470 is typically formed from a single piece of material (e.g., metal); thus, the male terminal 1470 is a one-piece male terminal 1470 and has integrally formed features. To integrally form these features, the male terminal 1470 is typically formed using a die-cutting process. However, it should be understood that other types of forming the male terminal 1470 may be utilized, such as casting or using an additive manufacturing process (e.g., 3D printing). In other embodiments, the features of the male terminal 1470 may not be formed from a one-piece or be integrally formed, but instead formed from separate pieces that are welded together. In forming the male terminal 1470, it should be understood that any number (e.g., between 1 and 100) of contact arms 1494a-1494h may be formed within the male terminal 1470.

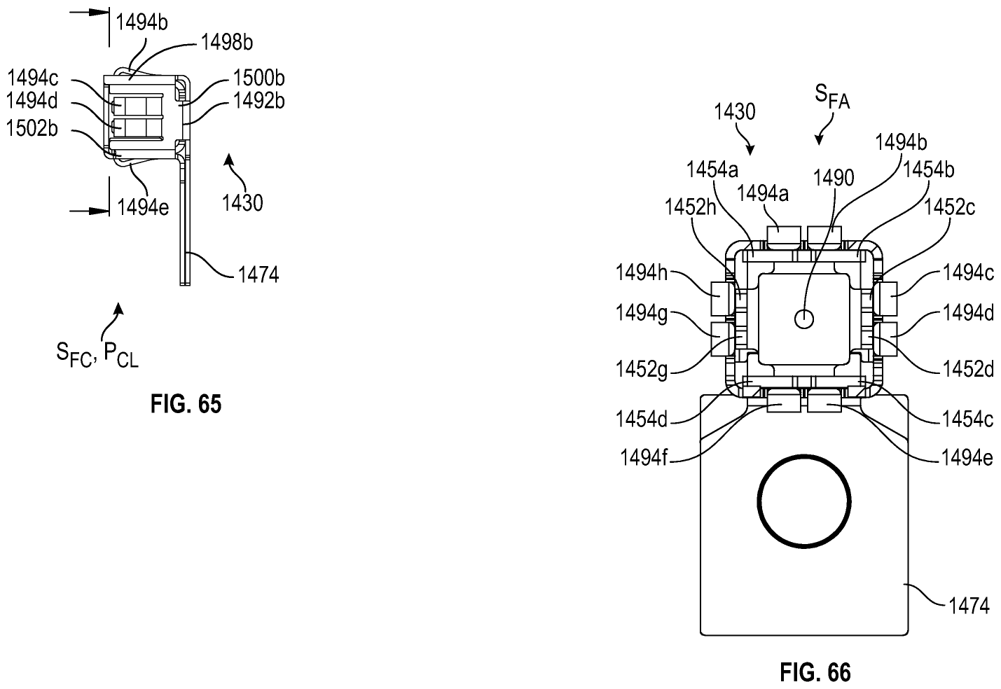

Positioning the internal spring member 1440c within the male terminal assembly 1430 occurs across multiple steps or stages. FIG. 63 provides the first embodiment of the male terminal assembly 1430 in a disassembled state S_{DA}, FIG. 64 provides the first embodiment of the male terminal assembly 1430 in a partially assembled state S_{PA}, and FIG. 65 provides the first embodiment of the male terminal assembly 1430 in a fully assembled state S_{FA}. The first stage of assembling the male terminal assembly 1430 is shown in FIG. 63, where the front male terminal wall 1480 is in an open or flat position P_{O} and the spring member 1440c is separated from the male terminal 1470. In this open position P_{O}, the front male terminal wall 1480 is substantially co-planar with one of the male terminal side wall 1482c. This configuration of the male terminal 1470 exposes the spring receiver 1486 and places the male terminal 1470 in a state that is ready for receiving the spring member 1440c. The second stage of assembling the male terminal assembly 1430 is shown in FIG. 64, where the front male terminal wall 1480 remains in the open or horizontal position P_{O} and the spring member 1440c is positioned within or inserted into the spring receiver 1486. To reach the partially assembled state, an insertion force, F_{I}, has been applied to the spring member 1440c to insert the spring member 1440c into the spring receiver 1486. The insertion force, F_{I}, is applied on the spring member 1440c until the second or rear male terminal wall 1484 is positioned adjacent to the rear spring wall 1444, a free end 1488 of the male terminal 1470 is substantially aligned with a free end 1446 of the spring member 1440c, and a portion of the male terminal side walls 1482a-1482d are positioned adjacent a portion of the spring member side walls 1442a-1442d.

The third stage of assembling the male terminal assembly 1430 is shown in FIG. 65, where: (i) the front male terminal wall 1480 is closed or vertical P_{CL} and (ii) the spring member 1440c is positioned within the spring receiver 1486. To close the front male terminal wall 1480, an upward directed force, Fu, is applied to the male terminal wall 1480 to bend it about its seam to place it adjacent to the side walls 1482a-1482d. After the front male terminal wall 1480 is in the proper position, the top edge is coupled (e.g., welded) to the side wall 1480 of the male terminal body 1472. Here, the closed or vertical P_{CL} of the front male terminal wall 1480 ensures that the spring member 1440c is retained within the male terminal 1470. It should be understood that in other embodiments, the front male terminal wall 1480 may be omitted, may not have a touch proof post opening therethrough, may not extend the entire way from side wall 1482a-1482d (e.g., partially extending from any side wall 1482a-1482d), or may be a separate piece that is coupled to both side walls 1482a-1482d.

a. Terminal Properties and Functionality

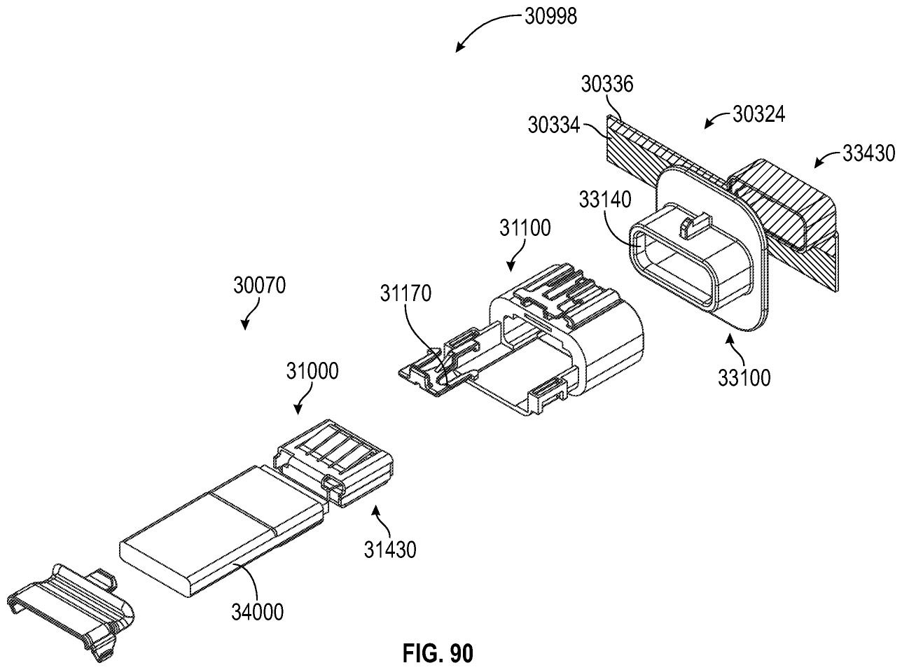

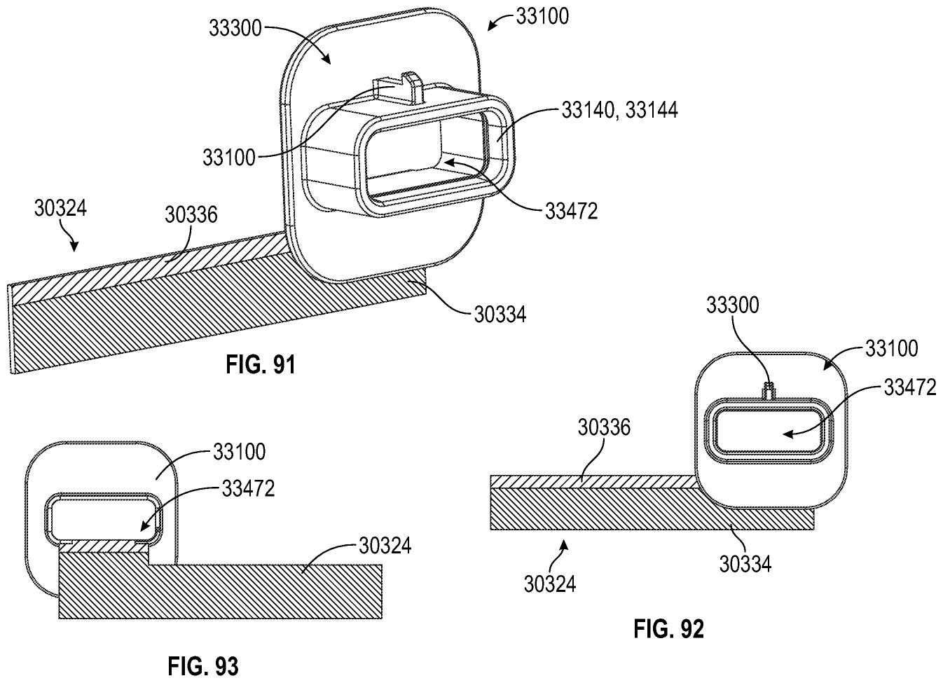

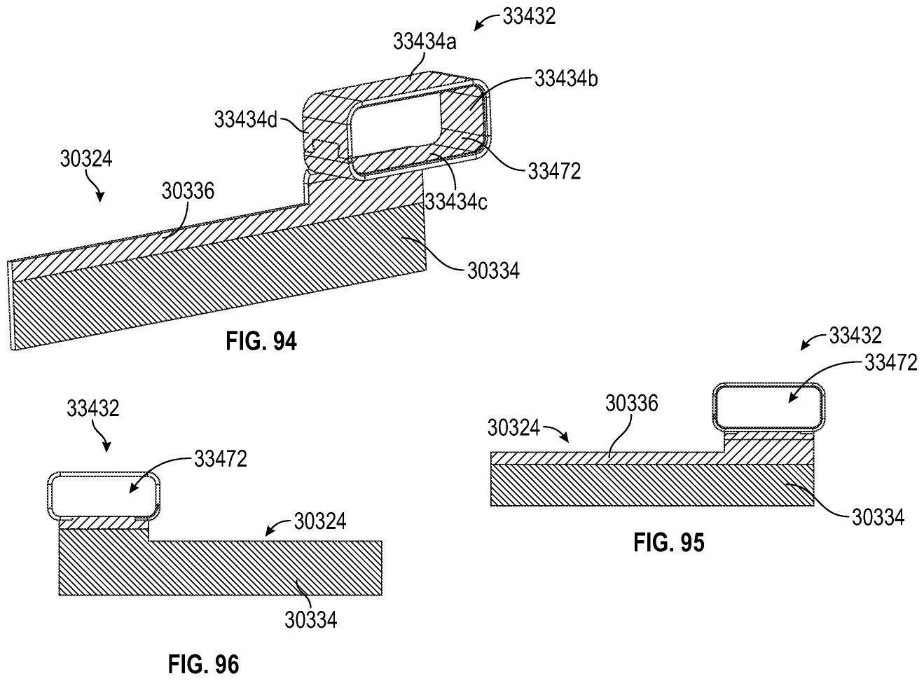

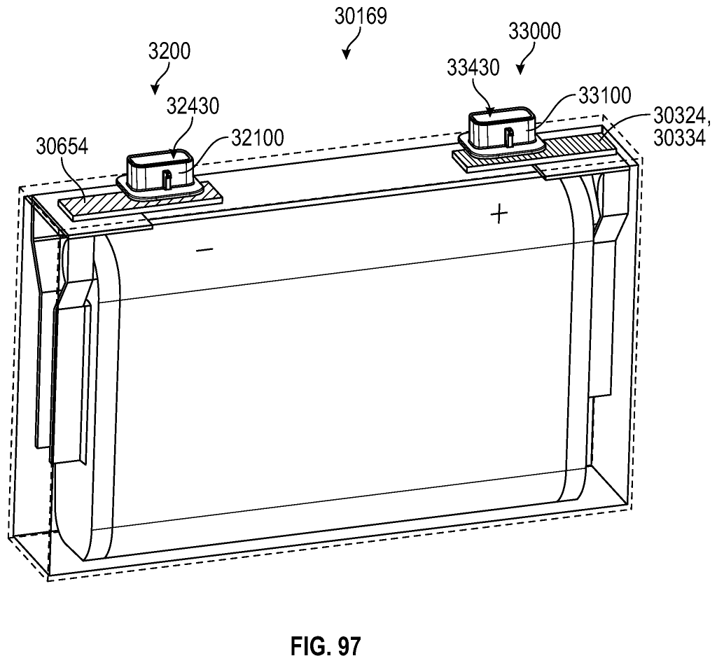

FIG. 74 depicts a cross-section of the boltless male connector assembly 1000 coupled to the female connector assembly 2000 in the fully connected state S_{FC}. While the below disclosed is discussed in connection with an embodiment of the system 998, which includes a negative male terminal assembly 1430 and the negative terminal assembly 2430, it should be understood that this disclosure applies in equal force to other systems, including: (i) a system 998 that includes a positive male terminal assembly 1430 and the positive terminal assembly 3430, and (ii) other embodiments shown in FIGS. 75-98. As best shown in FIG. 74, shown in the one or more outer surfaces of the spring arms 1452a-1452d contact the free ends 1488 of the respective contact arms 1494a-1494d. As discussed above, the outermost extent of the contact arms 1494a-1494d are slightly larger than the inner extent of the female terminal body 2434. As such, when these components are mated with one another, the spring member 1440a is compressed. This compression of the spring member 1440a creates an outwardly directed biasing force S_{BF} against the contact arms 1494a-1494d and away from the interior of the spring member 1440a.

The male terminal body 1472, including the contact arms 1494a-1494d, may be formed from a first material such as copper, a highly-conductive copper alloy (e.g., C151 or C110), aluminum and/or another suitable electrically conductive material. The first material preferably has an electrical conductivity of more than 80% of IACS (International Annealed Copper Standard, i.e., the empirically derived standard value for the electrical conductivity of commercially available copper). For example, C151 typically has 95% of the conductivity of standard, pure copper compliant with IACS. Likewise, C110 has a conductivity of 101% of IACS. In certain operating environments or technical applications, it may be preferable to select C151 because it has anti-corrosive properties desirable for high-stress and/or harsh weather applications. The first material for the male terminal body 1472 is C151 and is reported, per ASTM B747 standard, to have a modulus of elasticity (Young's modulus) of approximately 115-125 gigapascals (GPa) at room temperature and a coefficient of terminal expansion (CTE) of 17.6 ppm/degree Celsius (from 20-300 degrees Celsius) and 17.0 ppm/degree Celsius (from 20-200 degrees Celsius).

The spring member 1440a may be formed from a second material such as spring steel, stainless steel (e.g., 301SS, ¼ hard), and/or another suitable material having greater stiffness (e.g., as measured by Young's modulus) and resilience than the first material of the male terminal body 1472. The second material preferably has an electrical conductivity that is less than the electrical conductivity of the first material. The second material also has a Young's modulus that may be approximately 193 GPa at room temperature and a coefficient of terminal expansion (CTE) of 17.8 ppm/degree Celsius (from 0-315 degrees Celsius) and 16.9 ppm/degree Celsius (from 0-100 degrees Celsius). In contemplated high-voltage applications, the cross-sectional area of copper alloy forming the first connector is balanced with the conductivity of the selected copper alloy. For example, when a copper alloy having lower conductivity is selected, the contact arms 1494a-1494d formed therefrom have a greater cross-sectional area so as to adequately conduct electricity. Likewise, selection of a first material having a higher conductivity may allow for contact arms 1494a-1494d having a relatively smaller cross-sectional area while still meeting conductivity specifications.

In an example embodiment, the CTE of the second material may be greater than the CTE of the first material, i.e., the CTE of the spring member 1440a is greater than the CTE of the male terminal body 1472. Therefore, when the assembly of the male terminal body 1472 and the spring member 1440a is subjected to the high-voltage and high-temperature environment typical for use of the electrical connector described in the present disclosure, the spring member 1440a expands relatively more than the male terminal body 1472. Accordingly, the outward force S_{BF} produced by the spring member 1440a on the contact arms 1494a-1494d of the male terminal body 1472 is increased in accordance with the increased temperature, which is reference to below as a thermal spring force, S_{TF}.

An example application of the present disclosure, such as for use in a vehicle alternator, is suitable for deployment in a class 5 automotive environment, such as that found in passenger and commercial vehicles. Class 5 environments are often found under the hood of a vehicle, e.g., alternator, and present 1500 Celsius ambient temperatures and routinely reach 2000 Celsius. When copper and/or highly conductive copper alloys are subjected to temperatures above approximately 1500 Celsius said alloys become malleable and lose mechanical resilience, i.e., the copper material softens. However, the steel forming the spring member 1440a retains hardness and mechanical properties when subjected to similar conditions. Therefore, when the male terminal body 1472 and spring member 1440a are both subjected to high-temperature, the first material of the male terminal body 1472 softens and the structural integrity of the spring member 1440a, formed from the second material, is retained, such that the force applied to the softened contact arms 1494a-1494d by the spring member 1440a more effectively displaces the softened contact arms 1494a-1494d outward relative the interior of the male terminal body 1472, in the fully connected position S_{FC}.

The male terminal body 1472, spring member 1440a, and female terminal body 2434, are configured to maintain conductive and mechanical engagement while withstanding elevated temperatures and thermal cycling resulting from high-power, high-voltage applications to which the connector assembly is subjected. Further, the male terminal body 1472 and female terminal body 2434 may undergo thermal expansion as a result of the elevated temperatures and thermal cycling resulting from high-voltage, high-temperature applications, which increases the outwardly directed force applied by the male terminal body 1472 on the female terminal body 2434. The configuration of the male terminal body 1472, spring member 1440a, and the female terminal body 2434 increase the outwardly directed connective force therebetween while the connector system 998 withstands thermal expansion resulting from thermal cycling in the connected position P_{C}.

Based on the above exemplary embodiment, the Young's modulus and the CTE of the spring member 1440a is greater than the Young's modulus and the CTE of the male terminal body 1472. Thus, when the male terminal body 1472 is used in a high power application 10 that subjects the connector system 998 to repeated thermal cycling with elevated temperatures (e.g., approximately 1500 Celsius) then: (i) the male terminal body 1472 become malleable and loses some mechanical resilience, i.e., the copper material in the male terminal body 1472 softens and (ii) the spring member 1440a does not become as malleable or lose as much mechanical stiffness in comparison to the male terminal body 1472.

Thus, when utilizing a spring member 1440a that is mechanically cold forced into shape (e.g., utilizing a die forming process) and the spring member 1440a is subjected to elevated temperatures, the spring member 1440a will attempt to at least return to its uncompressed state, which occurs prior to insertion of the male terminals assembly 1430 within the female terminal assembly 2430, and preferably to its original flat state, which occurs prior to the formation of the spring member 1440a. In doing so, the spring member 1440a will apply a generally outward directed thermal spring force, S_{TF}, (as depicted by the arrows labeled “S_{TF}” in FIG. 36) on the free ends 1488 of the contact arms 1494a-1494d. This thermal spring force, S_{TF}, is dependent upon local temperature conditions, including high and/or low temperatures, in the environment where the system 998 is installed. Accordingly, the combination of the spring biasing force, S_{BF}, and the thermal spring force, S_{TF}, provides a resultant biasing force, S_{R}BF, that ensures that the outer surface of the contact arms 1494a-1494d are forced into contact with the inner surface of the female terminal body 2434 when the male terminal assembly 2430 is inserted into the female terminal 2430 and during operation of the system 998 to ensure an electrical and mechanical connection. Additionally, with repeated thermal cycling events, the male terminal assembly 1430 will develop an increase in the outwardly directed resultant spring forces, S_{R}BF, that are applied to the female terminal assembly 2430 during repeated operation of the system 998.

Further illustrated in FIG. 74, in the fully connected state S_{FC}, the male terminal assembly 1430 provides 360° compliance with the female terminal assembly 2430 to ensure that a sufficient amount of outwardly directed force F is applied by the male terminal assembly 1430 to the female terminal assembly 2430 for electrical and mechanical connectivity in all four primarily directions. This attribute allows for omission of a keying feature and/or another feature designed to ensure a desired orientation of the components during connection. The 360° compliance attribute of the system 998 also aids in maintaining mechanical and electrical connection under strenuous mechanical conditions, e.g., vibration. In a traditional blade or fork-shaped connector with 180° compliance, i.e., connection on only two opposing sides, vibration may develop a harmonic resonance that causes the 180° compliant connector to oscillate with greater amplitude at specific frequencies. For example, subjecting a fork-shaped connector to harmonic resonance may cause the fork-shaped connector to open. Opening of the fork-shaped connector during electrical conduction is undesirable because momentary mechanical separation of the fork-shaped connector from an associated terminal may result in electrical arcing. Arcing may have significant negative effects on the 180° compliant terminal as well as the entire electrical system of which the 180° compliant terminal is a component. However, the 360° compliance feature of the present disclosure may prevent the possible catastrophic failures caused by strong vibration and electrical arcing.

As described above, it is desirable to form the male terminal 1470 from the same material as the female terminal body 2432 in order to: (i) help prevent corrosion and other degradation, (ii) reduce resistance between these structures, and (iii) facilitate the electrical and mechanical coupling of said structures. As such, the male and female terminal bodies 1472, 2432 are formed from copper in this exemplary embodiment. However, in order to utilize matching materials for the terminal bodies 1470, 2432 and avoid utilizing a bimetallic positive busbar 320, it should be understood that the bimetallic positive busbar 320 may be replaced with an aluminum busbar and the male terminal 1470 may also be made from aluminum. In this embodiment, the male terminal 1470 associated with the negative external connection 150 may be formed from copper, the exterior busbar 520 may be formed from copper, the positive busbar 320 may be formed from aluminum, and the male terminal 1470 associated with the positive external connection 140 may be formed from aluminum. In further embodiments, the battery cells 170 may have different terminal 178, 182 configurations wherein the materials of the transport structure 200 may only utilize busbars made from a single material and the male terminal bodies 1470 can be made from this same material.

### VI. Battery Pack

FIGS. 71-72 show: (i) the male connector assembly 1000, shown in FIGS. 60-70, (ii) the fully assembled transport structure 200, shown in FIGS. 55-59, and (iii) battery cells 170 coupled to the negative cell stack 208 of the fully assembled transport structure 200, while the battery cell 170 that were coupled to the positive cell stack 204 were removed to enabled viewability of the transfer assembly 200. Said transfer assembly 200 and the battery cells 170 are installed and secured in the battery module housing 110 to form the battery module 100. Once the manufacturing of the battery modules 100 is complete, the said battery modules 100 are installed in the battery pack 80 and coupled to one another. The electrical coupling of the battery packs 80 to one another does not utilize bolts and therefor utilizes a boltless connector systems 998.

FIG. 75 shows an exemplary battery pack 80 that includes nine battery modules 100. Three of the nine battery modules 100 are coupled to one another in parallel to form a first battery group 90 and six of the nine battery modules 100 are also coupled to one another in parallel to form a second battery group 92. In this exemplary embodiment, the following boltless connections are made to form the first battery group 90: (i) a negative external connection 150 of a first battery module 100 is coupled to a battery management assembly 94, (ii) a positive external connection 140 of the first battery module 100 is coupled to a negative external connection 150 of a second battery module 100, (ii) a positive external connection 140 of the second battery module 100 is coupled to a negative external connection 150 of a third battery module 100, and (iii) a positive external connection 140 of the third battery module 100 is coupled to the battery management assembly 94. Coupling these external connections 140, 150 to one another is: (i) boltless, (ii) PCT compliant, (iii) 360° compliant, (vi) is fast and efficient compared to conventional battery pack connectors, (vii) does not require special tools or machines, (viii) meets USCAR and other industry specifications, (ix) is lighter weight than conventional battery pack connectors, and (x) other benefits that are obvious to one of skill in the art.

Once the first and second battery groups 90, 92 are coupled to the battery management assembly 94, which manages charging, discharging, cooling, and other aspects of the battery pack 80, the assembly of the battery pack 80 may be complete and can be installed in an application 10. As discussed above, these applications 10 include, but are not limited to, a vehicle 20 (FIG. 84), a bus 25 (FIG. 85), a locomotive, a tractor, a boat, a submarine, large ship 30 (FIG. 86), ship 35 (FIG. 87), tanker, sailing yacht, telecommunications hardware, a power storage system, and/or renewable energy hardware. It should be understood that in other embodiments, there may be only one battery group 90 or there may be over fifty battery groups and each battery group may have: (i) any number of battery modules 100 and thus any number of batter cells 170, (ii) any arrangement of the series/parallel connections, (iii) the number of battery modules 100 in each group may be the same or may be different, (iv) the number of battery cells 170 within each module 100 may vary, and/or (v) any other design or configuration that may be desired.

### VII. Second Embodiment

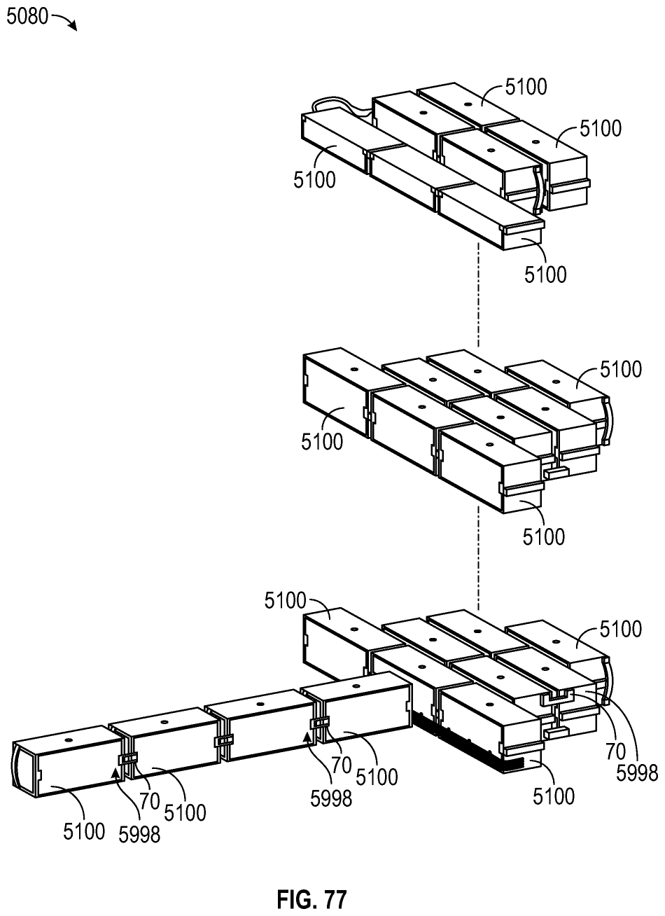

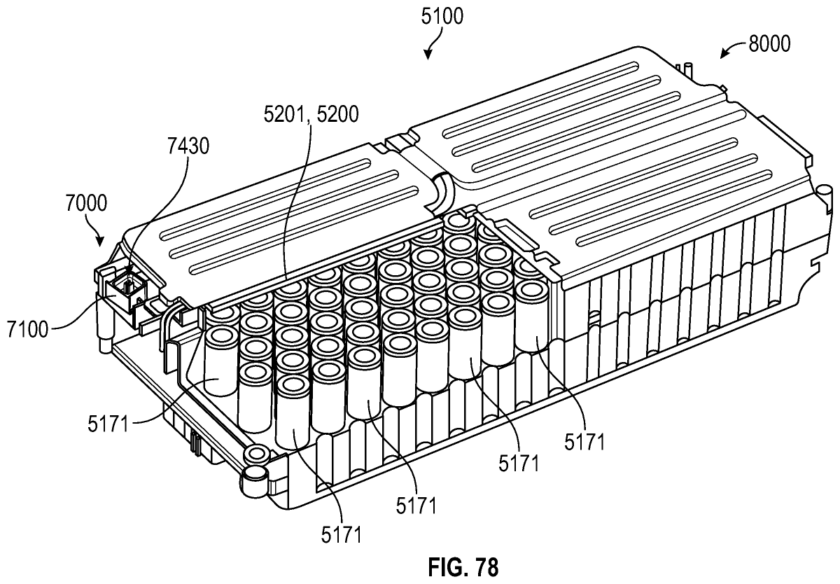

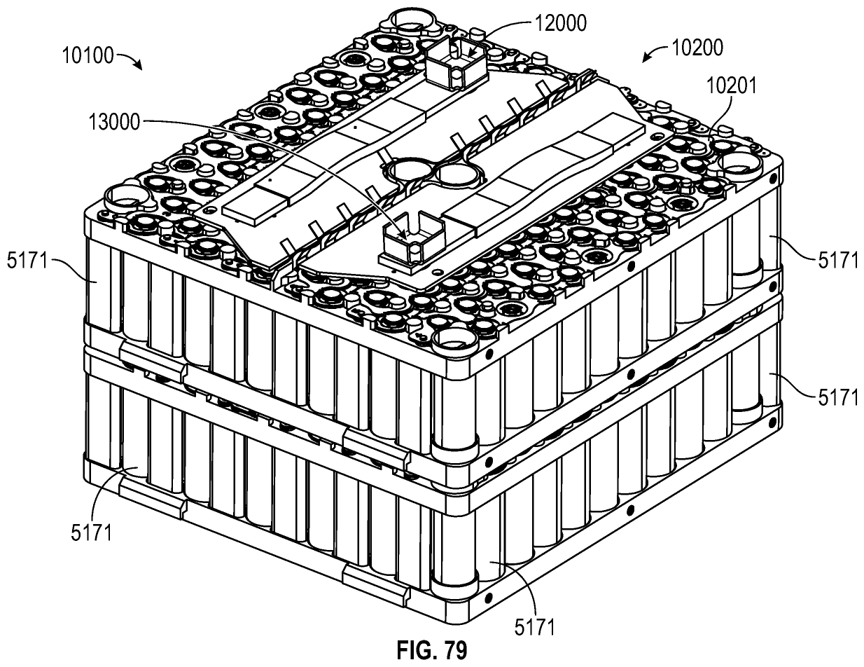

FIGS. 76-78 a second embodiment of a battery pack 5080 having a plurality of boltless connector systems 5998 that couple the battery cells 5171 contained in a battery modules 5100 of FIG. 78 to each other using a plurality of boltless busbar assemblies 70. For sake of brevity, the above disclosure in connection with battery pack 80 will not be repeated below, but it should be understood that across embodiments like numbers represent like structures. For example, the disclosure relating to female connector assemblies 2000, 3000 applies in equal force to female connector assemblies 7000, 8000. While the battery pack 5080 has a different configuration with twenty-seven battery modules 5100 in comparison to the first embodiment of the battery pack 80, it should be understood that one of the important differences between these embodiments is the transport assembly 200 is replaced with a transport structure 5200 having a conductive current collector 5201 that: (i) overlays the batter cells 5171 and is welded thereto, and (ii) is coupled to the female terminal assemblies 7000, 8000. In particular, the transport structure 200 is altered for this second embodiment because the shape of the battery cell 5171 (e.g., cylindrical and do not have a pouch configuration (see FIGS. 1-72)) and configuration of the terminals 5178, 5182 (e.g., tabs and do not have a blade configuration (see FIGS. 71-72)). It should be understood that other structural configurations of the battery module 5100, transport assembly 5200, and the current collector 5201 are contemplated by this disclosure. For example, FIG. 79 shown an alternative embodiment of the battery module 10100 that may be used in battery pack 5080 instead of the battery modules 5100 shown in FIGS. 77 and 78.

### VIII. Third Embodiment

FIGS. 80-81 a third embodiment of a battery pack 15080 having a plurality of boltless connector systems 15998 that couple the battery cells 5171 contained in a battery modules 15100 of FIG. 80 to each other using a plurality of boltless busbar assemblies 70. For sake of brevity, the above disclosure in connection with battery pack 80 or battery pack 5080 will not be repeated below, but it should be understood that across embodiments like numbers represent like structures. For example, the disclosure relating to female connector assemblies 2000, 3000 applies in equal force to female connector assemblies 12000, 13000.

While the battery pack 15080 has a different configuration with fourteen battery modules 15100 in comparison to the first embodiment of the battery pack 80 or the second embodiment of the battery pack 5080, it should be understood that one of the important differences between these embodiments is the transport structure 200 is replaced with a transport assembly 15200 with a conductive current collector 15201 that: (i) overlays the batter cells 15172 and is welded thereto, and (ii) is coupled to the female terminal assemblies 12000, 13000. In particular, the transport structure 200 is altered for this third embodiment because the shape of the battery cell 15172 (e.g., prismatic and do not have a pouch configuration (see FIGS. 1-72) or a cylindrical configuration (see FIGS. 76-79)) and configuration of the terminals 15178, 15182 (e.g., tabs and do not have a blade configuration (see FIGS. 71-72)). It should be understood that other structural configurations of the battery module 15100, transfer assembly 15200, and the current collector 15201 are contemplated by this disclosure.

### IX. Alternative Embodiment of the Battery Cell

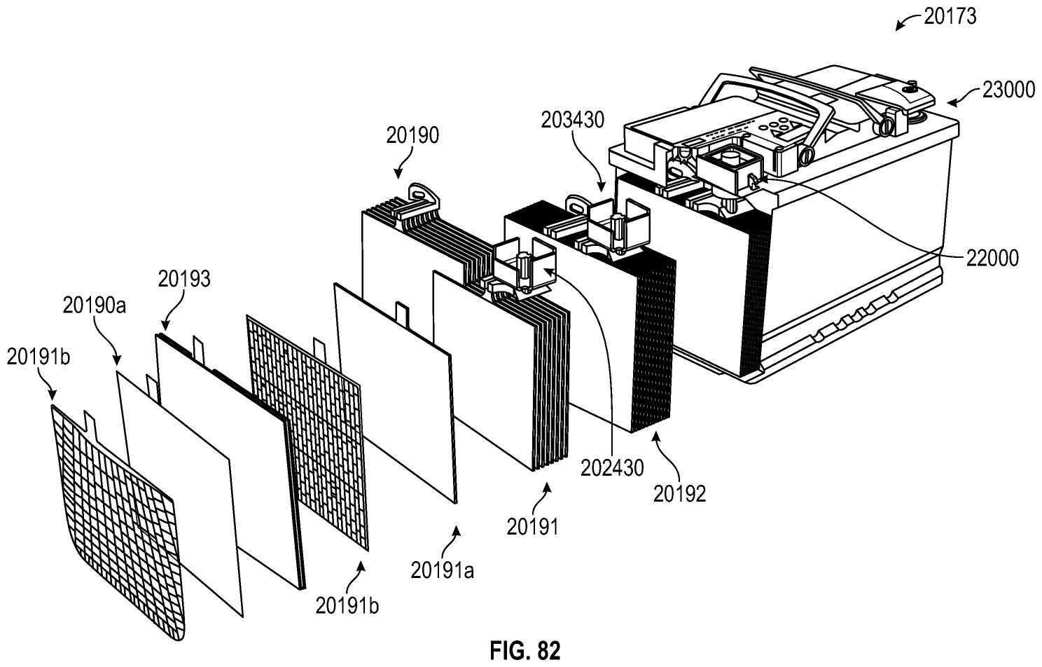

FIG. 82 shows an alternative embodiment of the battery cell 20173, wherein the boltless female connector assemblies 22000, 23000 are coupled to the individual battery cell instead of only utilizing the boltless connectors at the battery pack level. In particular, FIG. 82 shows an exploded view of a lead-acid battery cell 20173, wherein the cell 20173 includes: (i) a positive plate set 20190 having a positive plate 20190a and a positive grid 20190b, (ii) a negative plate set 20191 having a negative plate 20191a and a negative grid 20191b, (iii) a plate block 20192, and (iv) fleece separators that are positioned between the plates 20190a, 20191a. Based on this embodiment, it should be understood that utilizing of the boltless connector assemblies 2000, 3000 or 22000, 23000 may be used at the battery pack level or the battery cell level and can be used various battery cell technologies/materials, including: (i) NiCd, (ii) NiMH, (iii) NaNiCl, (iv) Li-Polymer, (v) Li-Ion, or (vi) batteries that utilize other materials (e.g., LiO₂, AlO₂, LiS, LTO, LFP, NMC, NCA).

### X. Second Embodiment of the Connector System

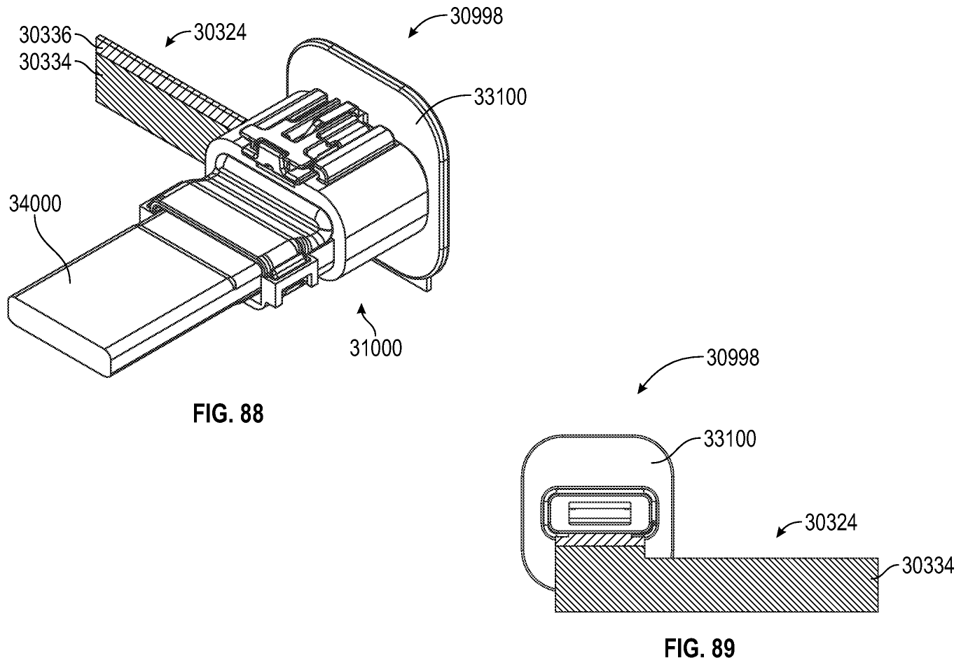

FIGS. 88-98 show a second embodiment of a boltless connector system 30998, which is similar to the first embodiment of the boltless connector system 998. As such, the above disclosure for these similar structures, functions, and/or operation will not be repeated in connection with this second embodiment. However, it should be understood that across embodiments like numbers represent like structures. For example, the disclosure relating to female housing 2100, 3100 of the first embodiment applies in equal force to female housing 33100 of this second embodiment. Additionally, like the busbar 320 that was coupled to the positive female connector assembly 3000, the busbar 30320 that is coupled to and integrally formed with the female connector assembly 33000 is bimetallic. In particular, a portion 30334 of the battery cell interface 30324 is formed from a first material (e.g., aluminum) and a second portion 30336 of the battery cell interface 30324 is formed from a second material (e.g., copper). This bimetallic configuration may be formed using any of the methods that are disclosed above and is beneficial because it can be integrated into a battery cell 30169 or battery module 30100: (i) without altering/affecting the functionality of the battery cell or battery module that it is integrated within, and (ii) requiring additional changes be made to the battery cells 30169. Other similarities between this second embodiment of the boltless connector system 30998 and the first embodiment of the boltless connector system 998 can be identified by comparing said systems 998, 30998.

At a high level and like the first embodiment of the boltless connector system 998, the second embodiment of the boltless connector system 30998 includes: (i) a female connector assembly 33000 having a female housing 33100 and a female terminal assembly 33430, and (ii) a male connector assembly 31000 having a male housing 31100 and a male terminal assembly 31430. The female housing 32100 receives a substantial extent of the female terminal assembly 32430 and facilitates the coupling of the female terminal assembly 32430 with the male terminal assembly 31430 using the above described male terminal compression means 32140. The female terminal assembly 33430 includes a female terminal body 33432 having a plurality of sidewalls 33434a-33434d that form a terminal receptacle 33472. Wherein the terminal receptacle 33472 is configured and dimensioned to receive a majority of the male terminal assembly 31430 in a fully connected state. Said male terminal assembly 31430 includes a male terminal body 31470 and an internal spring member 31440c, wherein the interplay of said body 31470 and spring member 31440c are described above. Finally, a housing 31100 surrounds the male terminal assembly 31430 and includes a CPA 31160, 31170 to help retain the connection between the female and male connector assemblies 33000, 31000.

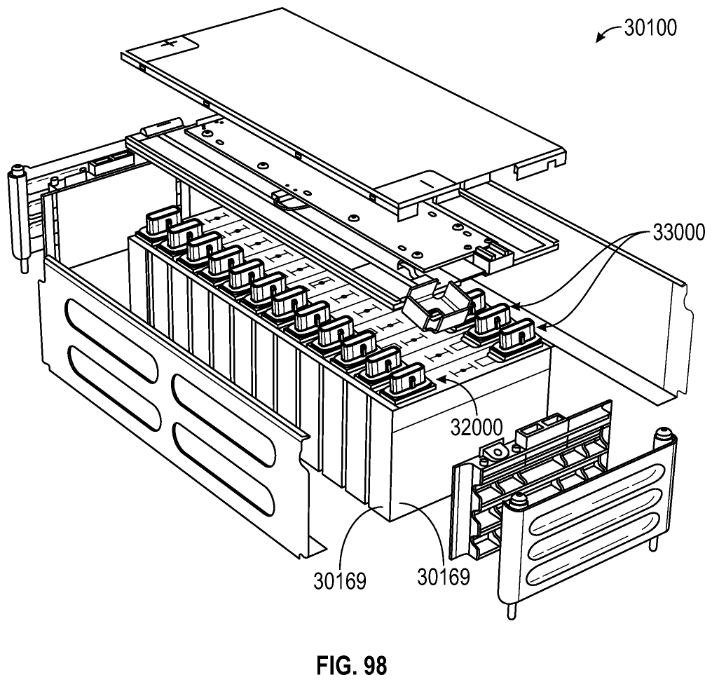

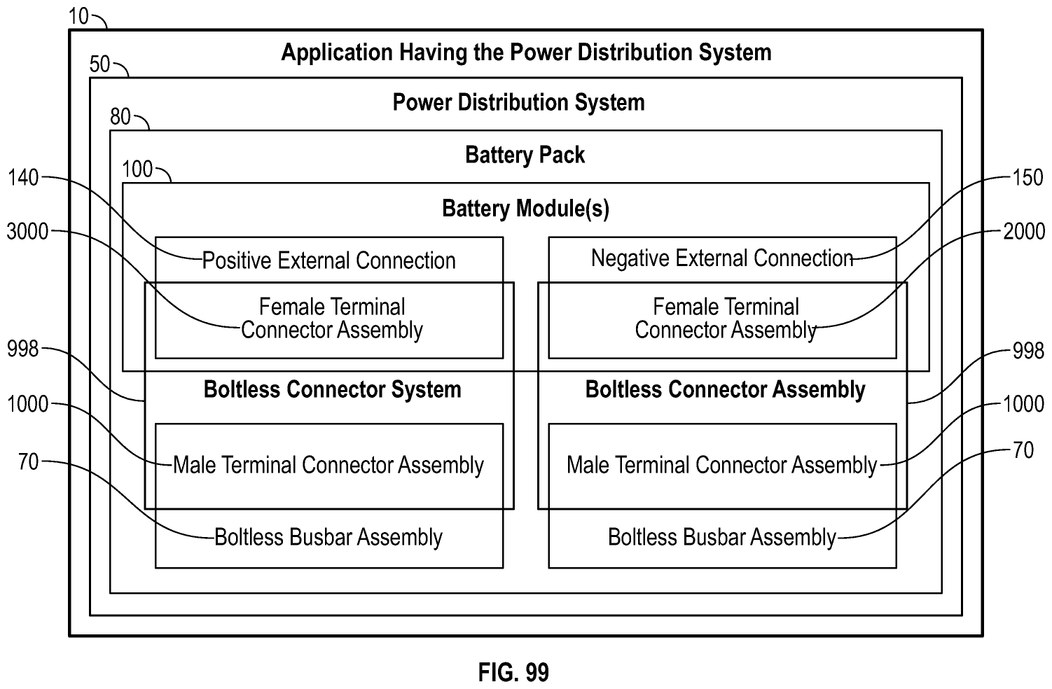

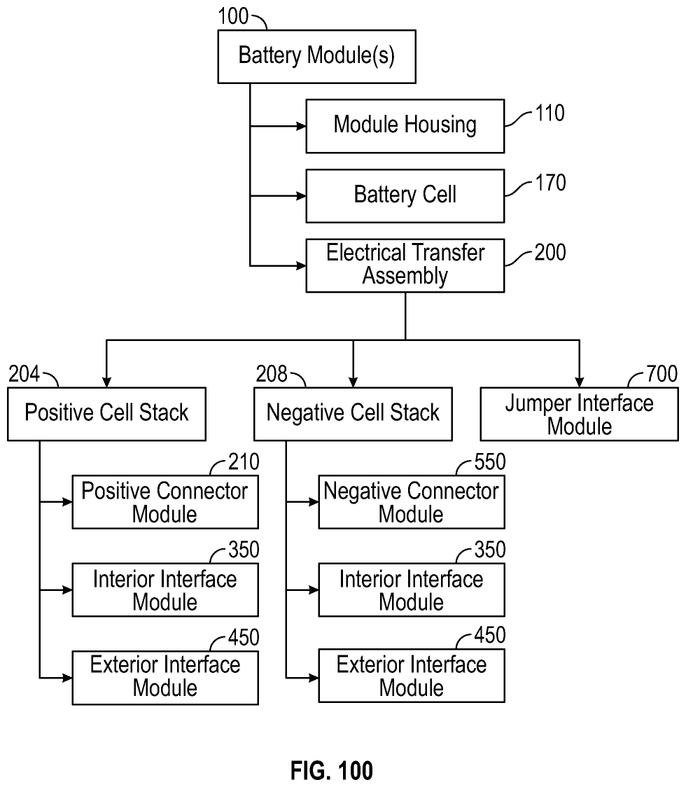

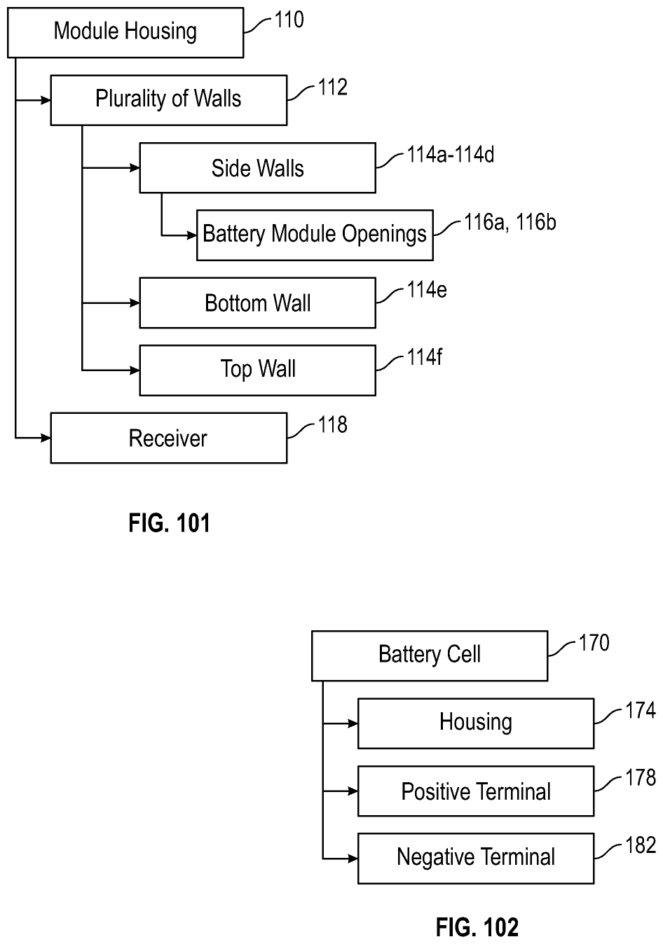

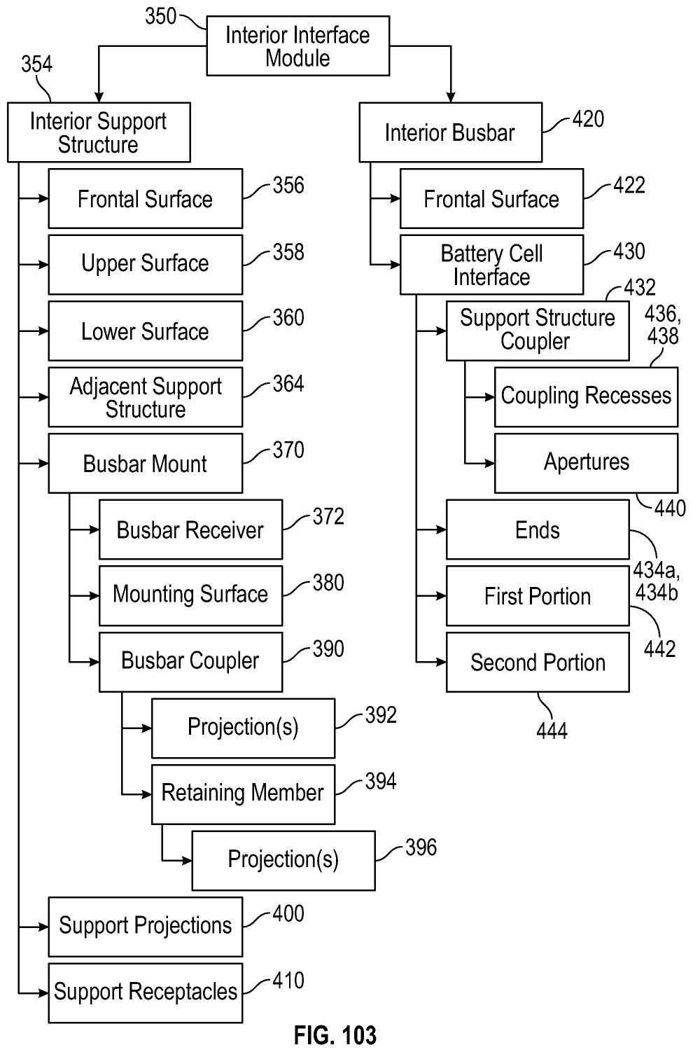

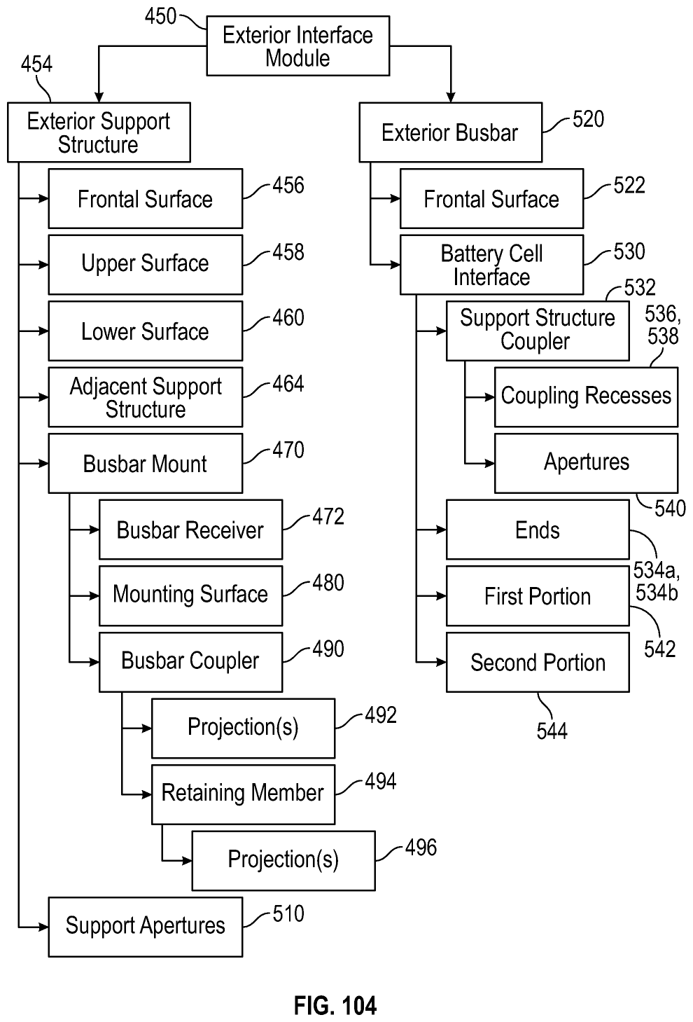

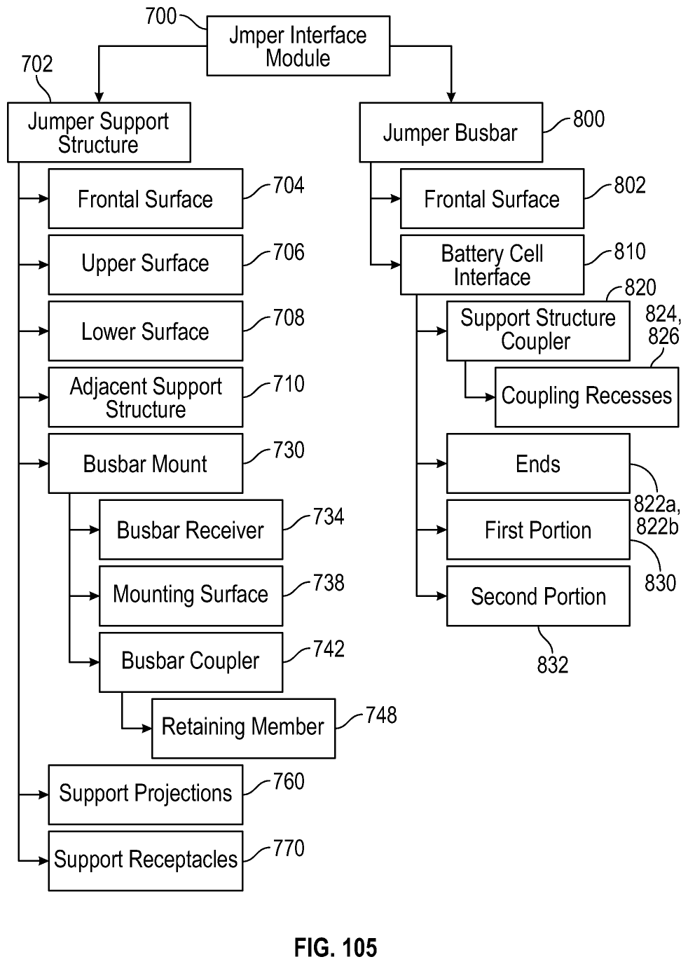

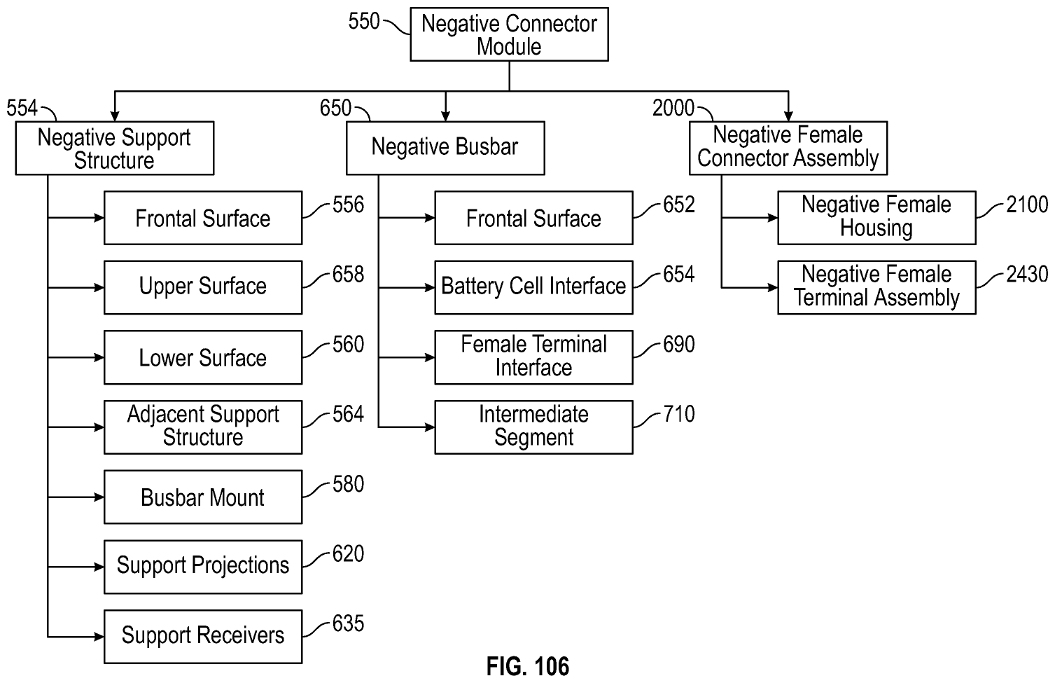

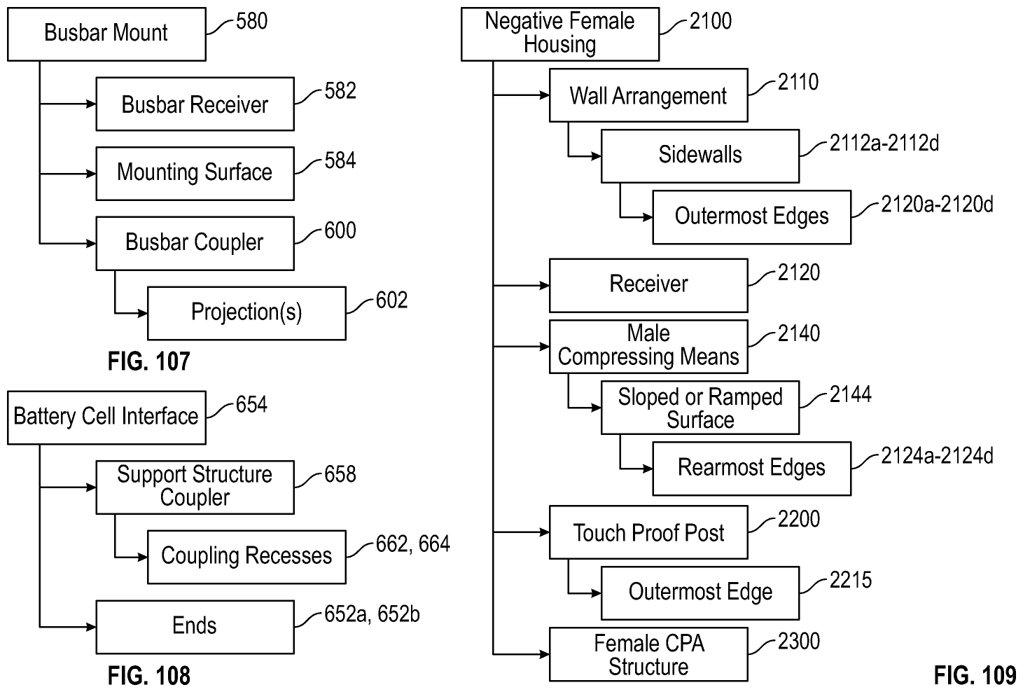

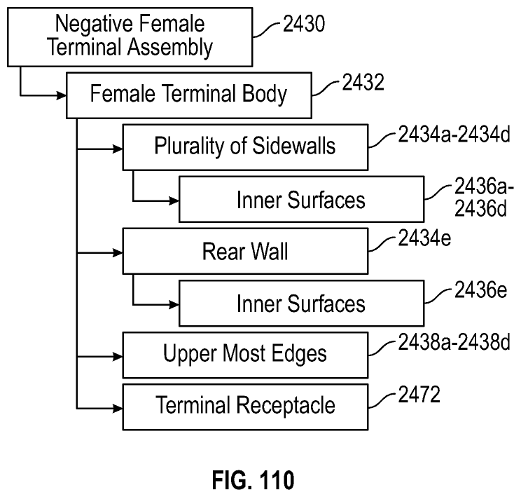

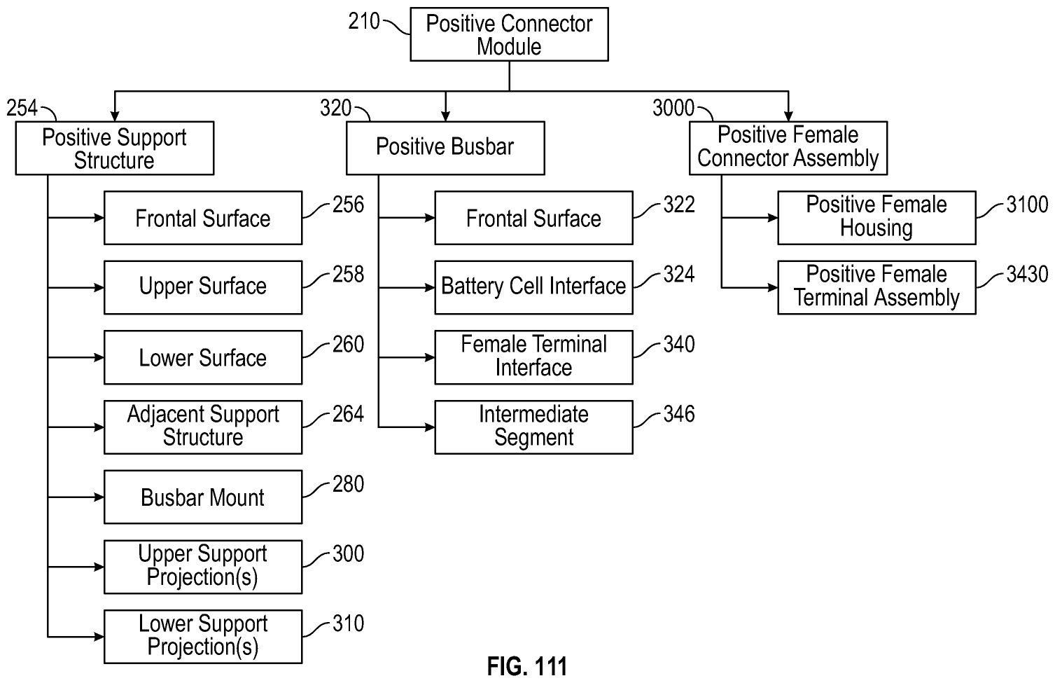

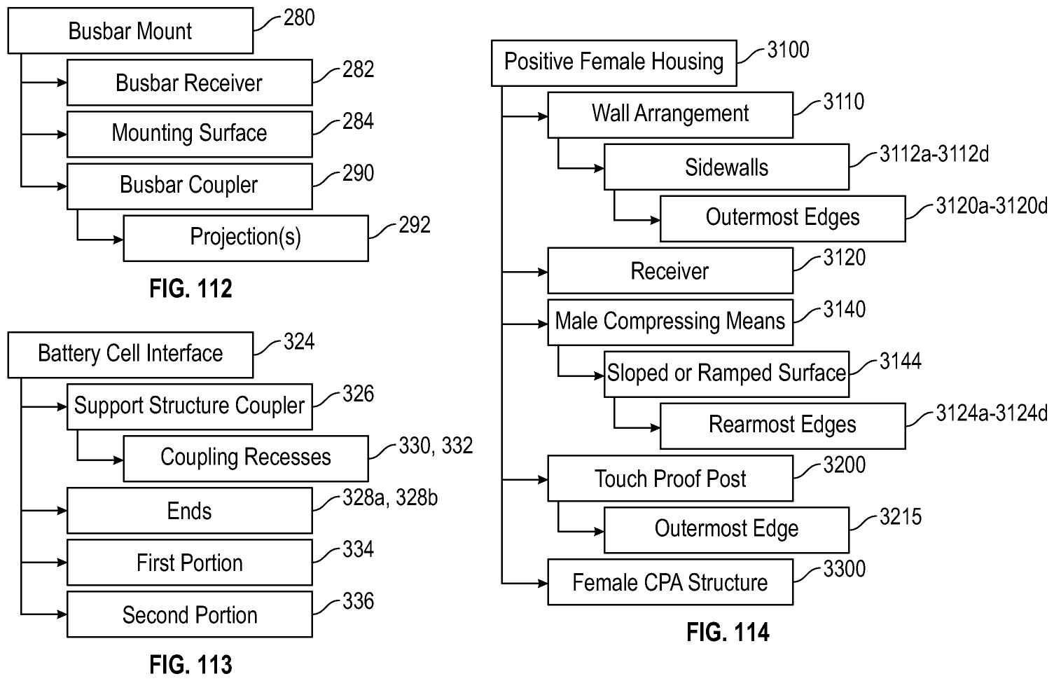

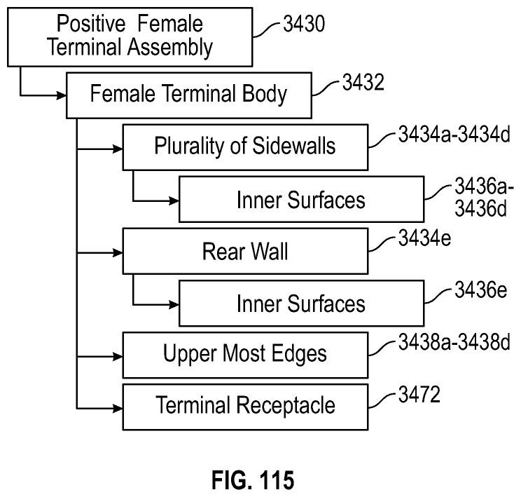

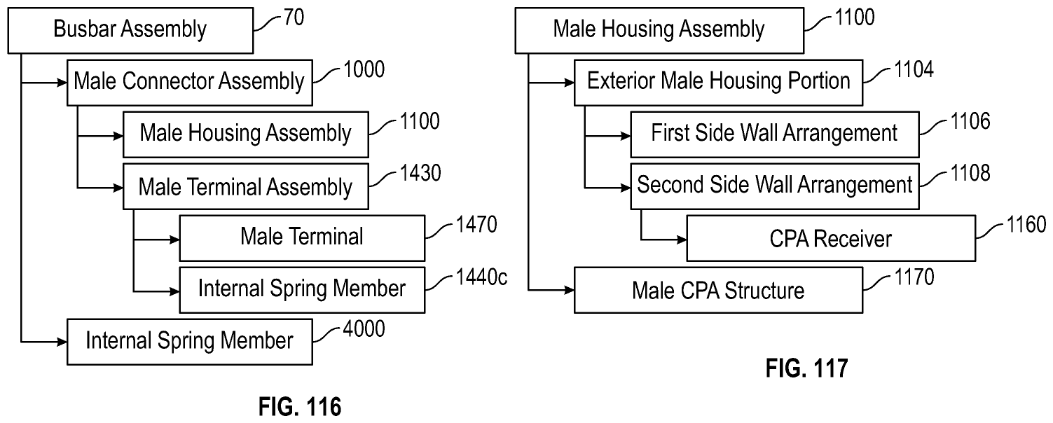

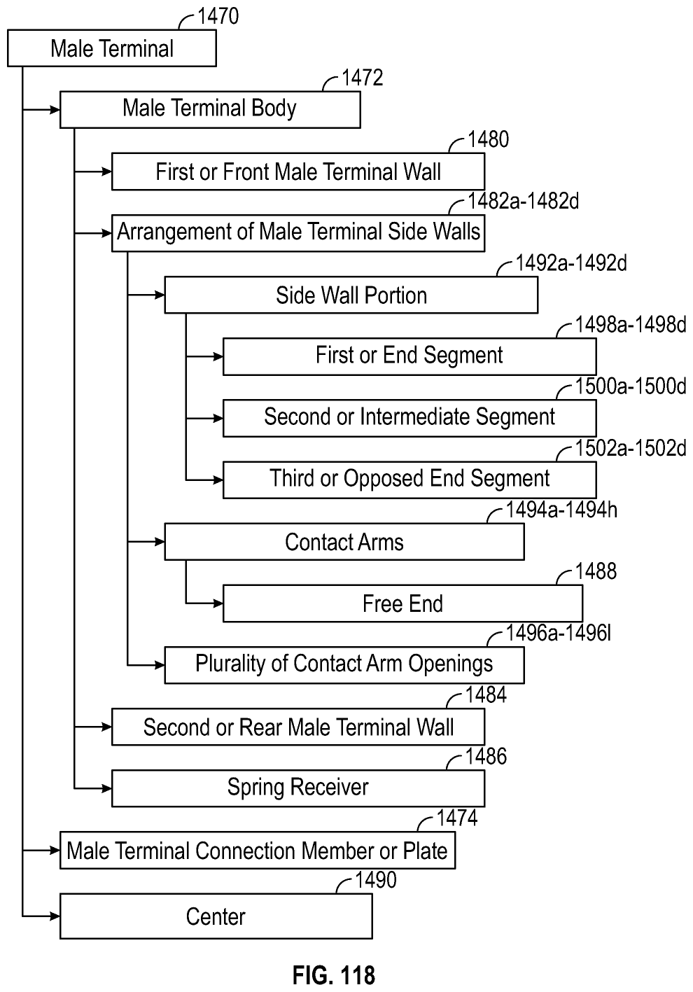

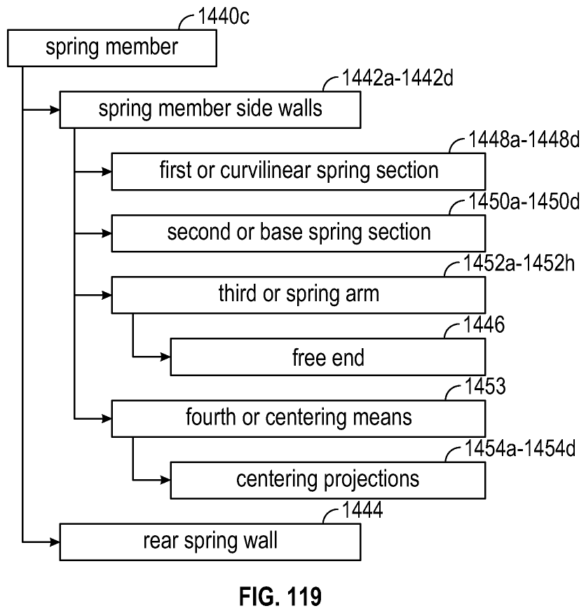

The primary difference between this second embodiment of the boltless connector system 30998 and the first embodiment of the boltless connector system 998, include: (i) the connector system 30998 is integrated into a battery cell 30169 with positive terminal 33000 and a negative terminal 32000, whereas the connector system 998 is integrated into at the battery module 100 level, (ii) shape of the male and female terminal assemblies, wherein the first embodiment is substantially cuboidal and the second embodiment is a rectangular prism, (iii) the second is not 360° compliant, as two of the sides of the second embodiment do not include contact arms 31496a-31496h, (iv) the sidewalls 33434a-33434d are integrally formed with the battery cell interface 30324 and are not coupled thereto using a welding process, and (v) other differences may be identified by comparing said systems 998, 30998. Integrating the connector system 30998 at the battery cell 30169 level eases assembly of the modules 30100 and increases serviceability because the cells can simplify be unplugged from a current collector and remove of the battery cell does not require that the weldment between the current collector and the cells be broke. While the connector system 30998 is integrated into application 10 at the battery cell level, it should be understood that additional connector systems may be utilized at the module level, pack level, and power distribution level. For example, FIG. 98 shows two systems 998 being utilized on the module level. Additional benefits may be obvious to one skill in the art based on the figures and disclosure contained herein.

The boltless connector systems 998 is T4/V4/D2/M2, wherein the system 998 meets and exceeds: (i) T4 is exposure of the system 998 to 150° C., (ii) V4 is severe vibration, (iii) D2 is 200 k mile durability, and (iv) M2 is less than 45 Newtons of force is required to connect the male terminal assembly 1430 to the female terminal assembly 2430, 3430. In other embodiments, the boltless connector systems 998 may be T4/V4/S3/D2/M2, wherein the system 998 also meets and exceeds the S3 sealed high-pressure spray. In addition to being T4/V4/S3/D2/M2 compliant, 360° compliant, boltless, and PCT compliant, the system 998 may also be scanable and therefor may be PCTS compliant (see PCT/US2020/049870).

The spring member 1440c disclosed herein may be replaced with the spring members shown in PCT/US2019/36010 or U.S. Provisional 63/058,061. Further, it should be understood that alternative configurations for connector assembles 1000 are possible. For example, any number of male terminal assemblies 1430 (e.g., between 2-30, preferably between 2-8, and most preferably between 2-4) may be positioned within a housing 1100 and any number of female terminal assemblies 2430, 3430 (e.g., between 2-30, preferably between 2-8, and most preferably between 2-4) may be positioned within a housing 2100, 3100. Additionally, alternative configurations for connector systems 998 are possible. For example, the female connector assembly 2000, 3000 may be reconfigured to accept these multiple male terminal assemblies 1430 into a single female terminal assembly 2430.

It should also be understood that the male terminal assemblies may have any number of contact arms 1494 (e.g., between 2-100, preferably between 2-50, and most preferably between 2-8) and any number of spring arms 1452 (e.g., between 2-100, preferably between 2-50, and most preferably between 2-8). As discussed above, the number of contact arms 1494 may not equal the number of spring arms. For example, there may be more contact arms 1494 then spring arms 1452, 5452. Alternatively, there may be less contact arms 1494 then spring arms 1452.

### Materials and Disclosure that are Incorporated by Reference

PCT Application Nos. PCT/US2021/047180, PCT/US202/1043788, PCT/US2021/043686, PCT/US2021/033446, PCT/US2020/050018, PCT/US2020/049870, PCT/US2020/014484, PCT/US2020/013757, PCT/US2019/036127, PCT/US2019/036070, PCT/US2019/036010, and PCT/US2018/019787, U.S. patent application Ser. No. 16/194,891 and U.S. Provisional Applications 62/681,973, 62/792,881, 62/795,015, 62/897,658 62/897,962, 62/988,972, 63/051,639, 63/058,061, 63/068,622, 63/109,135, 63/159,689, 63/222,859, each of which is fully incorporated herein by reference and made a part hereof.

SAE Specifications, including: J1742_201003 entitled, “Connections for High Voltage On-Board Vehicle Electrical Wiring Harnesses—Test Methods and General Performance Requirements,” last revised in March 2010, each of which is fully incorporated herein by reference and made a part hereof.

ASTM Specifications, including: (i) D4935-18, entitled “Standard Test Method for Measuring the Electromagnetic Shielding Effectiveness of Planar Materials,” and (ii) ASTM D257, entitled “Standard Test Methods for DC Resistance or Conductance of Insulating Materials,” each of which are fully incorporated herein by reference and made a part hereof.

American National Standards Institute and/or EOS/ESD Association, Inc Specifications, including: ANSI/ESD STM11.11 Surface Resistance Measurements of Static Dissipative Planar Materials, each of which is fully incorporated herein by reference and made a part hereof.

DIN Specification, including Connectors for electronic equipment—Tests and measurements—Part 5-2: Current-carrying capacity tests; Test 5b: Current-temperature derating (IEC 60512-5-2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

Other standards, including Federal Test Standard 101C and 4046, each of which is fully incorporated herein by reference and made a part hereof. While some implementations have been illustrated and described, numerous modifications come to mind without significantly departing from the spirit of the disclosure; and the scope of protection is only limited by the scope of the accompanying claims. For example, the overall shape of the of the components described above may be changed to: a triangular prism, a pentagonal prism, a hexagonal prism, octagonal prism, sphere, a cone, a tetrahedron, a cuboid, a dodecahedron, an icosahedron, an octahedron, a ellipsoid, or any other similar shape.

It should be understood that the following terms used herein shall generally mean the following:
a. “High power” shall mean (i) voltage between 20 volts to 600 volts regardless of current or (ii) at any current greater than or equal to 80 amps regardless of voltage.
b. “High current” shall mean current greater than or equal to 80 amps regardless of voltage.
c. “High voltage” shall mean a voltage between 20 volts to 600 volts regardless of current.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. A battery pack for use in a power management system of a motor vehicle, the battery pack comprising:
a first battery module having:
(i) a battery module housing;
(ii) a battery cell positioned within the battery module housing;
(iii) a female terminal housing associated with the battery module housing, wherein at least an extent of female terminal housing is positioned outside of the battery module housing;
(iv) a female terminal assembly configured to receive a male terminal assembly, wherein the female terminal assembly is positioned within the female terminal housing but not enclosed by the battery module housing; and
(v) an electrical transfer assembly positioned within the battery module housing, the electrical transfer assembly having a busbar electrically coupled to both the female terminal assembly and the battery cell, wherein electrical current flows between the battery cell, the busbar, and the female terminal assembly during operation of the first battery module.

2. The battery pack of claim 1, further comprising a male terminal assembly, and wherein the female terminal housing includes a male terminal compression means configured to compress an extent of the male terminal assembly during its connection to the female terminal housing.

3. The battery pack of claim 2, wherein the male terminal compression means of the female terminal housing extends rearward from an outermost edge of said female terminal housing.

4. The battery pack of claim 2, wherein the male terminal compression means of the female terminal housing is a sloped wall with: (a) a rearmost edge that is positioned adjacent to an uppermost edge of the female terminal assembly and (b) an inner surface that is angled with respect to an outer surface of the female terminal housing.

5. The battery pack of claim 1, further comprising a male terminal assembly, and wherein the male terminal assembly and the female terminal assembly cooperatively interact to provide tactical feedback to a user that informs the user that the male terminal assembly is positioned in the female terminal assembly.

6. The battery pack of claim 1, further comprising an elongated touch-proof element positioned in a female receiver formed by the female terminal assembly.

7. The battery pack of claim 1, further comprising a male terminal assembly, and wherein when the female terminal assembly receives the male terminal assembly, the male terminal assembly applies an outwardly directed force on each side of the female terminal assembly.

8. The battery pack of claim 1, further comprising a male terminal assembly, and wherein inserting an extent of the male terminal assembly into an extent of the female terminal assembly requires less than 45 Newtons.

9. The battery pack of claim 1, further comprising a male terminal assembly, and wherein inserting an extent of the male terminal assembly into an extent of the female terminal assembly does not require a lever assist.

10. The battery pack of claim 2, wherein the male terminal assembly includes a male terminal body with a rear wall and an arrangement of side walls defining a receiver with an opening, wherein at least one side wall within the arrangement of side walls includes:
a first contact arm opening formed through the side wall;
an intermediate segment positioned between the first contact arm opening and the rear wall of the male terminal body;
an end segment extending (i) from the intermediate segment, and (ii) along the first contact arm opening; and
a first deformable contact arm extending (i) at an outward angle from the intermediate segment, (ii) along an extent of the first contact arm opening, and (iii) towards a front extent of the male terminal body.

11. The battery pack of claim 10, wherein when electrical current is applied to the male terminal body, electrical current is not required to flow through the end segment to reach the first deformable contact arm.

12. The battery pack of claim 2, wherein the male terminal assembly includes: (i) a male terminal body having a receiver and a first contact arm and (ii) an internal spring member dimensioned to reside within the receiver of the male terminal assembly and having a first spring arm; and
wherein the female terminal assembly has a receptacle dimensioned to receive a portion of both the male terminal assembly and the internal spring member residing within the receiver of the male terminal assembly to define a connected position.

13. The battery pack of claim 12, wherein the first spring arm is configured to provide a biasing force on the first contact arm under certain operating conditions of the first battery module.

14. The battery pack of claim 1, wherein the electrical transfer assembly further includes:
a positive connector module including the female terminal assembly and the busbar, wherein said busbar is a first busbar;
a negative connector module including a second female terminal assembly and a second busbar; and
wherein (a) a positive terminal of the battery cell is electrically coupled to said first busbar, and (b) a negative terminal of the battery cell is electrically coupled to said second busbar.

15. The battery pack of claim 14, wherein the first busbar is bimetallic and the second busbar is not bimetallic.

16. The battery pack of claim 14, wherein the positive terminal of the battery cell is welded to the first busbar, and the negative terminal of the battery cell is welded to the second busbar.

17. The battery pack of claim 14, wherein the positive and negative terminals of the battery cell are not bolted to the first busbar and the second busbar.

18. The battery pack of claim 14, wherein the positive and negative connector modules are secured in the battery module housing without using bolts or threaded fastener.

19. The battery pack of claim 14, wherein the female terminal housing is integrally formed in the positive connector module.

20. The battery pack of claim 1, wherein the battery cell is a first battery cell;
wherein a second battery cell is positioned within the battery module housing;
wherein the electrical transfer assembly further includes:
a positive connector module including the female terminal assembly and the busbar, wherein said busbar is a first busbar;
a negative connector module including a second female terminal assembly and a second busbar;
a jumper interface module and a third busbar; and
wherein (a) a positive terminal of the first battery cell is electrically coupled to said first busbar, (b) a negative terminal of the first battery cell is electrically coupled to said third busbar, (c) a positive terminal of the second battery cell is electrically coupled to said third busbar, (d) a negative terminal of the second battery cell is electrically coupled to said second busbar.
